(19) United States
(12) Patent Application Publication
(10) Pub. No.: US 2025/0233721 A1
(43) Pub. Date: Jul. 17, 2025

(54) METHOD FOR WIRELESS COMMUNICATION, ELECTRONIC DEVICE AND COMPUTER-READABLE STORAGE MEDIUM

(71) Applicant: Sony Group Corporation, Tokyo (JP)

(72) Inventor: Xiaoxue WANG, Beijing (CN)

(73) Assignee: Sony Group Corporation, Tokyo (JP)

(21) Appl. No.: 18/855,340

(22) PCT Filed: Apr. 17, 2023
(86) PCT No.: PCT/CN2023/088615

§ 371 Date: Oct. 9, 2024

(30) Foreign Application Priority Data
Apr. 21, 2022 (CN) 202210422130.9

(51) Int. Cl. H04L 5/00; H04W 72/0453; H04W 72/232; H04W 72/25

(52) U.S. Cl. CPC H04L 5/0098; H04W 72/0453; H04W 72/232; H04W 72/25

(57) ABSTRACT

Provided are methods for wireless communication, electronic devices, and computer readable storage media, which help to improve the efficiency of sidelink communication in an unlicensed frequency band. For example, provided is an electronic device of a base station side, which may comprise a processing circuit configured to: perform channel access processing on an unlicensed frequency band for sidelink communication, so as to obtain a channel occupancy time (COT); and generate downlink control information, so as to indicate that the COT is allocated to a user device for sidelink communication. Also provided is an electronic device of a user side, which may comprise a processing circuit configured to: receive downlink control information indicating that a channel occupancy time (COT), obtained by a base station side device by performing channel access processing on an unlicensed frequency band used for sidelink communication, is allocated to the electronic device for sidelink communication.

This application claims priority to a Chinese patent application filed with the China Patent Office on Apr. 21, 2022, with application number 202210422130.9 and invention name “Method for wireless communication, electronic device, and computer-readable storage medium”, the entire contents of which are incorporated by reference into this application.

### TECHNICAL FIELD

The present application relates to the field of wireless communication technology, and more specifically, to a method and electronic device for wireless communication and a computer-readable storage medium that facilitate user equipment to use resources on an unlicensed frequency band for Sidelink communication.

### BACKGROUND

It has been proposed that resources in unlicensed frequency bands can be used for Sidelink communications. However, in Sidelink communication in the unlicensed frequency band, the User Equipment (UE) at the transmitting end needs to first perform channel access processing on the unlicensed frequency band used for Sidelink communication before performing any Sidelink transmission (including sending or broadcasting Sidelink Synchronization Signal Block (S-SSB) or sending data signals to the UE at the receiving end), and can perform Sidelink transmission only after winning the channel competition and obtaining the Channel Occupancy Time (COT).

In this case, the efficiency of the Sidelink communication of the user equipment in the unlicensed frequency band may be low. For example, a user equipment serving a single user may have a lower probability of winning channel contention in a channel access process and/or may have a longer delay in obtaining COT, thereby increasing the delay of Sidelink communication in an unlicensed band and reducing the efficiency of Sidelink communication. In addition, if the Sidelink synchronization signal cannot be transmitted efficiently, it will cause many problems in the synchronization process between the transmitting UE and the receiving UE and directly affect the subsequent data signal transmission, thereby seriously reducing the efficiency of Sidelink communication compared with the inefficient transmission of data signals.

### SUMMARY

The following presents a simplified summary of the disclosure in order to provide a basic understanding of some aspects of the disclosure. However, it should be understood that this summary is not an exhaustive overview of the disclosure. It is not intended to identify a key or important part of the present disclosure, nor is it intended to limit the scope of the present disclosure. Its sole purpose is to present some concepts about the disclosure in a simplified form as a prelude to the more detailed description that is presented later.

An object of the embodiments of the present disclosure is to provide a method, an electronic device, and a computer-readable storage medium for wireless communication, which are beneficial to improving the efficiency of Sidelink communication of a user equipment in an unlicensed frequency band.

The purpose of the first embodiment of the present disclosure is to provide a method and electronic device for wireless communication and a computer-readable storage medium, which are beneficial to reducing the delay of user equipment performing Sidelink communication in an unlicensed frequency band, thereby improving the efficiency of Sidelink communication in an unlicensed frequency band.

According to a first aspect of the first embodiment of the present disclosure, an electronic device on a base station side is provided, the electronic device comprising a processing circuit, the processing circuit being configured to: perform channel access processing on an unlicensed frequency band used for direct link (Sidelink) communication to obtain a channel occupancy time COT; generate downlink control information to indicate allocation of the COT to a user equipment for direct link (Sidelink) communication.

According to the first aspect of the first embodiment of the present disclosure, a method for wireless communication on the base station side is also provided, the method comprising: performing channel access processing on an unlicensed frequency band used for direct link (Sidelink) communication to obtain a channel occupancy time COT; generating downlink control information to indicate allocation of the COT to a user equipment for direct link (Sidelink) communication.

According to the second aspect of the first embodiment of the present disclosure, an electronic device is provided, which includes a processing circuit, and the processing circuit is configured to: receive downlink control information, wherein the downlink control information indicates allocation of a channel occupancy time COT, which is obtained by a base station side device performing channel access processing on an unlicensed frequency band used for direct link (Sidelink) communication, to the electronic device for use in the direct link (Sidelink) communication.

According to the second aspect of the first embodiment of the present disclosure, a method for wireless communication is also provided, the method comprising: receiving downlink control information, the downlink control information indicating allocation of a channel occupancy time COT, which is obtained by a base station side device performing channel access processing on an unlicensed frequency band used for direct link (Sidelink) communication, to the electronic device for use in the direct link (Sidelink) communication.

The second and third embodiments of the present disclosure aim to provide a method and electronic device for wireless communication and a computer-readable storage medium, which are beneficial to improving the transmission efficiency of the Sidelink synchronization signal in the unlicensed frequency band, thereby improving the efficiency of the Sidelink communication in the unlicensed frequency band.

According to an aspect of the second embodiment of the present disclosure, an electronic device on the base station side is provided, which includes a processing circuit, and the processing circuit is configured to: perform channel access processing on an unlicensed frequency band used to transmit a direct link (Sidelink) synchronization signal to obtain a channel occupancy time COT; and allocate resources of the unlicensed frequency band in the COT to multiple user equipments for sending a direct link (Sidelink) synchronization signal.

According to an aspect of the second embodiment of the present disclosure, a method for wireless communication on the base station side is also provided, the method comprising: performing channel access processing on an unlicensed frequency band used to transmit a direct link (Sidelink) synchronization signal to obtain a channel occupancy time COT; allocating resources of the unlicensed frequency band in the COT to multiple user equipments for sending a direct link (Sidelink) synchronization signal.

According to the first aspect of the third embodiment of the present disclosure, an electronic device is provided, which includes a processing circuit, and the processing circuit is configured to: jointly send (or transmit) a synchronization signal and a data signal of a direct link (Sidelink) on an unlicensed frequency band in a predefined time-frequency resource format, wherein the time-frequency resource format includes multiple sub-channels on a time slot.

According to the first aspect of the third embodiment of the present disclosure, a method for wireless communication is also provided, the method comprising: jointly sending (or transmitting) a synchronization signal and a data signal of a direct link (Sidelink) on an unlicensed frequency band in a predefined time-frequency resource format, wherein the time-frequency resource format includes multiple sub-channels on one time slot.

According to the second aspect of the third embodiment of the present disclosure, an electronic device is provided, which includes a processing circuit, and the processing circuit is configured to: receive a synchronization signal and a data signal of a direct link (Sidelink) communication on an unlicensed frequency band that are jointly sent in a predefined time-frequency resource format, wherein the time-frequency resource format includes multiple subchannels on one time slot.

According to the second aspect of the third embodiment of the present disclosure, a method for wireless communication is also provided, the method comprising: receiving a synchronization signal and a data signal of a direct link (Sidelink) communication on an unlicensed frequency band that are jointly sent in a predefined time-frequency resource format, wherein the time-frequency resource format includes multiple subchannels on one time slot.

According to another aspect of the present disclosure, a non-transitory computer-readable storage medium storing executable instructions is also provided. When the executable instructions are executed by a processor, the processor executes the above-mentioned method for wireless communication or various functions of the above-mentioned electronic device.

According to other aspects of the present disclosure, a computer program code and a computer program product for implementing the above method according to the present disclosure are also provided.

According to at least one aspect of the first embodiment of the present disclosure, a base station side device, which serves multiple users and is easy to win channel contention obtains COT, allocates COT to UE for Sidelink communication, thereby helping to increase the possibility of UE obtaining COT and reduce the delay for UE to obtain COT, thereby helping to reduce the delay for UE to conduct Sidelink communication in an unlicensed frequency band and improve the efficiency of Sidelink communication.

According to at least one aspect of the second and third embodiments of the present disclosure, the Sidelink synchronization signal of the unlicensed frequency band is transmitted in a multiplexing manner, thereby improving the transmission efficiency of the Sidelink synchronization signal of the unlicensed frequency band, thereby improving the efficiency of the Sidelink communication of the unlicensed frequency band.

Other aspects of the embodiments of the present disclosure are given in the following description, wherein the detailed description is used to fully disclose the preferred embodiments of the embodiments of the present disclosure without imposing limitations thereon.

### BRIEF DESCRIPTION OF THE DRAWINGS

The drawings described herein are for illustrative purposes only of selected embodiments and not all possible implementations, and are not intended to limit the scope of the present disclosure. In the attached drawings,

FIG. 1 is a schematic diagram showing an application scenario according to a first embodiment of the present disclosure;

FIG. 2 is a block diagram showing a configuration example of an electronic device on the base station side according to the first embodiment;

FIG. 3 is a schematic diagram for illustrating an example of time domain resource usage indicated by downlink control information generated by an electronic device according to the first embodiment;

FIG. 4 is a schematic diagram for explaining an example format of downlink control information generated by an electronic device according to the first embodiment;

FIG. 5 is a block diagram showing a configuration example of an electronic device on the user equipment side according to the first embodiment;

FIG. 6 is a flowchart for illustrating a first example signaling interaction for obtaining and allocating a COT to a user equipment by a base station side device according to the first embodiment;

FIG. 7 is a flowchart for illustrating a second example signaling interaction for obtaining and allocating a COT to a user equipment by a base station side device according to the first embodiment;

FIG. 8 is a flowchart for illustrating a third example signaling interaction for obtaining and allocating a COT to a user equipment by a base station side device according to the first embodiment;

FIG. 9 is a flowchart showing a process example of a method for wireless communication on the base station side according to the first embodiment;

FIG. 10 is a flowchart showing an example of a process of a method for wireless communication on the user equipment side according to the first embodiment;

FIG. 11 is a schematic diagram showing an application scenario according to the second embodiment of the present disclosure;

FIG. 12 is a block diagram showing a configuration example of an electronic device according to a second embodiment;

FIG. 13 is a schematic diagram for illustrating a first example of frequency domain resources for transmitting S-SSB configured for a user equipment by an electronic device according to the second embodiment;

FIG. 14 is a schematic diagram for explaining a first example of resources in a COT allocated to a plurality of user equipments by an electronic device according to the second embodiment;

FIG. 15 is a schematic diagram for illustrating a second example of frequency domain resources for transmitting S-SSB configured for a user equipment by an electronic device according to the second embodiment;

FIG. 16 is a schematic diagram for explaining a second example of resources in a COT allocated to a plurality of user equipments by an electronic device according to the second embodiment;

FIG. 17 is a flowchart for illustrating a first example signaling interaction for a base station side device to obtain a COT and allocate resources in the COT to multiple user equipments according to the second embodiment;

FIG. 18 is a flowchart for illustrating a second example signaling interaction for a base station side device to obtain a COT and allocate resources in the COT to multiple user equipments according to the second embodiment;

FIG. 19 is a flowchart showing an example of a process of a method for wireless communication according to the second embodiment;

FIG. 20 is a block diagram showing a configuration example of an electronic device according to a third embodiment;

FIG. 21 is a schematic diagram for illustrating a first example of a predefined time-frequency resource format that can be used in the third embodiment;

FIG. 22 is a schematic diagram for illustrating a second example of a predefined time-frequency resource format that can be used in the third embodiment;

FIG. 23 is a schematic diagram for illustrating a third example of a predefined time-frequency resource format that can be used in the third embodiment;

FIG. 24 is a flow chart showing an example of a process of a method for wireless communication at a transmitting end according to a third embodiment;

FIG. 25 is a flowchart showing an example of a process of a method for wireless communication at a receiving end according to the third embodiment;

FIG. 26 is a block diagram showing a first example of a schematic configuration of an eNB to which the technology of the present disclosure may be applied;

FIG. 27 is a block diagram showing a second example of a schematic configuration of an eNB to which the technology of the present disclosure may be applied;

FIG. 28 is a block diagram showing an example of a schematic configuration of a smartphone to which the technology of the present disclosure may be applied;

FIG. 29 is a block diagram showing an example of a schematic configuration of a car navigation device to which the technology of the present disclosure can be applied.

While the disclosure is susceptible to various modifications and alternative forms, specific embodiments thereof have been shown by way of example in the drawings and are herein described in detail. It should be understood, however, that the description of specific embodiments herein is not intended to limit the disclosure to the particular forms disclosed, but on the contrary, the disclosure is intended to cover all modifications, equivalents, and alternatives falling within the spirit and scope of the disclosure. It should be noted that corresponding reference numerals indicate corresponding parts throughout the several views of the drawings.

### DETAILED DESCRIPTION OF EMBODIMENTS

Examples of the present disclosure will now be described more fully with reference to the accompanying drawings.

The following description is merely exemplary in nature and is not intended to limit the present disclosure, application, or uses. Example embodiments are provided so that this disclosure will be thorough, and will fully convey the scope to those skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known structures, and well-known technologies are not described in detail.

The description will be in the following order:
I. First embodiment
   I.1. Overview
   I.2. Configuration example of electronic device on base station side
      I.2.1 Example processing of each unit of electronic device
      I.2.2 Example of generated downlink control information and related processing
      I.2.3 Example way of allocating COT
   I.3. Configuration example of electronic device on user side
      I.3.1 Example processing of each unit of electronic device
      I.3.2 Example of received downlink control information and related processing
      I.3.3 Example way of obtaining COT allocated by the base station side
   I.4. Example signaling flow
      I.4.1 Example signaling flow for dynamic allocation
      I.4.2 Example signaling flow for static allocation
      I.4.3 Example signaling flow for semi-static allocation
   I.5. Method embodiment
      I.5.1 Method embodiment on base station side
      I.5.2 Method embodiment on user side
II. Second embodiment and third embodiment
   I1.1. Overview
   I1.2. Configuration example of electronic device of second embodiment
      I1.2.1 Example processing of each unit of electronic device
      I1.2.2 Example way of allocating resources in COT
   I1.3. Example signaling flow of second embodiment
      I1.3.1 Example signaling flow for TDM allocation
      I1.3.2 Example signaling flow for FDM allocation
   I1.4. Method embodiment of second embodiment
   I1.5. Configuration example of electronic device of third embodiment
   I1.6. Method embodiment of third embodiment
III. Application Examples

### I. First Embodiment

### I.1. Overview

As mentioned above, a UE serving a single user has a lower probability of winning channel contention in the channel access process and/or may have a longer delay in obtaining COT, thereby increasing the delay of Sidelink communication in the unlicensed band and reducing the efficiency of Sidelink communication.

To this end, the inventors propose that in Sidelink communication in an unlicensed frequency band, in a mode in which a base station schedules Sidelink transmission, namely, Sidelink resource allocation mode 1 (mode 1), a base station, which serves multiple users and is easy to win channel contention obtains a COT, allocates a COT to a transmitting UE for Sidelink communication, thereby facilitating an increase in the possibility of the UE obtaining the COT and reducing the delay for the UE to obtain the COT, thereby facilitating a reduction in the delay for the UE to conduct Sidelink communication in an unlicensed frequency band and improving the efficiency of Sidelink communication.

FIG. 1 is a schematic diagram showing an application scenario according to the first embodiment of the present disclosure, wherein an example of a mode in which a base station schedules Sidelink transmission, namely, Sidelink resource allocation mode 1 is shown. As shown in FIG. 1, the user equipment SL UE1 at the transmitting end performs Sidelink communication with the user equipment SL UE2 at the receiving end. The SL UE1 at the transmitting end is within the coverage of the base station gNB and operates in Sidelink resource allocation mode 1. The SL UE2 at the receiving end is outside the coverage of the base station gNB, and SL UE1 can communicate with the gNB via an access link (Access Link, also called Uulink), and then use the COT obtained and allocated by the gNB to perform Sidelink communication with SL UE2. Next, the apparatus and method on the base station side and the user side and an example signaling process according to the first embodiment of the present disclosure will be further described in conjunction with the example scenario shown in FIG. 1.

### I.2. Configuration Example of Electronic Device on the Base Station Side

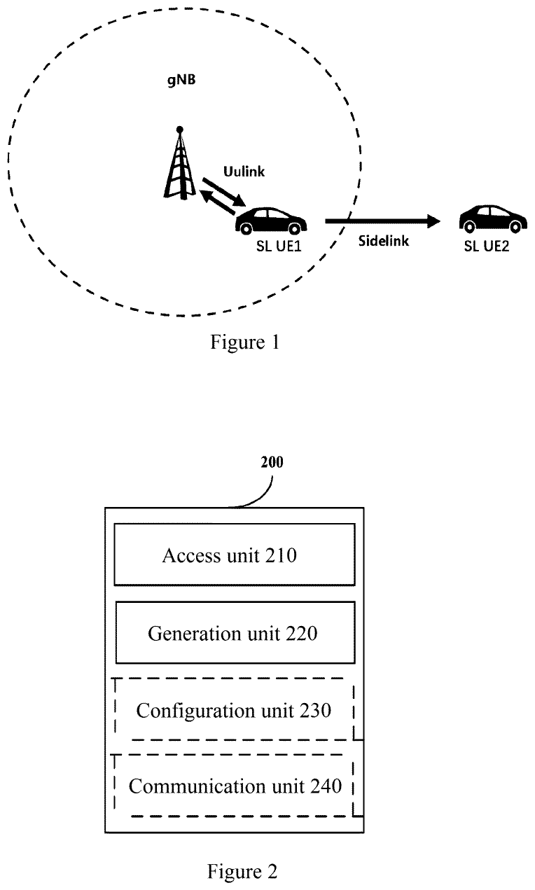

FIG. 2 is a block diagram showing a configuration example of electronic device on the base station side according to the first embodiment.

As shown in FIG. 2, the electronic device 200 may include an access unit 210, a generation unit 220, and an optional configuration unit 230 and an optional communication unit 240. In addition, although not shown in the drawings, the electronic device 200 may further include a storage unit.

Here, each unit of the electronic device 200 may be included in a processing circuit. It should be noted that the electronic device 200 may include one processing circuit or multiple processing circuits. Further, the processing circuit may include various discrete functional units to perform various different functions and/or operations. It should be noted that these functional units may be physical entities or logical entities, and units with different names may be implemented by the same physical entity.

Next, the example processing of the electronic device 200 and its various units on the base station side will be further described in combination with the example scenario shown in FIG. 1, wherein the electronic device 200 can, for example, be used for the base station gNB in FIG. 1.

### I.2.1 Example Processing of Each Unit of Electronic Device

### Example Processing of Access Unit 210

According to the first embodiment, the access unit 210 of the electronic device 200 may perform channel access processing on an unlicensed frequency band used for direct link (Sidelink) communication (hereinafter also referred to as Sidelink unlicensed frequency band) to obtain a channel occupation time COT.

As an example, the access unit 210 may listen before talk (LBT) by monitoring potential transmission activities on the Sidelink unlicensed frequency band and access the channel when confirming that the Sidelink unlicensed frequency band is available. The access unit 210 may use various LBT processes to perform channel access processing, including but not limited to LBT processes without/with a random backoff mechanism. As an example, the types of channel access processing performed by the access unit 210 may include but are not limited to (a) an LBT process without applying random backoff (Type 2, Cat2), (b) an LBT process including random backoff but with a fixed contention window (Contention Window, CW) size (Type 3, Cat3), and (c) an LBT process including random backoff and a variable contention window size (Type 4, Cat4). Different types of channel access processes may obtain COTs with different reliabilities (e.g., with different probabilities, different speeds). For example, the COT obtained by the more complex Cat4LBT process has a high reliability. The access unit 210 may appropriately determine the type of channel access processing it performs based on various factors. For example, optionally, when the electronic device 200 understands the specific requirements of the user equipment's Sidelink transmission via the communication unit 240 described later, the access unit 210 can appropriately determine the type of channel access processing it performs based on the specific requirements of the user equipment's Sidelink transmission.

In this embodiment, optionally, a Cat4 (Type 4) LBT process including random backoff and a variable contention window size is adopted, and the LBT process can further have different priorities to indicate the possibility and speed of successfully obtaining COT, etc. For example, a high priority LBT may indicate that the LBT obtains the COT faster with a higher probability. More specifically, in one example, a Cat4 (Type 4) LBT process may be considered to have four different priority categories {1, 2, 3, 4} from high to low. Each priority class has a separate contention window and the maximum and minimum values of the contention window are different, where high-priority LBT can access the channel faster using a smaller contention window. Furthermore, each priority class may use a different delay period, wherein a high priority LBT is able to sense the channel status and acquire the channel in a shorter time via a shorter delay period. In some or all priority levels, downlink transmissions may have a shorter delay period than uplink transmissions. For example, therefore, in the example of FIG. 1, compared with the SL UE1 on the user side, the access unit 210 of the electronic device 200 on the base station side can, for example, perform a higher priority LBT or perform an LBT with the same priority but a shorter delay period, thereby obtaining COT faster. In the case of adopting LBT processes with different priorities, the access unit 210 can appropriately determine the priority of the LBT process for channel access processing based on various factors (such as the specific requirements of the Sidelink transmission of the user equipment).

The bandwidth (also referred to as LBT bandwidth) on which the access unit 210 performs channel access processing via the LBT process may include all or part of the unlicensed frequency bands in which the user equipment can perform Sidelink transmission, and this embodiment does not impose any restrictions in this regard.

The access unit 210 may, for example, perform a channel access process for the user equipment (e.g., SL UE1) once and obtain a COT, or may perform multiple channel access processes for the user equipment and obtain multiple COTs. In some applications, it is particularly advantageous for the access unit 210 to obtain multiple COTs for the user equipment. For example, the user equipment can select the COT that best meets its Sidelink transmission requirements or use multiple COTs at a time to transmit a large amount of data.

### Example Processing of Generation Unit 220

According to the first embodiment, the generating unit 220 of the electronic device 200 may generate downlink control information (Downlink Control Information, DCI) to indicate that the obtained COT is allocated to the user equipment for Sidelink communication.

For example, the generation unit 200 may allocate the COT obtained by the access unit 210 to the SL UE1 at the transmitting end shown in FIG. 1 for Sidelink communication, and generate a DCI to indicate the allocation to the SL UE1. The allocation of the COT obtained by the access unit 210 by the generation unit 200 includes but is not limited to the allocation of time domain resources, i.e., time periods, in the COT. The generating unit 220 may allocate all or part of the time period in the COT to the user equipment. In addition, optionally, the allocation of the COT by the generation unit may further include allocation of frequency domain resources of the unlicensed frequency band of the COT that the access unit 210 successfully obtains. As mentioned above, the bandwidth (LBT bandwidth) for channel access processing by the access unit 210 may include all or part of the unlicensed frequency band in which the user equipment can perform Sidelink transmission, and the generation unit 200 may further allocate all or part of the available frequency domain resources in the unlicensed frequency band in which the access unit 210 successfully obtains COT to the user equipment. The generation unit 220 may appropriately perform the above allocation based on various factors. For example, when the electronic device 200 understands the specific demand of the Sidelink communication of the user equipment, the generating unit 220 can perform the above allocation based on the demand and optionally considering the Sidelink communication resources of the unlicensed frequency band that the electronic device 200 can schedule.

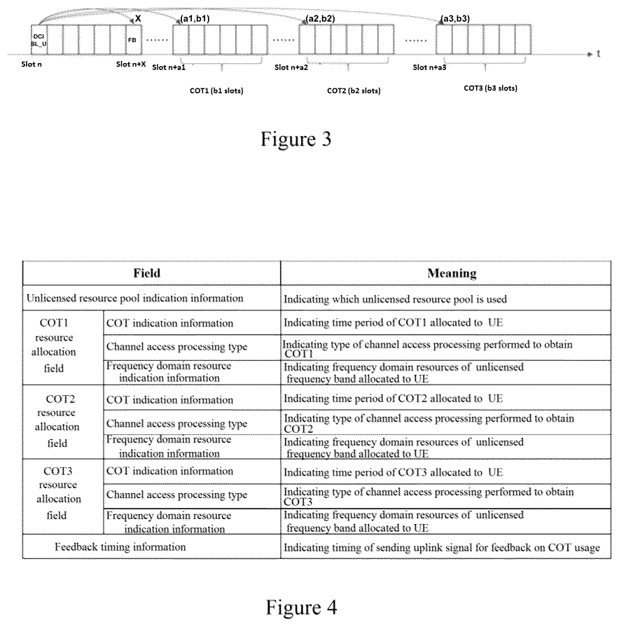

Accordingly, the downlink control information DCI SL_U generated by the generation unit 220 for the user equipment may at least include information indicating allocation of time domain resources in the COT (and optionally frequency domain resources in the COT) for the user equipment. For ease of description, in the first embodiment, the downlink control information generated by the generating unit 220 indicating allocation of COT to the user equipment for Sidelink communication may be referred to as Sidelink Unlicensed Resource Scheduling DCI, and may be referred to as Downlink Control Information DCI SL_U as appropriate. Further details of the downlink control information DCI SL_U generated by the generation unit 200 and related processing will be further described later in conjunction with FIG. 3 and FIG. 4.

### Example Processing of Configuration Unit 230

In Sidelink communication, the user equipment may use a pre-configured resource pool (a collection of pre-configured time-frequency resources/time-frequency resource blocks) for communication. Therefore, optionally, as shown in FIG. 2, the electronic device 200 may further include a configuration unit 230 configured to configure an unlicensed resource set (also referred to as an unlicensed resource pool) for the user equipment for direct link (Sidelink) communication. Here, the unlicensed resource set configured by the configuration unit 230 for the user equipment includes at least the resources of the unlicensed frequency band on which the access unit 210 performs channel access processing to obtain the COT (in other words, when the configuration unit 230 configures the unlicensed resource set for the user equipment, the access unit 210 preferably performs channel access processing on all or part of the unlicensed frequency bands in the unlicensed resource set configured for the user equipment (and currently available to the user equipment) to obtain the COT on such unlicensed frequency band). The configuration unit 230 may implement the above configuration by, for example, generating unauthorized resource pool configuration information and sending the configuration information to the user equipment using the communication unit 240 described later. Of course, the Sidelink communication configuration information that the configuration unit 230 can generate for the user equipment is not limited to the unauthorized resource pool configuration information that the present disclosure pays special attention to, but can include authorized resource pool configuration information generated in a manner similar to the existing manner, which will not be repeated here.

As an example, the configuration unit 320 may add a field as the unauthorized resource pool configuration information in the existing Sidelink communication configuration information for the user equipment. For example, the configuration unit 320 may add the above fields in a system information block (SIB) for Sidelink communication configuration. For example, the configuration unit 320 may add an information element sl-FreqlnfoList-r18 IE in the system message SIB 12 information element (IE) for new radio (NR) Sidelink communication configuration, after the information element sl-FreqlnfoList-r16 IE for configuring the authorized resource pool, to configure the specific content of the unauthorized resource pool for the user equipment. An example of the code of the SIB 12 information element after such modification is as follows:

SIB12 information element

```
SL-ConfigCommonNR-r16 ::= SEQUENCE {
  sl-FreqInfoList-r16
  sl-FreqInfoList-r18
  sl-UE-SelectedConfig-r16
  sl-NR-AnchorCarrierFreqList-r16
  sl-EUTRA-AnchorCarrierFreqList-r16
  sl-RadioBearerConfigList-r16
  sl-RLC-BearerConfigList-r16
  sl-MeasConfigCommon-r16
  sl-CSI-Acquisition-r16
  sl-OffsetDFN-r16
  t400-r16
  sl-MaxNumConsecutiveDTX-r16
  sl-SSB-PriorityNR-r16
}
```

In the code of the above SIB 12 information element, the newly added sl-FreqlnfoList-r18 IE is used to configure the specific content of the unlicensed resource pool for the user equipment, such as but not limited to the location of the unlicensed frequency band frequency domain resources of the resource pool (such as subchannel index, etc.). Except for the newly added field sl-FreqlnfoList-r18 IE, the specific meanings of the remaining fields can be referred to the definitions in existing standards (such as the 3rd Generation Partnership Project, 5th Generation Mobile Communication Technology (3GPP 5G) TS 38.331 standard), which will not be repeated here.

Optionally, the configuration unit 230 may also be configured to generate corresponding configuration information for Radio Resource Control (RRC) configuration or RRC reconfiguration between the electronic device 200 and the user equipment. In the case where the electronic device 200 schedules Sidelink communication for the user equipment, for example, after the electronic device 200 sends the above-mentioned SIB 12 information element carrying resource pool configuration information, etc. to the user equipment via the communication unit 240 described later, RRC reconfiguration can be performed between the electronic device 200 and the user equipment. For example, the user equipment can report Sidelink capabilities to the electronic device 200 (for example, but not limited to, the user equipment reports the unlicensed resource pool that it can currently use and optionally also includes the authorized resource pool that can be used), and the configuration unit 230 of the electronic device 200 can further configure specific Sidelink resources for the user equipment based on the report, such as generating further configuration information, and can use the communication unit 240 described later to send the configuration information to the user equipment.

### Example Processing of Communication Unit 240

Optionally, as shown in FIG. 2, the electronic device 200 may further include a communication unit 240 for sending information to a device other than the electronic device 200 and/or receiving information from a device other than the electronic device 200.

Here, the electronic device 200 may utilize the communication unit 240 to send the downlink control information DCI SL_U generated by the generation unit 220 to the user equipment, such as SL U1 in FIG. 1. In an example, the communication unit 240 may be configured to scramble the downlink control information DCI SL_U with a predefined scrambling sequence. The predefined scrambling sequence of DCI SL_U for Sidelink unlicensed resource scheduling may be different from the scrambling sequence indicating the scheduling of authorized resources for Sidelink communication (the scrambling sequence indicating the scheduling of authorized resources for Sidelink communication is, for example, the Sidelink Radio Network Temporary Identity (RNTI), i.e., Sidelink RNTI or SL-RNTI), so as to facilitate the distinction from the DCI format 3_0 for Sidelink authorized resource scheduling that is scrambled using the latter. A user equipment that receives a DCI SL_U scrambled with a predefined scrambling sequence may, for example, determine that the received DCI is a DCI SL_U for Sidelink unlicensed resource scheduling based on the predefined scrambling sequence and optionally in combination with a valid length of the downlink control information DCI SL_U.

For example, the predefined scrambling sequence applied by the communication unit 240 to the downlink control information DCI SL_U may include a scrambling sequence for indicating the scheduling of unlicensed resources for Sidelink communication, such as a scrambling sequence specifically set for this purpose, which may be called Sidelink Unlicensed RNTI or SLU-RNTI. As an example only, the value of the scrambling sequence SLU-RNTI may be any one of the hexadecimal sequences FFF3 to FFFD. The user equipment that receives the downlink control information DCI SL_U scrambled with the scrambling sequence SLU-RNTI can, for example, directly determine that the received DCI is DCI SL_U for Sidelink unlicensed resource scheduling according to the scrambling sequence SLU-RNTI.

Alternatively, the predefined scrambling sequence applied by the communication unit 240 to the downlink control information DCI SL_U may include a scrambling sequence used to indicate information related to the transfer time slot, such as a time slot indication (Slot Format Indication) RNTI, namely SFI-RNTI. In the prior art, a scrambling sequence SFI-RNTI is used to scramble a DCI format 2_0 that notifies a user equipment of a time slot format indication. The DCI format 2_0 generally has a certain valid length or length range. Therefore, as long as the effective length of the downlink control information DCI SL_U is different from the effective length of the above-mentioned DCI format 2_0, the communication unit 240 can use the scrambling sequence SFI-RNTI to scramble the downlink control information DCI SL_U. In this case, the user equipment can, for example, determine that the received DCI is DCI SL_U for Sidelink unlicensed resource scheduling based on the scrambling sequence SFI-RNTI, optionally in combination with the effective length of the downlink control information DCI SL_U (different from the effective length of the above-mentioned DCI format 2_0).

In addition, when the electronic device 200 generates Sidelink communication configuration information for the user equipment using the configuration unit 230, the electronic device 200 may send the configuration information to the user equipment using the communication unit 240. As mentioned above, the configuration unit 320 may add a field in the system information block SIB (e.g., SIB 12 message) used for Sidelink communication configuration as the configuration information of the unlicensed resource set. Accordingly, the electronic device 200 may utilize the communication unit 240 to send the configuration information of the unlicensed resource set generated for the user equipment by the configuration unit 230 to the user equipment through the system information block SIB (e.g., SIB 12 message). In addition, when the configuration unit 230 generates corresponding configuration information for RRC configuration or RRC reconfiguration (RRC Reconfiguration) between the electronic device 200 and the user equipment, the electronic device 200 can use the communication unit 240 to send the configuration information to the user equipment via RRC signaling.

### I.2.2 Example of Generated Downlink Control Information and Related Processing

As mentioned above, the allocation of the COT obtained by the access unit 210 by the generation unit 200 includes but is not limited to the allocation of time domain resources in the COT, and optionally includes the allocation of frequency domain resources of the unlicensed frequency band of the COT successfully obtained by the access unit 210. Accordingly, the downlink control information DCI SL_U generated by the generation unit 220 may at least include information indicating the above allocation.

In an example, the downlink control information DCI SL_U generated by the generation unit 220 may include COT indication information, which indicates the period of COT allocated to the user equipment.

The COT indication information may, for example, indicate the start and end time of the period of COT allocated to the user equipment. In an example, the COT indication information may indicate the time slot offset of the start time slot of the period of COT allocated to the user equipment relative to the DCI SL_U and the number of time slots that period of COT lasts. For example, assuming that DCI SL_U is sent in time slot n, the COT indication information may indicate (a, b), indicating that the starting time slot n+a of the period of COT allocated to the user equipment lasts for b time slots. Note that the generation unit 220 can allocate all or part of the time period in the COT obtained by the access unit 210 to the user equipment; accordingly, the COT indication information of the downlink control information DCI SL_U can indicate all or part of the time period of the COT, which is not limited in this embodiment.

In addition, preferably, the downlink control information DCI SL_U may also include access type information, which indicates the type of channel access processing of the access unit 210. The channel access processing is for example but not limited to the above-mentioned Cat2 (type 2) LBT process, Cat3 (type 3) LBT process, Cat4 (type 4) LBT process, etc. Different types of channel access processes may indicate the reliability of the COT obtained via the process (e.g., a more complex Cat4LBT process may have a higher reliability of the COT obtained). Therefore, the access type information of the downlink control information DCI SL_U will help the user equipment to determine whether to use the corresponding COT. As an example, when the access unit 210 performs a channel access process via an LBT process with different priorities to obtain a COT, the type of channel access process may further include the priority of the LBT. For example, when the aforementioned Cat4 (Type 4) LBT process with four priorities is adopted, the access type information of the DCI SL_U may also indicate one of the four priorities {1, 2, 3, 4}.

In addition, optionally, the downlink control information DCI SL_U may also include frequency domain resource indication information, which indicates the frequency domain resources of the unlicensed frequency band allocated to the user equipment. As an example, the frequency domain resource indication information may indicate a subchannel index of a subchannel in an unlicensed frequency band allocated to the user equipment. Note that the generation unit 220 can allocate all or part of the available frequency domain resources in the COT obtained by the access unit 210 to the user equipment; accordingly, the frequency domain resource indication information of the downlink control information DCI SL_U can indicate all or part of the available frequency domain resources in the obtained COT (for example, the subchannel index of all or part of the available subchannels in the obtained COT), and this embodiment does not limit this.

In a preferred example, the downlink control information DCI SL_U may include N resource allocation fields for N COTs (N is a natural number greater than or equal to 1), and each resource allocation field includes the above-mentioned COT indication information, access type information and frequency domain resource indication information for the corresponding COT. Such an arrangement is beneficial for the user equipment to obtain various pieces of information of the corresponding COT from each resource allocation field and select an appropriate COT for Sidelink communication accordingly when possible.

Optionally, N=1, that is, the downlink control information DCI SL_U includes one resource allocation field for one COT. Such a setting is conducive to reducing the delay for the user equipment to obtain the COT allocated to it by the electronic device on the network side.

Alternatively, N>1, that is, the downlink control information DCI SL_U includes multiple resource allocation fields for multiple COTs, so that one downlink control information DCI SL_U can allocate at most N COTs to the user equipment. Such a setting is beneficial for providing the user equipment with the right to choose different COTs/different COT usage methods. For example, the user equipment may comprehensively consider the time periods of each COT (such as the start time and duration), the type of channel access processing (which may, for example, characterize the reliability of the COT), and the location of the corresponding frequency domain resources (such as whether sufficient frequency domain resources are allocated, etc.), and select from the allocated COTs (such as the earliest COT, the longest COT, or using multiple COTs at a time, etc.) according to the situation or requirements of the Sidelink transmission to be performed (such as the priority of the data to be sent, the delay requirements, the data packet size, and other information).

Preferably, N=3, that is, the downlink control information DCI SL_U includes 3 resource allocation fields for 3 COTs. Such a setting is conducive to achieving a balance between reducing the delay in allocating COTs to user equipment and providing user equipment with the right to choose different COT usage methods (such as selecting the earliest COT, the longest COT, or using multiple COTs at a time). Note that although the downlink control information DCI SL_U may include N resource allocation fields for N COTs (N>1), some of the fields may be empty and, for example, filled with reserved bits (e.g., all 0s), and only less than N COTs may be allocated to the user equipment (e.g., when N=3, only 1 or 2 COTs may be allocated).

In addition, optionally, the downlink control information DCI SL_U may also include feedback timing information, which indicates the sending timing of an uplink signal (sometimes also referred to as a COT usage feedback signal in this embodiment) used to feedback the usage of the COT. The sending timing of the COT feedback signal indicated by the feedback timing information needs to be earlier than the start time of the COT allocated to the user equipment.

As an example, the feedback timing information may indicate a time slot offset of a transmission time slot of an uplink COT feedback signal relative to a time slot of a DCI SL_U. For example, assuming that DCI SL_U is sent in time slot n, the feedback timing information may indicate X, indicating that the uplink COT usage feedback signal may be sent in time slot n+X. Preferably, even if the downlink control information DCI SL_U includes multiple resource allocation fields for multiple COTs, a feedback timing information is used to indicate the sending timing of the feedback signal used by an uplink COT for all COTs; this is conducive to simplifying the feedback process and facilitating the subsequent unified allocation of unused COTs by the base station side equipment.

The user equipment that receives the downlink control information DCI SL_U may send an uplink COT usage feedback signal at the sending timing indicated by the feedback timing information of the DCI SL_U. The electronic device 200 can receive a COT usage feedback signal sent by a user equipment in any appropriate manner, as long as it can reflect the usage of COT, that is, it carries COT usage feedback information, and the electronic device 200 can provide the obtained COT usage feedback information to the generation unit 220 for reference in the subsequent COT allocation/downlink control information DCI SL_U generation. As an example, the COT usage feedback information obtained by the electronic device 200 from the COT usage feedback signal can be, for example, a feedback information sequence in the form of a binary sequence. The length of the feedback information sequence can be equal to the number of COTs allocated in the downlink control information DCI SL_U or the number of resource allocation fields. Each bit in the feedback information sequence can indicate whether the corresponding COT will be used by the user equipment (0 means it will not be used, 1 means it will be used). For example, when the downlink control information DCI SL_U includes three resource allocation fields for three COTs (COT1, COT2, COT3), the feedback information sequence obtained by the electronic device 200 from the COT usage feedback signal may be in the form of 011, for example, indicating that the user equipment decides not to use COT1 and to use COT2 and COT3 based on the content of each resource allocation field and its own Sidelink transmission situation and/or needs.

The electronic device 200 can use the communication unit 240 to receive a COT usage feedback signal carrying the above-mentioned COT usage feedback information transmitted by the user equipment using a physical uplink control channel (Physical Uplink Control Channel, PUCCH) or a physical uplink shared channel (Physical Uplink Shared Channel, PUSCH). In one example, the electronic device 200 may receive a cyclically shifted basic sequence transmitted using PUCCH as a COT usage feedback signal, wherein the number of cyclic shifts of the basic sequence indicates the COT usage feedback information carried, i.e., a binary feedback information sequence. For example, when the number of cyclic shifts of the basic sequence received by the electronic device 200 as the COT feedback signal is 3, the electronic device 20 can obtain a feedback information sequence 011 corresponding to 3. In another example, the electronic device 200 can use the communication unit 240 to receive a COT usage feedback signal carrying the above-mentioned COT usage feedback information transmitted via the PUSCH channel, wherein the COT usage feedback signal carrying the COT usage feedback information 011 is directly transmitted as data content.

In the Sidelink unlicensed frequency band transmission, the electronic device 200 on the base station side is only responsible for allocating the obtained COT to the user equipment and does not use the COT for any transmission itself. When the user equipment receives the downlink control information DCI SL_U indicating allocation of COT, it selects the allocated COT according to the situation and/or demand for Sidelink transmission. In some cases, the user equipment chooses not to use part or even all of the allocated COT. By setting feedback timing information in the downlink control information DCI SL_U to require the user equipment to send an uplink signal at a specified sending timing to feedback COT usage, it is beneficial for the electronic device 200 on the base station side, for example, to schedule and control the use of Sidelink unlicensed resources via the generation unit 220, and reduce the waste of unlicensed resources. For example, when the electronic device 200 on the base station side learns from the user equipment that the latter does not use a certain COT, the generation unit 220 can allocate the COT to the other user equipment or other user equipment (for example, other UEs within the coverage of the electronic device 200 that need to perform Sidelink transmission on an unlicensed frequency band) when subsequently allocating COT/generating downlink control information DCI SL_U for the other UE.

FIG. 3 is a schematic diagram for explaining an example of time domain resource usage indicated by downlink control information DCI SL_U generated by the electronic device 200 according to the first embodiment. As shown in FIG. 3, DCI SL_U is sent in time slot n. The DCI SL_U indicates through the feedback timing information X that the uplink COT should be sent in time slot n+X (X=6) using the feedback signal FB, and for example, for the three COTs obtained by the electronic device 200 via the access unit 210, namely COT1 to COT3, the corresponding COT indication information (a1, b1), (a2, b2), and (a3, b3) of the three resource allocation fields indicate that the starting time slots of COT1, COT2, and COT3 are n+a1, n+a2, and n+a3, respectively, and each lasts for b1=b2=b3=6 time slots.

As described above, for example, the electronic device 200 can configure an unlicensed resource pool for the user equipment SL UE1 via the configuration unit 230, and in this case, the access unit 210 of the electronic device 200 preferably performs channel access processing for all or part of the unlicensed frequency bands in the unlicensed resource pool to obtain a COT on such an unlicensed frequency band. Accordingly, in a preferred example, the downlink control information DCI SL_U generated by the generation unit 220 of the electronic device 200 may also additionally include resource pool indication information, which indicates the unlicensed resource pool on which the access unit 210 of the electronic device 200 performs channel access processing to obtain the COT. The resource pool indication information may indicate, for example, a non-authoritative resource pool index. Note that at this time, the frequency domain resource indication information in the downlink control information DCI SL_U indicates the frequency domain resources (e.g., subchannel index) in the unlicensed resource pool.

FIG. 4 is a schematic diagram for explaining an example format of downlink control information DCI SL_U generated by the electronic device 200 according to the first embodiment. As shown on the left side of the table in FIG. 4, the downlink control information DCI SL_U may include unlicensed resource pool indication information, three resource allocation fields for three COTs (COT1 to COT3), and other fields such as feedback timing information (for example, arranged in sequence from first to last in time). The meaning of each field is shown on the right side of the table in FIG. 4 and has been described in detail before, so it will not be repeated here.

Note that although in FIGS. 3 and 4, the preferred example of allocating 3 COTs to the user equipment is illustrated by indicating the downlink control information DCI SL_U, the number of COTs allocated to the user equipment is not limited to this, but can be more or less than 3; the embodiments of the present disclosure are not limited to this.

### I.2.3 Example Way of Allocating COT

The electronic device 200 of this embodiment can allocate COT to the user equipment in a dynamic manner, a static manner or a semi-static manner, that is, perform a series of processes of channel access and generating and sending downlink control information DCI SL_U in a corresponding manner. In the case of dynamic allocation of COT, the electronic device 200 performs the above series of processes in response to the user equipment's request for Sidelink communication resources; in the case of static or semi-static allocation of COT, the electronic device 200 can pre-configure the sending period of the downlink control information DCI SL_U for the user equipment, and can periodically perform the above series of processes based on the sending period (static manner) or periodically perform the above series of processes after activating the downlink control information DCI SL_U (semi-static manner).

### Example of Dynamical Allocation of COT

First consider the case of dynamic allocation of COT. In the case of dynamic allocation of COT, the electronic device 200 can respond to a request from a user equipment for resources for Sidelink communication, so as to use the access unit 210 to perform channel access processing to obtain the COT, use the generation unit 220 to generate downlink control information DCI SL_U, and use the communication unit 240 to send the downlink control information to the user equipment.

As an example, a user equipment such as SL UE1 in FIG. 1 may send a request for Sidelink communication resources to the electronic device 200 on the base station side when it has Sidelink transmission requirements (e.g., synchronization signal or data signal transmission requirements).

In the first example of dynamically allocating COT, the request for Sidelink communication resources received by the electronic device 200 from the user equipment can, for example, be sent via a SidelinkUEinformationNR message for the user equipment to request Sidelink communication resources from the base station, and the message can indicate the Sidelink resources requested by the user equipment. For example, the user equipment may indicate the Sidelink resources it requests in the SidelinkUEinformationNR message according to its own Sidelink transmission situation and/or requirements.

As an example, the SidelinkUEinformationNR message received by the electronic device 200 from the user equipment may indicate resources of the unlicensed resource pool (e.g., indicate an index of the requested unlicensed resource pool). At this time, the electronic device 200 can, for example, respond to the request of the SidelinkUEinformationNR message and perform channel access processing on the unlicensed frequency band of the unlicensed resource pool specified in the message to obtain the COT, generate downlink control information DCI SL_U indicating that the COT is allocated to the user equipment, and send the downlink control information to the user equipment.

In addition, optionally, in the case where the user equipment can use the authorized resource pool, the SidelinkUEinformationNR message may also indicate the resources of the authorized resource pool (e.g., indicating the index of the requested authorized resource pool). At this time, the electronic device 200, for example, can respond to the request of the SidelinkUEinformationNR message and schedule the authorized resources in the authorized resource pool specified in the message via the generation unit 220, allocate authorized resources for Sidelink communication to the user equipment, generate another downlink control information (for example, DCI format 3_0) indicating the allocation of the authorized resources, and send the other downlink control information to the user equipment.

The user equipment can perform Sidelink transmission based on the received downlink control information DCI SL_U (and optional DCI format 3_0) and according to its own Sidelink transmission situation and/or requirements, using the COT allocated to it as indicated by the DCI SL_U (and the authorized resources for Sidelink communication allocated to it as indicated by the optional DCI format 3_0).

In the second example of dynamically allocating COT, the request for the Sidelink communication resource may be sent via a general scheduling request without indicating a specific Sidelink communication resource. At this time, the electronic device 200 can, for example, respond to the request and perform channel access processing on part or all of the unlicensed frequency bands of an unlicensed resource pool that is pre-configured for the user equipment (and currently available to the user) to obtain the COT, generate downlink control information DCI SL_U indicating that the COT is allocated to the user equipment, and send the downlink control information to the user equipment. In addition, optionally, the electronic device 200 can, for example, allocate authorized resources for Sidelink communication to the user equipment by scheduling the authorized resources in the authorized resource pool via the generation unit 220 in response to the request, generate another downlink control information (e.g., DCI format 3_0) indicating the allocation of the authorized resources, and send the other downlink control information to the user equipment.

The user equipment can perform Sidelink transmission based on the received downlink control information DCI SL_U (and optional DCI format 3_0) and according to its own Sidelink transmission situation and/or requirements, using the COT allocated to it as indicated by the DCI SL_U (and the authorized resources for Sidelink communication allocated to it as indicated by the optional DCI format 3_0).

In addition, in various examples of dynamically allocating COT, the request for Sidelink communication resources received by the electronic device 200 from the user equipment may additionally include further specific requirements of the user equipment's Sidelink communication (such as the priority of the data to be sent, latency requirements, data packet size, and other information), and may be sent by the user equipment in any appropriate manner. In an example, the specific demand for the Sidelink communication of the user equipment received by the electronic device 200 from the user equipment may be in the form of a buffer status report (BSR) or the like.

### Example of Static or Semi-Static Allocation of COT

In the case of static or semi-static allocation of COT, the electronic device 200 can, for example, use the configuration unit 230 to pre-generate configuration information (DCI configuration information) of the downlink control information DCI SL_U for the user equipment. The DCI configuration information, for example, includes the time-frequency resources and sending period for sending the downlink control information DCI SL_U, and the electronic device 200 can use the communication unit 240 to send the DCI configuration information via RRC signaling. Note that, in this embodiment, although the time-frequency resources and period for sending the downlink control information DCI SL_U are configured, the DCI SL_U (i.e., the specific content of the DCI SL_U) sent in each period with the specified time-frequency resources is still regenerated in the period.

Thereafter, in the case of static allocation of COT, in each transmission cycle of the downlink control information DCI SL_U, the electronic device 200 may utilize the access unit 210 to continuously perform channel access processing to obtain the COT, and accordingly utilize the generation unit 220 to generate the downlink control information DCI SL_U. For example, the electronic device 200 may generate a DCI SL_U indicating the COTs when obtaining the maximum number N (e.g., N=3) of COTs that the DCI SL_U can schedule as specified in the format of the DCI SL_U in the current transmission cycle of the DCI SL_U, and stop the channel access processing. Alternatively, the electronic device 200 may continue to perform channel access processing regardless of how many COTs are obtained and generate a DCI SL_U before the current transmission cycle of the DCI SL_U expires, wherein the DCI SL_U indicates the first N (e.g., N=3) COTs obtained in the current transmission cycle; when the number of COTs obtained in the current cycle is less than N, the corresponding resource indication field of the DCI SL_U may be empty or a reserved bit. In addition, the electronic device 200 can use the communication unit 240 to statically send (i.e., periodically send according to the sending period) the downlink control information DCI SL_U obtained in the above manner to the user equipment based on the sending period of the downlink control information DCI SL_U configured for the user equipment.

The case of semi-static allocation of COT is similar to the above-mentioned case of static allocation of COT, with the only difference that, after the electronic device 200 sends the DCI configuration information of DCI SL_U, for example, via RRC signaling, it is also necessary to generate downlink control information DCI (activation DCI) for activating the downlink control information DCI SL_U, for example, via the generation unit 220, and send the above-mentioned activation DCI to the user equipment, for example, via the communication unit 240, to indicate the start (for example, after a specified time slot offset) of the periodic sending of the downlink control information DCI SL_U. Along with the activation action of activating DCI, in each sending cycle of the downlink control information DCI SL_U, the electronic device 200 can use the access unit 210 to continuously perform channel access processing to obtain COT, and correspondingly use the generation unit 220 to generate the downlink control information DCI SL_U, and can use the communication unit 240 to send the downlink control information DCI SL_U obtained in the above manner to the user equipment in a semi-static manner based on the sending cycle of the downlink control information DCI SL_U (that is, periodically sending according to its sending cycle after the downlink control information DCI is activated).

Note that no matter the electronic device 200 allocates COT to the user equipment and generates/sends downlink control information DCI SL_U in a dynamic, static or semi-static manner, as long as the generated downlink control information DCI SL_U includes feedback timing information and the electronic device 200 receives a COT usage feedback signal from the user equipment that is sent according to the sending timing indicated by the feedback timing information, the electronic device 200 can subsequently allocate COT/generate downlink control information DCI SL_U for the user equipment or other user equipment (for example, other UEs within the coverage of the electronic device 200 that need to perform Sidelink transmission on an unlicensed frequency band), refer to the COT usage feedback information carried in the COT usage feedback signal, and reallocate the unused COT, which will not be repeated here.

The above describes the electronic device 200 on the base station side according to the first embodiment, which can obtain COT more easily/quicker than the UE serving a single user and allocate COT to the UE for Sidelink communication, thereby helping to increase the possibility of the UE obtaining the COT and reduce the delay for the UE to obtain the COT, which in turn helps to reduce the delay of the UE in Sidelink communication in the unlicensed frequency band and improve the efficiency of Sidelink communication.

In the above description of the electronic device 200 on the base station side according to the first embodiment, in addition to the electronic device 200 on the base station side, a user equipment (such as SL UE1 shown in FIG. 1) for which the electronic device 200 obtains and allocates COT for Sidelink communication is also described. In other words, for the first embodiment, the inventors propose not only the electronic device on the base station side but also the electronic device on the user side. The following will give a description of the electronic device on the user side of the first embodiment based on the description of the electronic device on the base station side of the first embodiment, and omit unnecessary details.

### I.3. Configuration Example of Electronic Device on User Side

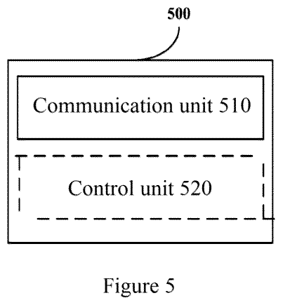

FIG. 5 is a block diagram showing a configuration example of an electronic device on the user side according to the first embodiment.

As shown in FIG. 5, the electronic device 500 may include a communication unit 510 and an optional control unit 520. The communication unit 510 sends information to and/or receives information from devices other than the electronic device 500 (e.g., under the control of an optional control unit 520). In addition, although not shown in the drawings, the electronic device 500 may further include a storage unit.

Here, each unit of the electronic device 500 may be included in a processing circuit. It should be noted that the electronic device 500 may include one processing circuit or multiple processing circuits. Further, the processing circuit may include various discrete functional units to perform various different functions and/or operations. It should be noted that these functional units may be physical entities or logical entities, and units with different names may be implemented by the same physical entity.

Next, in combination with the example scenario shown in FIG. 1, based on the description of the electronic device 200 on the base station side, the example processing of the electronic device 500 on the user side and its various units will be further described, wherein the electronic device 500 can, for example, be used for the user equipment SL UE1 in FIG. 1 that performs Sidelink transmission on an unlicensed frequency band.

### I.3.1 Example Processing of Each Unit of Electronic Device

According to the first embodiment, the communication unit 510 of the electronic device 500 on the user side can (for example, under the control of an optional control unit 220) receives downlink control information, and the downlink control information indicates allocation of the channel occupancy time COT, obtained by the base station side device performing channel access processing on the unlicensed frequency band used for the direct link Sidelink communication, to the electronic device for use in the direct link Sidelink communication.

For ease of description, the downlink control information received by the electronic device 500 and indicating allocation of COT for Sidelink communication may be referred to as Sidelink Unlicensed Resource Scheduling DCI, and may be referred to as Downlink Control Information DCI SL_U in appropriate circumstances.

In Sidelink communication, the user equipment may use a pre-configured resource pool (a collection of pre-configured time-frequency resources/time-frequency resource blocks) for communication. Therefore, optionally, the electronic device 500 on the user side can also receive configuration information of an unauthorized or unlicensed resource set (also referred to as an unauthorized or unlicensed resource pool) for direct link (Sidelink) communication from the base station side device, for example via the communication unit 510. Here, the unlicensed resource set configured by the base station side device for the electronic device 500 includes at least the resources of the unlicensed frequency band on which the base station side device performs channel access processing to obtain the COT (in other words, when an unlicensed resource set is configured for the electronic device 500 on the user side, the base station side device preferably performs channel access processing on all or part of the unlicensed frequency bands in the unlicensed resource set to obtain the COT on such unlicensed frequency band).

Of course, the Sidelink communication configuration information that the user-side electronic device 500 can receive from the base station-side device is not limited to the configuration information of the unauthorized resource pool, but may include the configuration information of the authorized or licensed resource pool similar to that in the prior art, which will not be repeated here.

As an example, the electronic device 500 at the user side may receive a system information block SIB for Sidelink communication configuration from the base station side device, in which a field is added as configuration information of the unlicensed resource set (unlicensed resource pool configuration information). That is, the electronic device 500 on the user side may receive the configuration information of the unlicensed resource set sent via the system information block SIB. For example, the electronic device 500 can receive a system message SIB 12 information element (IE) for NR Sidelink communication configuration from a base station side device. In the SIB 12 message, after the sl-FreqlnfoList-r16 IE used to configure the authorized resource pool, the sl-FreqlnfoList-r18 IE is added to configure the specific content of the unauthorized resource pool for the user equipment. The newly added sl-FreqlnfoList-r18 IE indicates, for example but not limited to, the location of the frequency domain resources of the unlicensed frequency band of the unlicensed resource pool (for example, a subchannel index, etc.). For details of the above SIB 12 message, please refer to the previous description of the electronic device on the base station side of the first embodiment, which will not be repeated here.

In addition, optionally, the electronic device 500 may also receive configuration information of various RRC configurations or RRC reconfigurations from a base station side device, for example, via the communication unit 510. In the case where the base station side device schedules Sidelink communication for the electronic device 500, for example, after the electronic device 500 receives the above-mentioned SIB 12 information carrying resource pool configuration information from the base station side device, RRC reconfiguration can be performed between the electronic device 500 and the base station side device. For example, the electronic device 500 can report Sidelink capabilities to the base station side device (for example, but not limited to, the electronic device 500 reports the unauthorized resource pool that it can currently use and optionally also includes the authorized resource pool that can be used), and can receive from the base station side device configuration information of specific Sidelink resources that it further configures for the electronic device 500 based on the report.

In an example, the electronic device 500 may receive downlink control information DCI SL_U scrambled with a predefined scrambling sequence from a base station side device via the communication unit 510. The predefined scrambling sequence of DCI SL_U used for Sidelink unlicensed resource scheduling may be different from the scrambling sequence (e.g., SL-RNTI) indicating the scheduling of licensed resources for Sidelink communication, so as to facilitate the distinction from DCI format 3_0 used for Sidelink licensed resource scheduling scrambled using the latter. The communication unit 510 may, for example, determine that the received DCI is DCI SL_U for Sidelink unlicensed resource scheduling based on a predefined scrambling sequence of the received downlink control information DCI SL_U, optionally in combination with a valid length of the downlink control information DCI SL_U.

For example, the predefined scrambling sequence used for the downlink control information DCI SL_U may include a scrambling sequence used to indicate scheduling of unlicensed resources for Sidelink communication, such as a scrambling sequence SLU-RNTI specifically set for this purpose. As an example only, the value of the scrambling sequence SLU-RNT may be any one of the hexadecimal sequences FFF3 to FFFD. For example, the electronic device 500 can directly determine that the received DCI is the DCI SL_U for Sidelink unlicensed resource scheduling according to the scrambling sequence SLU-RNTI.

Alternatively, the predefined scrambling sequence used for the downlink control information DCI SL_U may include a scrambling sequence for indicating information related to a delivery time slot, such as an existing SFI-RNTI. In the prior art, a scrambling sequence SFI-RNTI is used to scramble a DCI format 2_0 that notifies a user equipment of a time slot format indication. The DCI format 2_0 generally has a certain valid length or length range. In this case, the communication unit 510 can, for example, determine that the received DCI is DCI SL_U for Sidelink unlicensed resource scheduling based on the scrambling sequence SFI-RNTI, optionally in combination with the effective length of the downlink control information DCI SL_U (different from the effective length of the above-mentioned DCI format 2_0).

### I.3.2 Example of Received Downlink Control Information and Related Processing

The downlink control information DCI SL_U received by the electronic device 500, for example, via the communication unit 510, can indicate the allocation of the COT by the base station side device for the electronic device, for example, may include but is not limited to the allocation of time domain resources in the COT, and optionally may also include the allocation of (available) frequency domain resources in the unlicensed frequency band of the COT. Correspondingly, the downlink control information DCI SL_U received by the electronic device 500 may at least include information indicating the above allocation.

In an example, the downlink control information DCI SL_U received by the electronic device 500 may include COT indication information, which indicates the period of COT allocated to the electronic device. The COT indication information may, for example, indicate the start and end time of the period of COT allocated to the electronic device. In an example, the COT indication information may indicate the time slot offset of the start time slot of the period of COT allocated to the electronic device relative to the DCI SL_U and the number of time slots that period of COT lasts.

In addition, preferably, the downlink control information DCI SL_U received by the electronic device 500 may also include access type information, which indicates the type of channel access processing performed by the base station side to obtain COT. Channel access processing includes, but is not limited to, Cat2 (Type 2) LBT process, Cat3 (Type 3) LBT process, Cat4 (Type 4) LBT process, etc. The type of channel access process may indicate the reliability of the COT obtained via the process (e.g., a more complex Cat4LBT process may have a higher reliability of the COT obtained). Therefore, the access type information obtained by the electronic device 500 on the user side from the downlink control information DCI SL_U will help the electronic device to determine whether to use the corresponding COT. As an example, when the base station side device applies LBT processes with different priorities for channel access processing, the type of channel access processing indicated by the access type information may further include the priority of the LBT used by the base station side for channel access processing. For example, when the base station side adopts the aforementioned Cat4 (Type 4) LBT process with four priorities, the access type information of DCI SL_U may also indicate one of the four priorities {1, 2, 3, 4}.

In addition, optionally, the downlink control information DCI SL_U received by the electronic device 500 may further include frequency domain resource indication information, which indicates the frequency domain resources of the unlicensed frequency band allocated to the electronic device. As an example, the frequency domain resource indication information may indicate a subchannel index of a subchannel in an unlicensed frequency band allocated to the electronic device.

In a preferred example, the downlink control information DCI SL_U received by the electronic device 500 may include N resource allocation fields for N COTs (N is a natural number greater than or equal to 1), and each resource allocation field includes the above-mentioned COT indication information, access type information and frequency domain resource indication information for the corresponding COT. The electronic device 500 can advantageously obtain various information of the corresponding COT from each resource allocation field and select an appropriate COT for Sidelink communication accordingly if possible.

Optionally, N=1, that is, the downlink control information DCI SL_U includes one resource allocation field for one COT. Such a setting is conducive to reducing the delay for the electronic device 500 to obtain the COT allocated to it by the base station side device.

Alternatively, N>1, that is, the downlink control information DCI SL_U includes multiple resource allocation fields for multiple COTs, so that one downlink control information DCI SL_U can allocate a maximum of N COTs to the electronic device 500. Such a configuration is beneficial for the electronic device 500 to obtain the right to select different COTs/different COT usage methods. For example, the electronic device 500 may comprehensively consider the time periods of each COT (such as the start time and duration), the type of channel access processing (which may, for example, characterize the reliability of the COT), and the location of the corresponding frequency domain resources (such as whether enough frequency domain resources are allocated, etc.), and select from the allocated COTs (such as the earliest COT, the longest COT, or using multiple COTs at a time, etc.) according to the Sidelink transmission to be performed (such as the priority of the data to be sent, the delay requirements, the data packet size, and other information).

Preferably, N=3, that is, the downlink control information DCI SL_U includes 3 resource allocation fields for 3 COTs. Such a setting is conducive to achieving a balance between reducing the delay in allocating COTs to the electronic device 500 on the user side and providing the electronic device with the right to choose different COTs/different COT usage methods (for example, selecting the earliest COT, the longest COT, or using multiple COTs at a time). Note that although the downlink control information DCI SL_U may include N resource allocation fields for N COTs (N>1), some of the fields may be empty and, for example, filled with reserved bits (e.g., all 0s), and only less than N COTs are allocated to the electronic device 500 on the user side (e.g., when N=3, only 1 or 2 COTs may be allocated).

In addition, optionally, the downlink control information DCI SL_U received by the electronic device 500 may further include feedback timing information, which indicates the sending timing of an uplink signal (COT usage feedback signal) used to feedback the usage of the COT. The transmission timing of the COT use feedback signal indicated by the feedback timing information is earlier than the start time of the COT allocated to the electronic device.

As an example, the feedback timing information may indicate a time slot offset of a transmission time slot of an uplink COT feedback signal relative to a time slot of a DCI SL_U. Preferably, even if the downlink control information DCI SL_U includes multiple resource allocation fields for multiple COTs, a feedback timing information is used to indicate the sending timing of the feedback signal used by an uplink COT for all COTs; this is conducive to simplifying the feedback process and facilitating the subsequent unified allocation of unused COTs by the base station side equipment.

The user-side electronic device 500 that receives the downlink control information DCI SL_U can, under the control of the control unit 520, use the communication unit 510 to send an uplink signal (uplink COT usage feedback signal) for feedback on the usage of COT at the sending timing indicated by the feedback timing information of DCI SL_U. The electronic device 500 may send the uplink COT usage feedback signal in any appropriate manner, as long as it can reflect the usage of the COT, that is, carries the COT usage feedback information.

As an example, the electronic device 500 may generate COT usage feedback information using the control unit 520, and send an uplink COT usage feedback signal carrying the feedback information using the communication unit 510 in any appropriate manner.

As an example, the COT usage feedback information generated by the electronic device 500 can be a feedback information sequence in the form of a binary sequence. The length of the feedback information sequence can be equal to the number of COTs allocated in the downlink control information DCI SL_U or the number of resource allocation fields. Each bit in the feedback information sequence can indicate whether the corresponding COT will be used by the electronic device 500 (0 means it will not be used, 1 means it will be used). For example, when the downlink control information DCI SL_U includes three resource allocation fields for three COTs (COT1, COT2, COT3), when the electronic device 500 decides not to use COT1 and to use COT2 and COT3 based on the contents of these resource allocation fields and its own Sidelink transmission situation and/or requirements, the feedback information sequence generated by the electronic device 500 can, for example, have the form of 011.

The electronic device 500, for example, may utilize the communication unit 510 to use the PUCCH or PUSCH channel to transmit an uplink COT usage feedback signal carrying the above-mentioned COT usage feedback information. In an example, the electronic device 500 uses a cyclically shifted basic sequence transmitted by PUCCH as a COT usage feedback signal, wherein the number of cyclic shifts of the basic sequence is used to indicate the carried COT usage feedback information, i.e., a binary feedback information sequence. For example, when the feedback information sequence generated by the control unit 520 takes the value of 011, the number of cyclic shifts of the basic sequence sent by the communication unit 510 as the COT feedback signal is 3 corresponding to 011. In another example, the electronic device 500 uses the PUSCH channel to transmit an uplink COT usage feedback signal carrying the COT usage feedback information, for example, directly sends the COT usage feedback signal carrying the COT usage feedback information 011 as data content to the base station side device.

In the Sidelink unlicensed frequency band transmission, the base station side device is only responsible for allocating the obtained COT to the electronic device 500 on the user side and will not use the COT for any transmission itself. When the electronic device 500 receives the downlink control information DCI SL_U indicating allocation of COT, it selects the allocated COT according to the situation and/or demand for Sidelink transmission, and may choose not to use part or even all of the allocated COT. The electronic device 500 on the user side sends an uplink signal to feedback COT usage according to the sending timing specified by the feedback timing information of the downlink control information DCI SL_U, which is beneficial for the base station side device to schedule and control the use of Sidelink unlicensed resources and reduce the waste of unlicensed resources. For example, when the base station side device learns from the user side electronic device 500 that the latter does not use a certain COT, it can subsequently allocate the COT to the electronic device or other user equipment (for example, other UEs within the coverage range of the base station side device that need to perform Sidelink transmission on an unlicensed frequency band).

An example of time domain resource usage indicated by the downlink control information DCI SL_U received by the electronic device 500 may be as shown in FIG. 3 described above in the description of the electronic device 200 on the base station side, and will not be repeated here.

As described above, for example, an unlicensed resource pool can be configured by the base station side device for the electronic device 500 on the user side, and in this case, the base station side device preferably performs channel access processing on all or part of the unlicensed frequency bands in the unlicensed resource pool (configured for the electronic device 500 and currently available to the electronic device 500) to obtain COT on such unlicensed frequency bands. Accordingly, in a preferred example, the downlink control information DCI SL_U received by the electronic device 500 on the user side may also additionally include resource pool indication information, which indicates the unlicensed resource pool on which the base station side device performs channel access processing to obtain COT. The resource pool indication information may indicate, for example, an unlicensed resource pool index. Note that at this time, the frequency domain resource indication information in the downlink control information DCI SL_U indicates the frequency domain resources (e.g., subchannel indexes) in the unlicensed resource pool.

The example format of the downlink control information DCI SL_U received by the electronic device 500 may be as shown in FIG. 4 described above in the description of the electronic device 200 on the base station side, and will not be repeated here.

Note that although in the above description, a preferred example is described in which the downlink control information DCI SL_U indicates that the base station side device allocates 3 COTs to the electronic device 500 on the user side, the number of COTs allocated to the electronic device is not limited to this, but can be more or less than 3; the embodiments of the present disclosure are not limited to this.

### I.3.3 Example Way of Obtaining COT Allocated by the Base Station Side

The user-side electronic device 500 of this embodiment can obtain the COT allocated to the electronic device by the base station side device in a dynamic, static or semi-static manner. In the case of dynamic allocation of COT, the electronic device 500 obtains the COT allocated by the base station side device in a dynamic manner by sending a request for Sidelink communication resources to the base station side device; in the case of static or semi-static allocation of COT, the base station side device, for example, pre-configures the sending period of downlink control information DCI SL_U for the electronic device 500, and the electronic device 500 can obtain the COT allocated to it by the base station side device periodically (statically) or periodically (semi-statically) after activating the downlink control information DCI SL_U based on the sending period.

### Example of Obtaining COT Dynamically Allocated on the Base Station Side

First, consider the case where the base station side equipment dynamically allocates COT. In the case where the base station side device dynamically allocates COT, the electronic device 500 can use the communication unit 510 to send a request for resources for Sidelink communication to the base station side device, and receive downlink control information DCI SL_U sent in response to the request.

As an example, when the electronic device 500 on the user side has a Sidelink transmission requirement (such as a synchronization signal or data signal transmission requirement), under the control of the control unit 520, the communication unit 510 may send a request for Sidelink communication resources to the base station side device.

In the first example of obtaining the dynamic allocation of COT by the base station side device, the request of the electronic device 500 on the user side for Sidelink communication resources can be sent via a SidelinkUEinformationNR message used by the user equipment to request Sidelink communication resources from the base station, and the message can indicate the Sidelink resources requested by the electronic device 500. For example, the electronic device 500 can indicate the Sidelink resources requested by the electronic device 500 in the SidelinkUEinformationNR message transmitted by the communication unit 510, for example, under the control of the control unit 520, based on its own Sidelink transmission situation and/or requirements (for example, information such as the priority of the data to be sent, latency requirements, and data packet size).

As an example, the SidelinkUEinformationNR message may indicate a request for resources in a non-licensed or unlicensed resource pool (e.g., an index of the requested non-licensed resource pool). At this time, the base station side device can, for example, respond to the request of the SidelinkUEinformationNR message and perform channel access processing on the unlicensed frequency band of the unlicensed resource pool specified in the message to obtain the COT, generate downlink control information DCI SL_U indicating that the COT is allocated to the electronic device 500 on the user side, and send the downlink control information to the electronic device.

In addition, optionally, in the case that the electronic device 500 is able to use the authorized or licensed resource pool, the above-mentioned SidelinkUEinformationNR message may also indicate the resources of the authorized resource pool (for example, indicating the index of the requested authorized resource pool). At this time, the base station side device can, for example, respond to the request of the SidelinkUEinformationNR message by scheduling the authorized resources in the authorized resource pool specified in the message, allocate authorized resources for Sidelink communication to the electronic device 500 on the user side, generate another downlink control information (e.g., DCI format 3_0) indicating the allocation of the authorized resources, and send the other downlink control information to the electronic device.

The electronic device 500 on the user side can perform Sidelink transmission based on the received downlink control information DCI SL_U (and optional DCI format 3_0) and according to its own Sidelink transmission situation and/or requirements (such as the priority of the data to be sent, latency requirements, data packet size, etc.), using the COT allocated to it as indicated by the DCI SL_U (and the authorized resources for Sidelink communication allocated to it as indicated by the optional DCI format 3_0).

In the second example of obtaining the dynamic allocation of COT by the base station side device, the request of the electronic device 500 on the user side for the Sidelink communication resource can be sent via a general scheduling request, and no specific Sidelink communication resource is indicated. At this time, the base station side device can, for example, respond to the request and perform channel access processing on part or all of the unlicensed frequency bands of an unlicensed resource pool that is pre-configured for the electronic device 500 on the user side (and that the electronic device 500 can currently use) to obtain the COT, generate downlink control information DCI SL_U indicating that the COT is allocated to the electronic device, and send the downlink control information to the electronic device. In addition, optionally, the base station side device can, for example, allocate authorized resources for Sidelink communication to the electronic device 500 on the user side by scheduling authorized resources in the authorized resource pool in response to the request, generate another downlink control information (e.g., DCI format 3_0) indicating the allocation of the authorized resources, and send the other downlink control information to the electronic device. The electronic device 500 can perform Sidelink transmission based on the received downlink control information DCI SL_U (and optional DCI format 3_0) and according to its own Sidelink transmission situation and/or requirements (such as the priority of the data to be sent, latency requirements, data packet size, etc.), using the COT allocated to it as indicated by the DCI SL_U (and the authorized resources for Sidelink communication allocated to it as indicated by the optional DCI format 3_0).

In addition, in each example of obtaining dynamic allocation of COT by base station side equipment, the request for Sidelink communication resources sent by the electronic device 500 may additionally include further specific requirements for its Sidelink communication (such as the priority of the data to be sent, latency requirements, data packet size, and other information), and the above-mentioned specific requirements for Sidelink communication are sent in any appropriate manner. In an example, the specific requirement of the Sidelink communication sent by the electronic device 500 may be in the form of a buffer status report (BSR).

### Example of Obtaining Static or Semi-Static Allocation of COT by the Base Station Side

When the base station side device statically or semi-statically allocates COT, the electronic device 500 on the user side can, for example, receive the configuration information (DCI configuration information) of the downlink control information DCI SL_U generated for it by the base station side device via RRC signaling through the communication unit 510, and the DCI configuration information includes, for example, the time-frequency resources and sending period for sending the downlink control information DCI SL_U.

Thereafter, when the base station side device statically allocates COT to the electronic device 500, in each sending cycle (or sending period) of the downlink control information DCI SL_U, the electronic device 500 can use the communication unit 510 to receive the downlink control information DCI SL_U periodically sent according to the sending cycle (i.e., sent in a static manner) based on the sending cycle of the downlink control information DCI SL_U indicated in the DCI configuration information and the time-frequency resource position. The downlink control information DCI SL_U may be generated accordingly by the base station side device by continuously performing channel access processing in each sending cycle to obtain COT. For example, it may indicate the maximum number N (for example, N=3) of COTs that can be scheduled by DCI SL_U as specified by the format of DCI SL_U. When the number of COTs obtained in the current cycle is less than N, the corresponding resource indication field of DCI SL_U may be empty or a reserved bit.

The case where the base station side device semi-statically allocates COT is similar to the above-mentioned case of statically allocating COT, with the only difference that, after the electronic device 500 on the user side receives the DCI configuration information of DCI SL_U using the communication unit 520, for example, via RRC signaling, it is also necessary to, for example, receive the downlink control information DCI (activation DCI) sent by the base station side device for activating the downlink control information DCI SL_U, which, for example, indicates the start (for example, after a specified time slot offset) of the periodic sending (periodic transmission) of the downlink control information DCI SL_U. The electronic device 500 can use the communication unit 240 to receive the downlink control information DCI SL_U periodically sent (i.e., sent in a semi-static manner) by the base station side device according to the indication of activating DCI, the sending period of the downlink control information DCI SL_U indicated in the DCI configuration information, and the time-frequency resource location after the activation action.

The above describes the user-side electronic device 500 according to the first embodiment, which can rely on the base station side device that can obtain the COT more easily/faster than the UE serving a single user to obtain the COT allocated to it by the base station side device for Sidelink communication, thereby facilitating the improvement of the possibility of the electronic device obtaining the COT and reducing the delay of the electronic device obtaining the COT, thereby facilitating the reduction of the delay of the electronic device in performing Sidelink communication in an unlicensed frequency band and improving the efficiency of Sidelink communication.

### I.4. Example Signaling Flow

Next, an example signaling interaction for a base station side device to obtain and allocate COT to a user equipment according to the first embodiment of the present disclosure will be described with reference to a specific example, which can be implemented, for example, by utilizing the interaction between the electronic device 200 on the base station side and the electronic device 500 on the user side of the above-mentioned first embodiment.

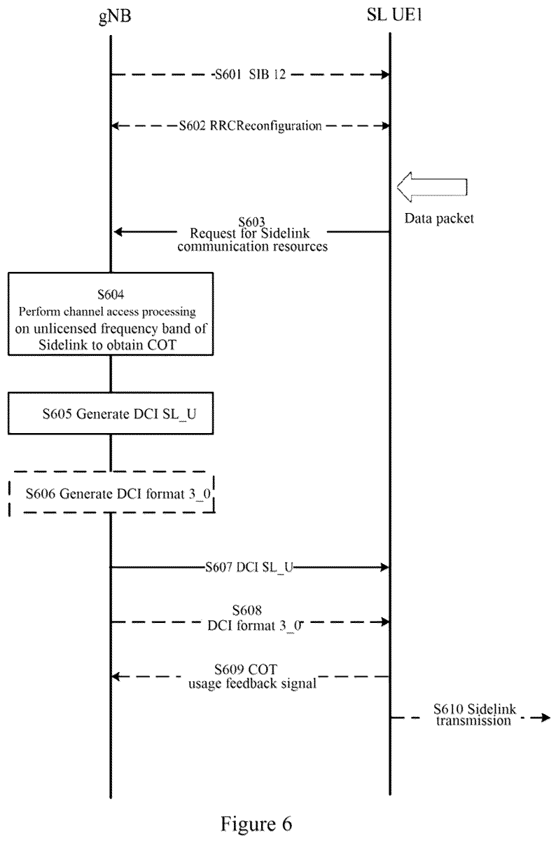

FIGS. 6, 7 and 8 are flowcharts for illustrating the first, second and third example signaling interactions for the base station side device to obtain and allocate COT to the user equipment according to the first embodiment, which are examples of dynamic allocation, static allocation and semi-static allocation, respectively. In the examples of FIGS. 6 to 8, the electronic device 200 on the base station side is, for example, used for the base station gNB in the example of FIG. 1, and the electronic device 500 on the user side is, for example, used for the transmitting user equipment SL UE1 in the example of FIG. 1.

Note that since this embodiment focuses on the COT allocation of the base station-side device to the transmitting user equipment, in order to avoid blurring the focus, the receiving user equipment SL UE2 is omitted in the examples of FIGS. 6 to 8. SL UE1 can perform various necessary signaling interactions with SL UE2 required for Sidelink communication between the two. For example, after receiving the SIB 12 message from the gNB, SL UE1 can determine the resource pool that can be used for Sidelink communication with SL UE2 through interaction with SL UE2 (and can report the resource pool during the RRC reconfiguration phase with the gNB). Details are not repeated here. Note that only when SL UE1 and SL UE2 can use the same resource pool can SL UE1 use the resource pool for Sidelink communication with SL UE2; therefore, there is a possibility that SL UE1 can only perform Sidelink communication with SL UE2 via the unauthorized resource pool.

### I.4.1 Example Signaling Flow for Dynamic Allocation

In the example of dynamic allocation, as shown in FIG. 6, optionally, first, in step S601, the base station gNB sends a system message SIB 12 to the user equipment SL UE1. The SIB 12 message, for example, may include Sidelink communication configuration information generated by the gNB for SL UE1, which may include unauthorized resource pool configuration information and optionally authorized resource pool configuration information.

Next, in step S602, RRC reconfiguration is performed between the base station gNB and the user equipment SL UE1, which may include, for example, SL UE1 reporting Sidelink capabilities to the gNB (for example, but not limited to, the user equipment reporting the currently available unauthorized resource pool and optionally the currently available authorized resource pool) and the gNB further configuring specific Sidelink resources for SL UE1 based on the report.

Thereafter, for example, as shown in the figure, when the user equipment SL UE1 has a data packet to be transmitted via Sidelink (or alternatively, for example, when SL UE1 has a need to send or broadcast a Sidelink synchronization signal), in step S603, the user equipment SL UE1 sends a request for Sidelink communication resources to the base station gNB.

In response to the request for Sidelink communication resources by the user equipment SL UE1 in step S603, the base station gNB performs channel access processing on the unlicensed frequency band to obtain COT in step S604, generates downlink control information DCI SL_U in step S605 to indicate the allocation of the COT to SL UE1, and sends the downlink control information DCI SL_U to SL UE1 in step S607. The downlink control information DCI SL_U generated and sent by the base station gNB in steps S605 and S607 may include one or more resource indication fields for one or more COTs, and each resource indication field may include COT indication information, access type information, and frequency domain resource indication information for the corresponding COT. Optionally, for example, in step S601, the base station gNB sends a system message SIB 12 to the user equipment SL UE1 and the SIB 12 message includes unlicensed resource pool configuration information, and in step S602, SL UE1 reports to the gNB that it can currently use the unlicensed resource pool, the above-mentioned downlink control information DCI SL_U may also include resource pool indication information to indicate the unlicensed resource pool. In addition, optionally, the downlink control information DCI SL_U may also include feedback timing information.

Optionally, for example, in a case where in step S601, the base station gNB sends a system message SIB 12 to the user equipment SL UE1 and the SIB 12 message includes the authorized resource pool configuration information, and in step S602, SL UE1 reports to the gNB that it can currently use the authorized resource pool, as shown in the figure, in response to the user equipment SL UE1's request for Sidelink communication resources in step S603, the base station may also allocate authorized resources from the authorized resource pool for Sidelink communication to SL UE1 in step S606 and generate downlink control information DCI format 3_0 indicating the allocation, and send downlink control information DCI format 3_0 to SL UE1 in step S608.

Thereafter, the user equipment SL UE1 may perform Sidelink transmission in step S610 based on the received downlink control information DCI SL_U (and optional DCI format 3_0) and according to its own Sidelink transmission situation and/or requirements, using the COT allocated to it as indicated by DCI SL_U (and optional authorized resources for Sidelink communication allocated to it as indicated by DCI 3_0). The Sidelink transmission in step S610 may be, for example, sending a Sidelink data signal to the SL UE2, or may be broadcasting a Sidelink synchronization signal, which is not limited in this embodiment.

In addition, optionally, when the downlink control information DCI SL_U received by the user equipment SL UE1 in step S607 includes feedback timing information, before performing the Sidelink transmission in step S610, SL UE1 may send a COT usage feedback signal to the gNB in step S609 according to the sending timing indicated by the feedback timing information, so as to facilitate the subsequent reallocation of unused COT by the gNB.

### I.4.2 Example Signaling Flow for Static Allocation

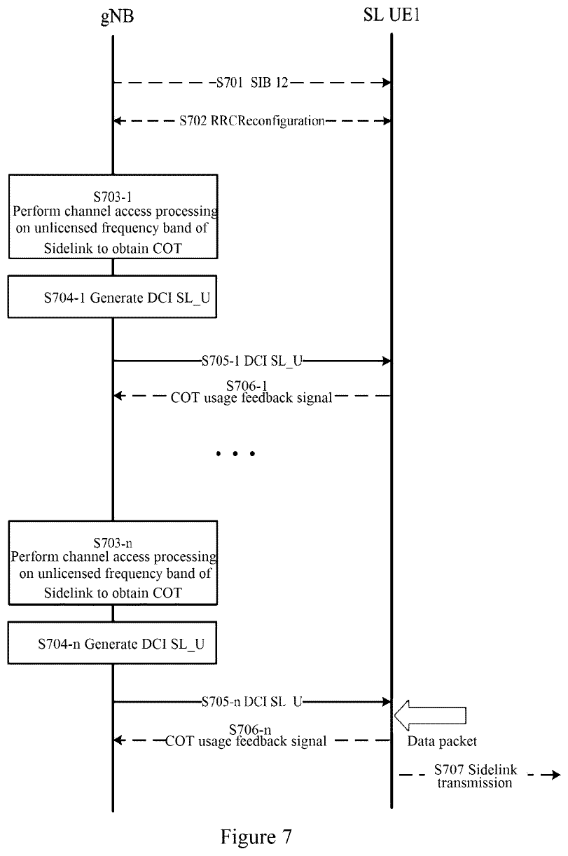

In the example of static allocation, as shown in FIG. 7, optionally, first, in step 7601, the base station gNB sends a system message SIB 12 to the user equipment SL UE1. The SIB 12 message may include, for example, Sidelink communication configuration information generated by the gNB for SL UE1, which may include unauthorized resource pool configuration information.

Next, in step S702, RRC reconfiguration is performed between the base station gNB and the user equipment SL UE1, which may include, for example, SL UE1 reporting Sidelink capabilities to the gNB (for example, but not limited to, the user equipment reporting the unauthorized resource pool currently available to it), the gNB further configuring specific Sidelink resources for SL UE1 based on the report, and the gNB configuring the periodic downlink control information DCI SL_U for Sidelink unauthorized resource scheduling for SL UE1, and the configuration at least includes configuring the time-frequency resources and sending period for sending DCI UL_U, so that the user equipment SL UE1 can receive DCI UL_U according to the configuration information.

Thereafter, as shown in the figure, in the i-th sending (or transmission) cycle (or period) of the downlink control information DCI SL_U, the base station gNB performs channel access processing in step S703-i to obtain COT, generates downlink control information DCI SL_U in step S704-i to indicate the allocation of the COT to SL UE1, and sends downlink control information DCI SL_U (i=1, . . . , n) to SL UE1 in step S705-i. The downlink control information DCI SL_U may include one or more resource indication fields for one or more COTs, and each resource indication field may include COT indication information, access type information, and frequency domain resource indication information for the corresponding COT. Optionally, for example, in step S701, the base station gNB sends a system message SIB 12 to the user equipment SL UE1 and the SIB 12 message includes unlicensed resource pool configuration information, and in step S602, SL UE1 reports to the gNB that it can currently use the unlicensed resource pool, the above-mentioned downlink control information DCI SL_U may also include resource pool indication information to indicate the unlicensed resource pool. In addition, optionally, the above-mentioned downlink control information DCI SL_U may also include feedback timing information.

Optionally, when the downlink control information DCI SL_U sent by the base station gNB to the user equipment SL UE1 in each sending cycle includes feedback timing information, SL UE1 may send a COT usage feedback signal to the gNB in step S706-i (i=1, . . . , n) in each sending cycle according to the sending timing indicated by the feedback timing information, so as to facilitate the gNB to subsequently reallocate the unused COT in the cycle. For example, before the nth transmission cycle, the COT usage feedback signal sent by SL UE1 to gNB in each transmission cycle can indicate that it is not using COT.

For example, after the base station gNB sends the downlink control information DCI SL_U to SL UE1 in step S705-n of the nth sending cycle, the user equipment SL UE1 has a data packet to be transmitted via Sidelink (or alternatively, for example, SL UE1 has a need to send or broadcast a Sidelink synchronization signal). At this time, the user equipment SL UE1, for example, can perform Sidelink transmission in step S707 based on the downlink control information DCI SL_U received in each sending cycle and according to its own Sidelink transmission situation and/or needs, using the COT that can be used in the COT allocated to it indicated by each DCI SL_U received in each sending cycle, or directly using the COT indicated by the DCI SL_U received in the most recent nth sending cycle. The Sidelink transmission in step S707 may be, for example, sending a Sidelink data signal to the SL UE2, or may be broadcasting a Sidelink synchronization signal, which is not limited in this embodiment.

### I.4.3 Example Signaling Flow for Semi-Static Allocation

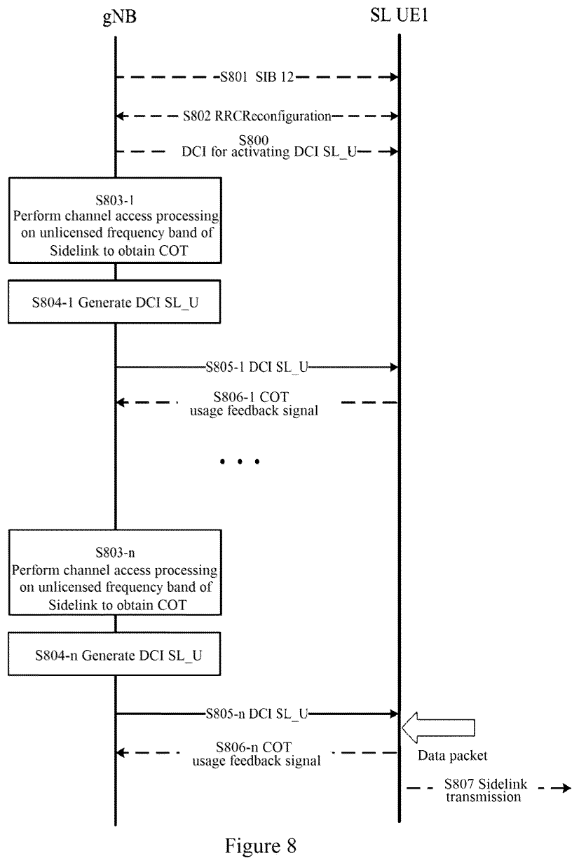

As shown in FIG. 8, the example process of semi-static allocation is roughly similar to the example process of static allocation shown in FIG. 7. The example process of FIG. 8 includes steps S801 to S802 and steps S803-1 to S807 which are similar to steps S701 to S707 in FIG. 7; the difference between the example process of FIG. 8 and the example process of FIG. 7 is that, in the example of semi-static allocation, in the RRC reconfiguration between the base station gNB and the user equipment SL UE1 in step S802, the gNB configures SL UE1 with semi-statically transmitted (rather than periodically transmitted) downlink control information DCI SL_U for Sidelink unlicensed resource scheduling; then, in the newly added step S800, the base station gNB sends an activation DCI for activating the downlink control information DCI SL_U to the user equipment SL UE1. With the activation action of step S800, the base station gNB and the user equipment SL UE1 can perform processing similar to steps S703-1 to S707 of FIG. 7 in steps S803-1 to S807; that is, after the action of activating the downlink control information DCI SL_U, the base station gNB performs channel access to obtain COT, generates downlink control information DCI SL_U, sends DCI SL_U, and other processing, and the user equipment SL UE1 also performs corresponding processing thereafter, which will not be repeated here.

### I.5. Method Example

Corresponding to the device embodiment of the first embodiment described above, the present disclosure provides the following method embodiments.

### I.5.1 Method Embodiment on Base Station Side

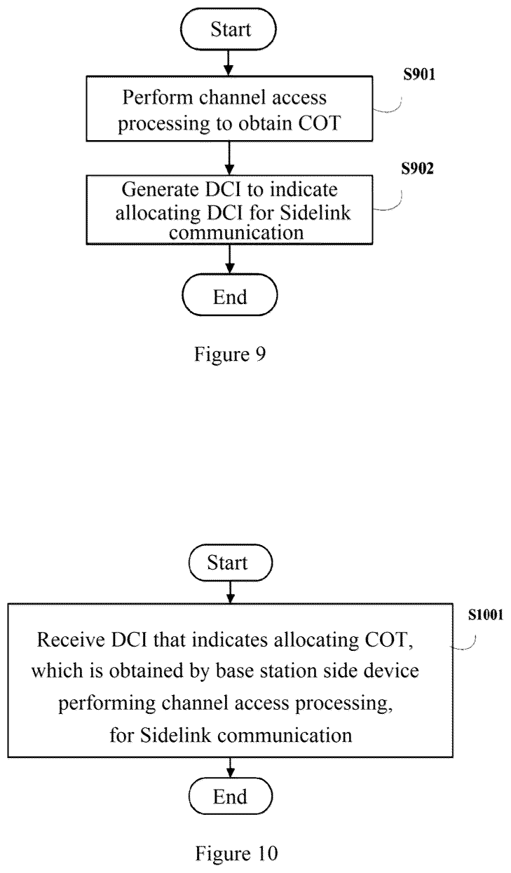

FIG. 9 is a flowchart showing a procedure example of a method for wireless communication on the base station side according to the first embodiment.

As shown in FIG. 9, in step S901, a channel access process is performed on an unlicensed frequency band used for direct link (Sidelink) communication to obtain a channel occupation time COT.

Next, in step S902, downlink control information is generated to indicate allocation of COT to the user equipment for direct link (Sidelink) communication.

In an example, the downlink control information generated in step S902 may include COT indication information, which indicates the period of the COT allocated to the user equipment.

Optionally, the downlink control information may further include access type information, which indicates the type of the channel access processing. For example, the type of channel access processing may further include a priority of listen-before-talk (LBT) for performing the channel access processing.

Optionally, the downlink control information may further include frequency domain resource indication information, which indicates the frequency domain resources of the unlicensed frequency band allocated to the user equipment.

As an example, the downlink control information may include multiple resource allocation fields for multiple COTs, and each resource allocation field includes the COT indication information, the access type information, and the frequency domain resource indication information for a corresponding COT.

Optionally, the downlink control information may further include feedback timing information, which indicates the sending or transmitting timing of an uplink signal for feeding back the usage of the COT.

In addition, although not shown in the figure, optionally, in the example process of FIG. 9, before step S901, a step of configuring an unlicensed resource set for the user equipment for direct link (Sidelink) communication may be additionally included, and the unlicensed resource set includes at least resources of the unlicensed frequency band. In addition, optionally, before step S901, a step of sending configuration information of the unlicensed resource set to the user equipment through a system information block SIB (e.g., SIB 12 information) may be additionally included.

In addition, although not shown in the figure, optionally, in the example process of FIG. 9, after step S902, a step of sending the downlink control information to the user equipment may be additionally included. In addition, optionally, the step of sending the downlink control information may include scrambling the downlink control information with a predefined scrambling sequence. In one example, the predefined scrambling sequence may include a scrambling sequence for indicating scheduling of unlicensed resources for direct link (Sidelink) communication, or a scrambling sequence for indicating transfer of time slot related information.

In addition, although not shown in the figure, the example process of FIG. 9 may be performed in a dynamic manner, a periodic manner, or a semi-static manner.

In a dynamic manner, in response to a request from the user equipment for resources for direct link (Sidelink) communication, the channel access processing of step S901 to obtain the COT, the generation of the downlink control information of step S902, and the processing of sending the downlink control information to the user equipment (not shown) can be performed. In a dynamic manner, although not shown in the figure, optionally, in the example process of FIG. 9, the following processing may also be included: in response to a request from the user equipment for resources for direct link (Sidelink) communication, authorized resources for direct link (Sidelink) communication are also allocated to the user equipment, another downlink control information indicating the allocation of the authorized resources is generated, and the another downlink control information is sent to the user equipment.

In a static or semi-static manner, the channel access processing of step S901 to obtain the COT and the processing of generating the downlink control information of step S902 can be continuously performed, and the downlink control information is sent to the user equipment in a static or semi-static manner based on the sending period of the downlink control information configured for the user equipment.

According to an embodiment of the present disclosure, the subject that executes the above method may be an electronic device on the base station side according to the first embodiment of the present disclosure. Therefore, all the embodiments of the electronic device on the base station side of the first embodiment in the previous text are applicable here and will not be repeated here.

### I.5.2 Method Embodiment on User Side

FIG. 10 is a flowchart showing a process example of a method for wireless communication on the user side according to the first embodiment.

As shown in FIG. 10, in step S1001, downlink control information DCI is received, and the downlink control information indicates allocation of a channel occupancy time COT, which is obtained by a base station side device performing channel access processing on an unlicensed frequency band for direct link Sidelink communication, to the electronic device for Sidelink communication.

In an example, the downlink control information received in step S1001 may include COT indication information, which indicates the period of the COT allocated to the electronic device.

Optionally, the downlink control information may further include access type information, which indicates the type of the channel access processing. For example, the type of channel access processing may further include a priority of listen-before-talk (LBT) for performing the channel access processing.

Optionally, the downlink control information may further include frequency domain resource indication information, which indicates the frequency domain resources of the unlicensed frequency band allocated to the electronic device.

As an example, the downlink control information may include multiple resource allocation fields for multiple COTs, and each resource allocation field includes the COT indication information, the access type information, and the frequency domain resource indication information for a corresponding COT.

Optionally, the downlink control information may further include feedback timing information, which indicates the sending timing of an uplink signal for feeding back the usage of the COT. In this case, although not shown in the figure, optionally, in the example process of FIG. 10, after step S1001, the following step may be additionally included: at the sending timing indicated by the feedback timing information, an uplink signal for feeding back the usage of the COT is sent.

Optionally, in step S1001, the downlink control information scrambled with a predefined scrambling sequence may be received. In one example, the predefined scrambling sequence may include a scrambling sequence for indicating scheduling of unlicensed resources for direct link (Sidelink) communication, or a scrambling sequence for indicating transfer of time slot related information.

In addition, although not shown in the figure, optionally, in the example process of FIG. 10, before step S1001, it can also additionally include a step of receiving configuration information of an unlicensed resource set for direct link (Sidelink) communication from the base station side device, and the unlicensed resource set includes at least resources of the unlicensed frequency band. In this step, the configuration information sent via a system information block SIB (e.g., SIB 12 information) may be received.

In addition, although not shown in the figure, the example process of FIG. 10 may be performed in a dynamic manner, a periodic manner, or a semi-static manner.

In a dynamic manner, the example process of FIG. 10 may further include a step of sending a request for resources for direct link (Sidelink) communication to the base station side device before step S1001, and in step S1001, the downlink control information sent in response to the request may be received. In a dynamic manner, although not shown in the figure, optionally, in the example process of FIG. 10, a step of receiving another downlink control information sent by the base station side device in response to the request may also be included, wherein the other downlink control information indicates the allocation of authorized resources for direct link (Sidelink) communication.

In a static or semi-static manner, in step S1001, the downlink control information sent in a static or semi-static manner may be received based on a sending period of the downlink control information configured by the base station side device for the electronic device.

According to an embodiment of the present disclosure, the subject executing the above method may be an electronic device on the user side according to the first embodiment of the present disclosure, and therefore all the embodiments of the electronic device on the user side of the first embodiment in the foregoing text are applicable here and will not be repeated here.

### II. Second Embodiment and Third Embodiment

### II.1. Overview

As mentioned above, in Sidelink communication in the unlicensed frequency band, the user equipment at the transmitting end needs to first perform channel access processing on the unlicensed frequency band used for Sidelink communication before performing any Sidelink transmission (including broadcasting the Sidelink synchronization signal or sending a data signal to the user equipment at the receiving end), and can perform Sidelink transmission only after winning the channel competition and obtaining the channel occupation time COT.

In this case, the efficiency of the Sidelink communication of the user equipment in the unlicensed frequency band may be low. Compared with the inefficient transmission of Sidelink data signals, if the Sidelink synchronization signal (hereinafter referred to as S-SSB) cannot be transmitted efficiently, it will cause many problems in the synchronization process between the transmitting UE and the receiving UE and directly affect the subsequent data signal transmission, thereby further seriously reducing the efficiency of Sidelink communication.

To this end, the inventors propose to transmit the Sidelink synchronization signal in the unlicensed frequency band in a multiplexing manner in the Sidelink communication in the unlicensed frequency band, thereby improving the transmission efficiency of the Sidelink synchronization signal in the unlicensed frequency band and further improving the efficiency of the Sidelink communication in the unlicensed frequency band.

Specifically, in the second embodiment of the present disclosure, a base station, which serves multiple users and is easy to win the channel contention, obtains the channel occupancy time COT of the unlicensed frequency band used to transmit the Sidelink synchronization signal (hereinafter also referred to as the unlicensed frequency band used to transmit S-SSB), and it allows multiple transmitting user equipments to reuse the resources of the unlicensed frequency band used to transmit S-SSB within the COT to transmit the S-SSB of the unlicensed frequency band of each user equipment, thereby improving the transmission efficiency of the S-SSB of the unlicensed frequency band of each user equipment. In addition, in the third embodiment of the present disclosure, a single user equipment transmits the Sidelink synchronization signal of the unlicensed frequency band by using the time-frequency resources of the Sidelink synchronization signal and the Sidelink data signal on the unlicensed frequency band in a multiplexing manner, thereby also improving the transmission efficiency of the Sidelink synchronization signal of the unlicensed frequency band of the user equipment.

Next, the apparatus and method according to the second and third embodiments of the present disclosure are further described.

### I1.2. Configuration Example of Electronic Device of Second Embodiment

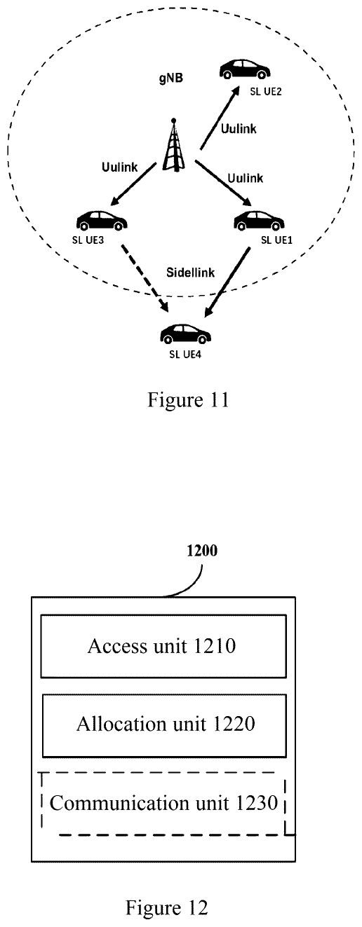

FIG. 11 is a schematic diagram showing an application scenario according to the second embodiment of the present disclosure, wherein an example of a mode in which a base station schedules Sidelink transmission, namely, Sidelink resource allocation mode 1 is shown. As shown in FIG. 11, multiple user equipment SL UE1, SL UE2, and SL UE3 are all within the coverage of the base station gNB and operate in Sidelink resource allocation mode 1. Another user equipment SL UE4 is outside the coverage of the base station gNB, and SL UE1, SL UE2, and SL UE3 can communicate with the gNB via Uulink, and then use the unlicensed frequency band resources for transmitting S-SSB within the COT allocated by the gNB to transmit the Sidelink synchronization signal S-SSB to the user equipment outside the coverage of the gNB, such as SL UE4.

As shown in FIG. 11, at a certain period, multiple user equipments SL UE1 and SL UE3 (even SL UE2 whose transmission requirement is not marked in the figure) may all desire to broadcast or send a Sidelink synchronization signal S-SSB to SL UE4. In this case, according to this embodiment, the base station gNB can be used to obtain the COT of the unlicensed frequency band for transmitting S-SSB, so that, for example, the resources within the COT can be shared among multiple user equipment (for example, SL UE1, SL UE2, SL UE3) to efficiently transmit the Sidelink synchronization signal of the unlicensed frequency band of each user equipment. Next, the apparatus and method according to the second embodiment of the present disclosure and an example signaling process will be further described in conjunction with the example scenario shown in FIG. 11.

FIG. 12 is a block diagram showing a configuration example of an electronic device on the base station side according to the second embodiment.

As shown in FIG. 12, the electronic device 1200 may include an access unit 1210, an allocation unit 1220, and an optional communication unit 1230. In addition, although not shown in the drawings, the electronic device 1200 may further include a storage unit.

Here, each unit of the electronic device 1200 may be included in a processing circuit. It should be noted that the electronic device 1200 may include one processing circuit or multiple processing circuits. Further, the processing circuit may include various discrete functional units to perform various different functions and/or operations. It should be noted that these functional units may be physical entities or logical entities, and units with different names may be implemented by the same physical entity.

Next, the example processing of the electronic device 1200 and its various units on the base station side will be further described in combination with the example scenario shown in FIG. 11, wherein the electronic device 1200 can, for example, be used for the base station gNB of FIG. 11.

### II.2.1 Example Processing of Each Unit of Electronic Device of Second Embodiment

The optional communication unit 1230 of the electronic device 1200 shown in FIG. 12 may be used to send information to a device other than the electronic device 1200 and/or receive information from a device other than the electronic device 1200. For example, when the electronic device 1200 is used for the base station gNB in FIG. 11, the communication unit 1230 can be used to communicate with user equipment SL UE1, SL UE2, SL UE3, etc. within the coverage area.

According to the second embodiment, the access unit 1210 of the electronic device 1200 can perform channel access processing on an unlicensed frequency band used to transmit a Sidelink synchronization signal S-SSB (an unlicensed frequency band used to transmit S-SSB) to obtain a channel occupancy time COT.

As an example, the access unit 1210 may, via Listen Before Talk (LBT), monitor potential transmission activities on an unlicensed frequency band used to transmit S-SSB and access the channel upon confirming that the unlicensed frequency band is available.

The access unit 1210 may use various LBT processes to perform channel access processing, including but not limited to LBT processes without/with the random backoff mechanism applied. As an example, the types of channel access processing performed by the access unit 1210 may include, but are not limited to, (a) an LBT process without applying random backoff (Type 2, Cat2), (b) an LBT process including random backoff but with a fixed contention window (CW) size (Type 3, Cat3), and (c) an LBT process including random backoff and with a variable contention window size (Type 4, Cat4). Different types of channel access processes may obtain COTs with different reliabilities (e.g., with different probabilities, different speeds). For example, the COT obtained by the more complex Cat4LBT process has a high reliability.

In this embodiment, optionally, a Cat4 (Type 4) LBT process including random backoff and a variable contention window size is adopted, and there may be different priorities to indicate the possibility and speed of successfully obtaining COT, etc. For example, a high priority LBT may indicate that the LBT obtains COT faster with a higher probability.

Preferably, the bandwidth (LBT bandwidth) on which the access unit 1210 of the electronic device 1200 performs channel access processing, for example via the LBT process, may include all unlicensed frequency bands that can be used by all user equipments within its coverage area to transmit S-SSB.

As an example, the access unit 1210 of the electronic device 1200 may be configured to perform the above-mentioned channel access processing in response to a request for resources for transmitting a Sidelink synchronization signal S-SSB from a user equipment within its coverage. For example, when the electronic device 1200 receives a request for resources for transmitting S-SSB from a user equipment within its coverage via the communication unit 1230, it can perform the above-mentioned channel access processing to obtain the COT when necessary (for example, when there is no COT that has been obtained, or when there are no resources in the unlicensed frequency band for transmitting S-SSB in the COT that have not yet been or can be allocated).

Preferably, at this time, when the unlicensed frequency bands that can be used for transmitting S-SSB by various user equipments within the coverage area of the electronic device 1200 are different from each other, the bandwidth of the channel access processing may include not only the unlicensed frequency band for transmitting S-SSB of the user equipment currently making the request, but also the unlicensed frequency bands that can be used for transmitting S-SSB by other user equipments. In this way, the electronic device 1200 can achieve centralized scheduling of resources in the unlicensed frequency band for transmitting S-SSB.

According to the second embodiment, the allocation unit 1220 of the electronic device 1200 can allocate the resources of the unlicensed frequency band in the COT for transmitting the Sidelink synchronization signal S-SSB (hereinafter which may also be referred to as the resources of the unlicensed frequency band in the COT for transmitting S-SSB, or further simplified as the resources of the unlicensed frequency band in the COT) obtained by the access unit 1210 of the electronic device 1200 to multiple user equipments for sending the Sidelink synchronization signal S-SSB.

For example, the electronic device 1200 can use the access unit 1210 to perform channel access processing and obtain COT for a user equipment within its coverage area that has a demand for transmitting a Sidelink synchronization signal S-SSB (for example, SL UE1 in FIG. 11, which sends a request for resources for transmitting S-SSB to the electronic device 1200); and when other user equipments (for example, SL UE2 and SL UE3 in FIG. 11) have similar requests and the resources in the unlicensed frequency band in the COT can also be used by other user equipments, the electronic device 1200 can use the allocation unit 1220 to allocate the above-mentioned resources in the COT to these user equipments (for example, SL UE1, SL UE2, and SL UE3 in FIG. 11) for common use. In this way, the efficiency of each user equipment in transmitting the Sidelink synchronization signal in the unlicensed frequency band can be improved.

The allocation of the unlicensed frequency band resources in the COT obtained by the access unit 1210 by the allocation unit 1220 includes but is not limited to the allocation of time domain resources, i.e., time periods, in the COT. In addition, the allocation of resources in the COT by the allocation unit 1220 may further include allocation of frequency domain resources in an unlicensed frequency band in the COT.

For example, the allocation unit 1220 may perform the above allocation based on the user equipment's request for resources for transmitting S-SSB, taking into account the resources of the unlicensed frequency band for transmitting S-SSB that the allocation unit 1220 can schedule. Note that the allocation unit 1220 can allocate all or part of the time period in the COT obtained by the access unit 1210, and all or part of the frequency domain resources of the unlicensed frequency band for transmitting S-SSB in the obtained COT to each user equipment. This can be appropriately handled by the allocation unit 1220 based on the unlicensed frequency band resources that it can schedule for transmitting S-SSB and the way it schedules these resources (for example, the allocation unit 1220 enables multiple user equipment to multiplex the unlicensed frequency band resources in the COT in a time division multiplexing (TDM) or frequency division multiplexing (FDM) manner).

Preferably, the allocation unit 1220 may be configured to generate downlink control information DCI for each user equipment among the multiple user equipments to indicate allocation of resources in the unlicensed frequency band in the COT to the user equipment. The downlink control information generated by the allocation unit 1220 for the user equipment may include at least information indicating allocation of time domain resources in the COT (and optionally frequency domain resources in the COT) for the user equipment. The electronic device 1200 can use the communication unit 1230 to send the downlink control information generated by the allocation unit 1220 to user equipment such as SL UE1, SL UE2, SL UE3, etc. in FIG. 11.

In an example, the downlink control information generated by the allocation unit 1220 for each user equipment may include COT indication information, which indicates the period of the COT allocated to the user equipment. The COT indication information may, for example, indicate the start and end time of the period of COT allocated to the user equipment. Note that the allocation unit 1220 can allocate all or part of the time period in the COT obtained by the access unit 1210 to each user equipment; accordingly, the COT indication information of the downlink control information can indicate all or part of the time period of the COT, which is not limited in this embodiment.

In addition, optionally, the downlink control information generated by the allocation unit 1220 for each user equipment may also include frequency domain resource indication information, which indicates the frequency domain resources of the unlicensed frequency band allocated to the user equipment for transmitting S-SSB. As an example, the frequency domain resource indication information may indicate a subchannel index of a subchannel in an unlicensed frequency band allocated to the user equipment for transmitting S-SSB (referred to as a subchannel for transmitting S-SSB). Note that the allocation unit 1220 can allocate all or part of the frequency domain resources of the unlicensed frequency band for transmitting S-SSB in the COT obtained by the access unit 1210 to each user equipment (for example, all or part of the subchannels for transmitting S-SSB in the obtained COT); accordingly, the frequency domain resource indication information of the downlink control information can indicate all or part of the frequency domain resources of the unlicensed frequency band for transmitting S-SSB in the obtained COT (for example, the subchannel index of all or part of the subchannels for transmitting S-SSB in the obtained COT), and this embodiment does not limit this.

As an example only, the downlink control information generated by the allocation unit 1220 for each user equipment can be in the form of the downlink control information DCI SL_U previously described in the first embodiment, in a partial format of the downlink control information DCI SL_U, or in a format similar thereto, which will not be repeated here.

Optionally, in addition to generating downlink control information for each of the multiple user equipments and instructing each user equipment to multiplex the resources of the unlicensed frequency band in the COT, the allocation unit 1220 may be further configured to: pre-configure frequency domain resources on the unlicensed frequency band for transmitting the Sidelink synchronization signal S-SSB for each of the multiple user equipments (hereinafter referred to as the unlicensed frequency band synchronization channel pre-configured by the user equipment, or further simplified as the unlicensed frequency band synchronization channel when appropriate). When the allocation unit 1220 of the electronic device 1200 pre-configures an unlicensed frequency band synchronization channel for each user equipment, the unlicensed frequency band (the bandwidth of the channel access processing) for which the access unit 1210 of the electronic device 1200 performs channel access processing may be a collection of the unlicensed frequency band synchronization channels of these user equipments; in other words, the access unit 1210 preferably performs channel access processing on the unlicensed frequency band synchronization channel of each user equipment to obtain the COT on the above-mentioned unlicensed frequency band synchronization channel.

The allocation unit 1220 pre-configuring the unlicensed synchronization channel for each of the plurality of user equipments can achieve multiple benefits. For example, on the one hand, the bandwidth of the channel access processing performed by the access unit 1210 of the electronic device 1200 can be reduced because the bandwidth is based on the unlicensed frequency band synchronization channel of each user equipment, rather than all unlicensed frequency bands that may be used for Sidelink communications (including Sidelink synchronization signals and Sidelink data signals). On the other hand, the energy consumption of each user equipment for detecting and receiving the Sidelink synchronization signal can also be reduced, because each user equipment only needs to perform the above detection and reception in the frequency band of its own unlicensed frequency band synchronization channel.

The allocation unit 1220 may implement the above configuration by, for example, generating unlicensed band synchronization channel configuration information and sending the configuration information to the user equipment using the communication unit 240.

In Sidelink communication, the user equipment may use a pre-configured resource pool (a collection of pre-configured time-frequency resources/time-frequency resource blocks) for communication. Therefore, optionally, the allocation unit 1220 may be further configured to configure a set of unlicensed resources (also referred to as an unlicensed resource pool) for the user equipment for direct link (Sidelink) communication. Here, the unlicensed resource set configured by the allocation unit 1220 for the user equipment includes at least a set of frequency domain resources on the unlicensed frequency band configured for each user equipment for transmitting the Sidelink synchronization signal S-SSB (unlicensed frequency band synchronization channel).

The allocation unit 1220 may implement the above configuration by, for example, generating unlicensed frequency band synchronization channel configuration information or even unlicensed resource pool configuration information and sending the configuration information to the user equipment using the communication unit 1230. Of course, the Sidelink communication configuration information that the allocation unit 1220 can generate for the user equipment is not limited to the unlicensed frequency band synchronization channel configuration information or even the unlicensed resource pool configuration information that this embodiment pays special attention to, but can include authorized resource pool configuration information generated in a manner similar to the existing method, which will not be repeated here.

As an example, the allocation unit 1220 may add a field as the unauthorized resource pool configuration information in the existing Sidelink communication configuration information for the user equipment. For example, the allocation unit 1220 may add the above field in the system information block SIB for Sidelink communication configuration. For example, the allocation unit 1220 may add specific content for configuring an unlicensed resource pool for the user equipment in the SIB 12 information element (IE) for NR Sidelink communication configuration, and may add an element in this part as configuration information for the user equipment's frequency domain resources on the unlicensed frequency band for transmitting the Sidelink synchronization signal S-SSB (unlicensed frequency band synchronization channel). The configuration information of the unlicensed band synchronization channel includes, for example but not limited to, the frequency domain position of the unlicensed band synchronization channel (e.g., a subchannel index, etc.).

Optionally, the electronic device 1200 may utilize the communication unit 1230 to send configuration information of the unlicensed synchronization channel generated for the user equipment by the allocation unit 1220 to the user equipment through the system information block SIB (e.g., SIB 12 message).

In one example, the frequency domain resources on the unlicensed band for transmitting S-SSB (unlicensed band synchronization channel) configured by the allocation unit 1220 for each user equipment may include a predetermined number N of consecutive resource blocks. Preferably, the predetermined number N may be an integer multiple of 11, and N may be, for example, 1, 2, 3, and so on.

The above configuration of the unlicensed frequency band synchronization channel by the allocation unit 1220 is conducive to the transmission of the Sidelink synchronization signal occupying 11 consecutive resource blocks and can be compatible with the format of the existing Sidelink synchronization signal. For example, an example structure of a Sidelink synchronization signal may include: Sidelink Primary Synchronization Signals (S-PSS); Sidelink Secondary Synchronization Signals (S-SSS); Physical Sidelink Broadcast Channel (PSBCH), which carries limited synchronization-related information. An existing format of the Sidelink synchronization signal including the above-mentioned S-PSS, S-SSS and PSBCH occupies 11 consecutive resource blocks in one time slot for transmission, for example.

Preferably, when the allocation unit 1220 configures an unlicensed resource pool for the user equipment, the unlicensed frequency band synchronization channel configured by the allocation unit 1220 for the user equipment may include a predetermined number N of continuous resource blocks around the center frequency point of the unlicensed resource pool (N may be an integer multiple of 11).

Optionally, in addition to the above-mentioned configuration information related to the unlicensed frequency band synchronization channel, the allocation unit 1220 can also be used to generate corresponding configuration information for RRC configuration or RRC reconfiguration (RRC Reconfiguration) between the electronic device 1200 and the user equipment. In the case where the electronic device 1200 schedules Sidelink communication for the user equipment, for example, after the electronic device 1200 sends the above-mentioned SIB 12 information element carrying the unauthorized resource pool configuration information to the user equipment via the communication unit 1230, RRC reconfiguration can be performed between the electronic device 1200 and the user equipment. For example, the user equipment can report the Sidelink capability to the electronic device 1200 (for example, but not limited to, the user equipment reports the unauthorized resource pool that it can currently use), and the allocation unit 1220 of the electronic device 1200 can further configure specific Sidelink resources for the user equipment based on the report, such as generating further configuration information, and can use the communication unit 1230 to send the configuration information to the user equipment.

### II.2.2 Example Way of Allocating Resources in COT

In a preferred embodiment, if the electronic device 1200 uses the allocation unit 1220 to pre-configure frequency domain resources on the unlicensed frequency band for transmitting S-SSB (unlicensed frequency band synchronization channel) for each user equipment, then after obtaining the COT using the access unit 1210, the electronic device 1200 can reuse the allocation unit 1220 to allocate the unlicensed frequency band resources in the COT in an appropriate manner taking into account the unlicensed frequency band synchronization channel pre-configured for each user equipment.

In other words, preferably, the allocation unit 1220 can allocate resources on the unlicensed frequency band for transmitting S-SSB by aspects (1) pre-configuring frequency domain resources on the unlicensed frequency band for transmitting S-SSB for the user equipment (for example, generating and sending configuration information of the synchronization channel) and (2) allocating resources (time-frequency resources or only time domain resources) on the unlicensed frequency band in the COT in real time after obtaining the COT (for example, generating and sending downlink control information to at least indicate the real-time allocation).

By the way, as an example, the allocation unit 1220 may only perform real-time allocation of time domain resources on the unlicensed frequency band in the COT in the above aspect (2) (i.e., the allocation of frequency domain resources fully complies with the pre-configuration in the above aspect (1) instead of being further refined in real time based on that pre-configuration). In this case, the downlink control information DCI generated by the allocation unit 1220 may only indicate the real-time allocation of the time domain resources, and may only include COT indication information, which will not be repeated here.

Next, an example in which the electronic device 1200 allocates resources of the unlicensed frequency band in the COT by using the allocation unit 1220 will be described with reference to a specific example.

### Example of TDM Allocation

In the first example, the electronic device 1200 can use the allocation unit 1220 to configure the same frequency domain resources on the unlicensed frequency band for transmitting the direct link (Sidelink) synchronization signal S-SSB (unlicensed frequency band synchronization channel) for each user equipment among multiple user equipment, and for example, after the access unit 1210 obtains the COT, different time periods in the COT can be allocated to these user equipment, that is, the allocation unit 1220 can be used to indicate the different time periods in the COT allocated to the corresponding user equipment in the multiple downlink control information DCIs generated respectively for these user equipment (TDM allocation).

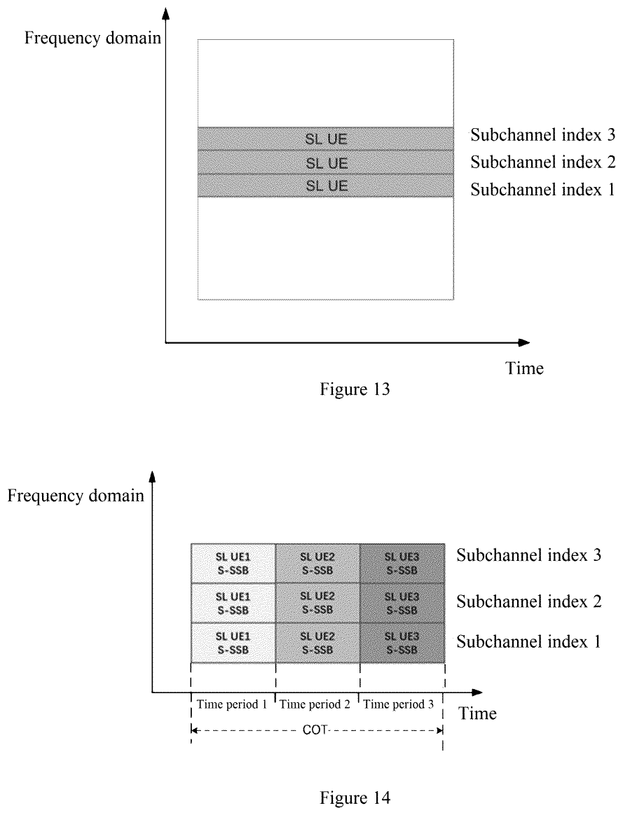

FIG. 13 is a schematic diagram for illustrating a first example of frequency domain resources for transmitting S-SSB (unlicensed frequency band synchronization channel) configured by the electronic device 1200 for the user equipment, which shows an example of a TDM allocation method. In that example, for example, in an unlicensed resource pool (shown as a light-colored rectangular box in the figure), the same unlicensed frequency band synchronization channel is pre-configured for each user equipment SL UE (which may be, for example, user equipment SL UE1, SL UE2, SL UE3 in FIG. 11), and the synchronization channel includes three subchannels indicated by subchannel indices 1 to 3 in the unlicensed resource pool. As an example, each subchannel may be suitable for transmitting a single Sidelink synchronization signal S-SSB. For example, each subchannel may include 11 consecutive resource blocks, so that an S-SSB occupying, for example, 11 consecutive resource blocks may be transmitted separately. Each user equipment SL UE can use three subchannels indicated by subchannel indices 1 to 3 in the unlicensed resource pool to transmit S-SSB.

FIG. 14 is a schematic diagram for illustrating a first example of resources in a COT allocated by an electronic device 1200 to multiple user equipments, which shows that in an example of a TDM allocation method, when allocating resources in a COT in real time, the electronic device 1200 can fully follow the unlicensed frequency band synchronization channel configuration of FIG. 13, and only allocate different time periods in the COT to each user equipment in real time, that is, allocating time period 1 to SL UE1, allocating time period 2 to SL UE2, and allocating time period 2 to SL UE2. As an example, each of the time periods 1 to 3 may be suitable for completely transmitting one Sidelink synchronization signal S-SSB. For example, each of the time periods 1 to 3 may include 1 time slot, so that a Sidelink synchronization signal S-SSB, for example, occupying a plurality of consecutive OFDM symbols in 1 time slot, may be completely transmitted. Note that although the example in FIG. 14 shows that time periods 1 to 3 allocated to each user equipment are continuous and jointly occupy the entire period of COT for the sake of simplicity of illustration, the present embodiment is not limited to this, and time periods 1 to 3 may be dispersed and/or jointly occupy part of the time period in the COT.

In the example shown in FIG. 14, each user equipment repeatedly transmits its Sidelink synchronization signal S-SSB on three subchannels indicated by subchannel indices 1 to 3 within a corresponding time period in the COT, thereby increasing the probability of successful transmission and decoding of the S-SSB, and further increasing the probability of successful synchronization.

### Example of FDM Allocation

In the second example, the electronic device 1200 can use the allocation unit 1220 to configure different frequency domain resources on the unlicensed frequency band for transmitting the direct link (Sidelink) synchronization signal S-SSB (unlicensed frequency band synchronization channels) for multiple user equipments, and for example, after the access unit 1210 obtains the COT, the same time period in the COT can be allocated to these user equipments, that is, the allocation unit 1220 can be used to indicate the same time period in the COT allocated to the corresponding user equipments in multiple downlink control information DCIs generated respectively for these user equipments (FDM allocation).

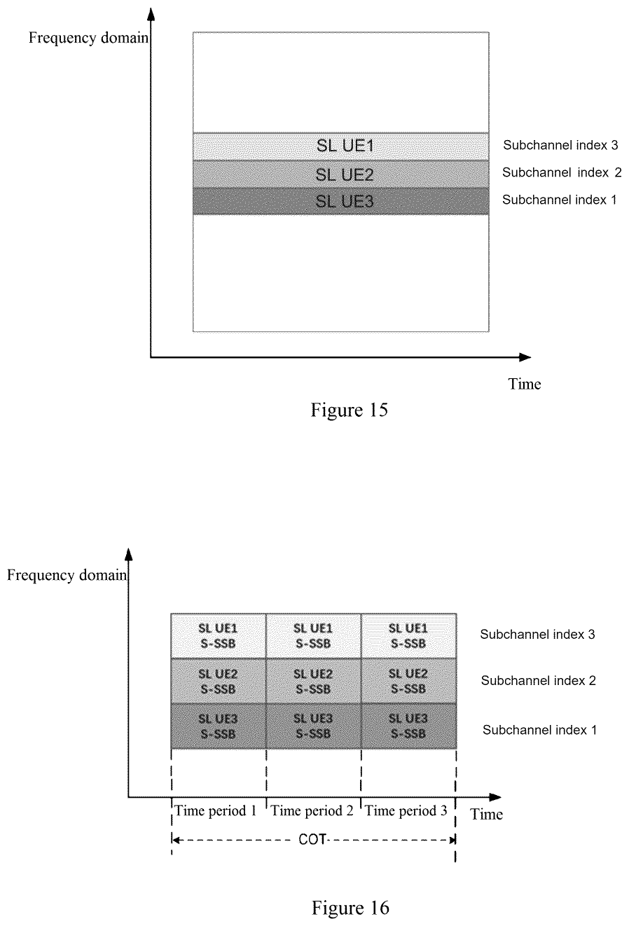

FIG. 15 is a schematic diagram for illustrating a second example of frequency domain resources for transmitting S-SSB (unlicensed frequency band synchronization channels) configured by the electronic device 1200 for the user equipment, which shows an example of the FDM allocation method. In that example, for example, in an unlicensed resource pool, different unlicensed frequency band synchronization channels are pre-configured for multiple user equipment SL UE1, SL UE2, and SL UE3, and each synchronization channel includes a subchannel indicated by the corresponding subchannel index 3, subchannel index 2, and subchannel index 1 in the unlicensed resource pool. Similar to the example of FIG. 13, each subchannel in FIG. 15 may be suitable for transmitting a single Sidelink synchronization signal S-SSB, and may include, for example, 11 consecutive resource blocks.

FIG. 16 is a schematic diagram for illustrating a second example of resources in the COT allocated by the electronic device 1200 to multiple user equipments, which shows that in an example of the FDM allocation method, when allocating resources in the COT in real time, the electronic device 1200 can fully follow the unlicensed frequency band synchronization channel configuration of FIG. 15, and only allocate the same time period in the COT to each user equipment in real time, that is, allocate time periods 1 to 3 to SL UE1, SL UE2, and SL UE3 respectively. Similar to the example of FIG. 16, each of time periods 1 to 3 can completely transmit a Sidelink synchronization signal and can, for example, include 1 time slot; in addition, although time periods 1 to 3 are shown to be continuous and jointly occupy the entire COT time period for the sake of simplicity of illustration, they can be dispersed and/or jointly occupy part of the time period in the COT.

In the example shown in FIG. 16, each user equipment repeatedly transmits its Sidelink synchronization signal S-SSB on the subchannel indicated by the corresponding subchannel index within three time periods in the COT, thereby increasing the probability of successful transmission and decoding of the S-SSB, and further increasing the probability of successful synchronization.

The above describes the electronic device 1200 on the base station side according to the second embodiment, which can obtain the COT more easily/faster than the UE serving a single user and allocate resources in the COT to the UE for transmitting the Sidelink synchronization signal of the unlicensed frequency band, and allow multiple transmitting user equipments to reuse the resources of the unlicensed frequency band within the COT for transmitting S-SSB to transmit the S-SSB of the unlicensed frequency band of each user equipment, thereby improving the transmission efficiency of the S-SSB of the unlicensed frequency band of each user equipment, which is beneficial to improving the efficiency of the Sidelink communication in the unlicensed frequency band.

### I1.3. Example Signaling Flow of Second Embodiment

Next, the example signaling interaction in which the base station side device obtains the COT and allocates resources in the COT to multiple user equipments according to the second embodiment of the present disclosure will be described with reference to specific examples. For example, it can be implemented by utilizing the interaction between the electronic device 1200 on the base station side of the above-mentioned second embodiment and the user equipment within its coverage area.

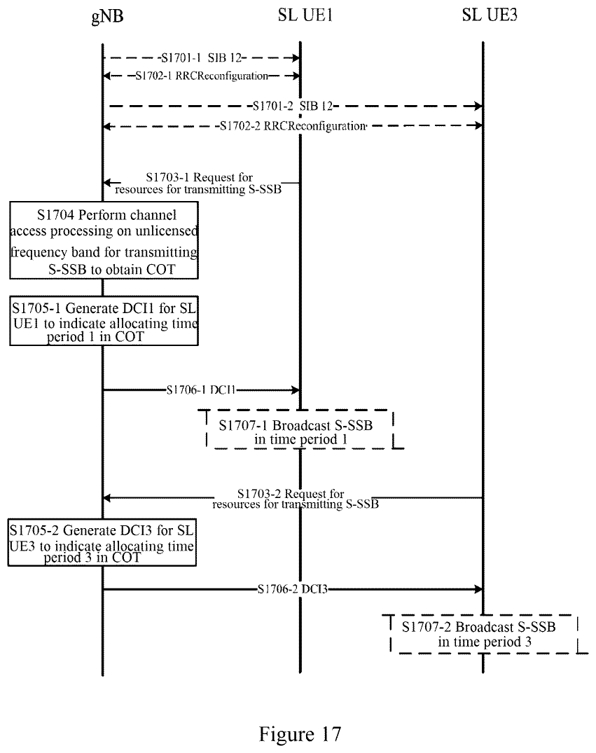

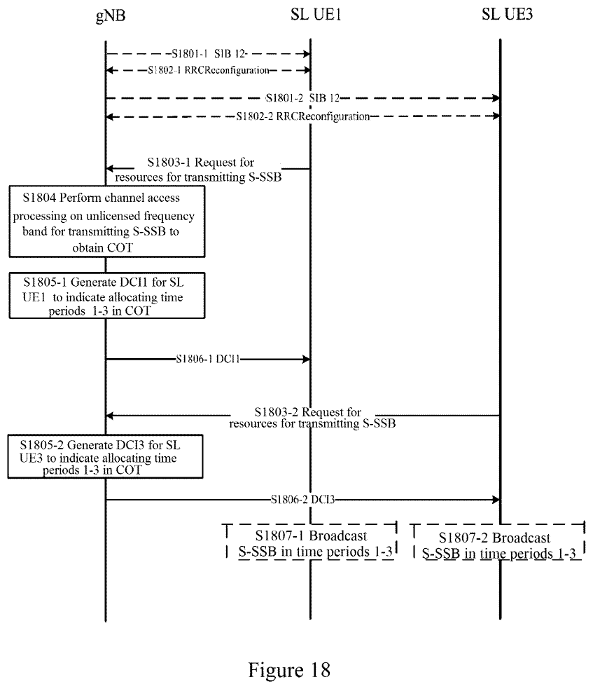

FIGS. 17 and 18 are flowcharts of first and second example signaling interactions for illustrating, respectively, a base station side device obtaining a COT and allocating resources in the COT to a user equipment according to the second embodiment. In the examples of FIGS. 17 and 18, the electronic device 1200 on the base station side is used, for example, for the base station gNB in the example of FIG. 12, and interacts with, for example, user equipment SL UE1, SL UE3 in the example of FIG. 12. Note that for the sake of simplicity, FIGS. 17 and 18 only show the interaction between the base station gNB and two user equipments SL UE1 and SL UE3, but a similar process can be extended to more user equipments and will not be repeated here.

In addition, since this embodiment focuses on the device on the base station side allocating resources within the COT to the user equipment on the transmitting end of the Sidelink communication, in order to avoid blurring the focus, the user equipment on the receiving end, such as SL UE4, is omitted in the examples of FIGS. 17 and 18. SL UE1 or SL UE3 may each perform various necessary signaling interactions with SL UE4 for Sidelink communication therebetween. As an example, after receiving the SIB 12 message from the gNB, SL UE1 can determine the resource pool that can be used for Sidelink communication with SL UE2 through interaction with SL UE4 (and can report the resource pool during the RRC reconfiguration phase with the gNB), which will not be repeated here. Note that only when SL UE1 and SL UE4 can use the same resource pool can SL UE1 use the resource pool for Sidelink communication with SL UE4; therefore, there is a possibility that SL UE1 can only perform Sidelink communication with SL UE4 (including transmission of Sidelink synchronization signal S-SSB) via an unauthorized resource pool.

### II.3.1 Example Signaling Flow for TDM Allocation

In the example signaling interaction of TDM allocation in FIG. 17, optionally, first, in step S1701-i for each user equipment SL UEi, the base station gNB sends a system message SIB 12 to the user equipment SL UEi. The SIB 12 message may, for example, include Sidelink communication configuration information generated by the gNB for SL UEi, which optionally includes unlicensed resource pool configuration information and optionally includes unlicensed synchronization channel configuration information for transmitting S-SSB (i=1,3). In this example, the gNB configures multiple unlicensed resource pools for each user equipment SL UE1, SL UE3, and configures the same unlicensed frequency band synchronization channel for each user equipment in each unlicensed resource pool, which is, for example, the frequency domain resources indicated by subchannel indices 1 to 3 as shown in FIG. 13.

Then, in step S1702-i, RRC reconfiguration is performed between the base station gNB and the user equipment SL UEi, which may include, for example, the user equipment reporting Sidelink capabilities to the gNB (for example, but not limited to, the user equipment reporting the unauthorized resource pool that it can currently use) and the gNB further configuring specific Sidelink resources for the user equipment based on the report. In this example, for example, each user equipment SL UE1 and SL UE3 reports to the gNB the same unlicensed resource pool that can be currently used.

Thereafter, for example, as shown in the figure, when the user equipment SL UE1 has a need to send or broadcast the Sidelink synchronization signal S-SSB, in step S1703-1, the user equipment SL UE1 sends a request for resources for transmitting the S-SSB to the base station gNB.

In response to the request of the user equipment SL UE1 for resources for transmitting S-SSB in step S1703-1, the base station gNB performs channel access processing on the unlicensed frequency band used for transmitting S-SSB (i.e., the unlicensed frequency band synchronization channel in the unlicensed resource pool currently available to the user equipment SL UE1) to obtain COT in step S1704, and generates downlink control information DCI1 for SL UE1 in step S1705-1 to indicate that resources on the unlicensed frequency band in the COT for transmitting S-SSB are allocated to SL UE1. In this example, it specifically indicates that time period 1 in the COT (for example, time period 1 in the COT as shown in FIG. 14) is allocated to SL UE1. The base station gNB can send downlink control information DCI1 to SL UE1 in step S1706-1. The SL UE1 that has received the DCI1 may broadcast the synchronization signal S-SSB (on the subchannels indicated by the subchannel indices 1 to 3) in a time period 1 in the COT in step S1707-1 according to the indication by the DCI1.

In addition, when the user equipment SL UE3 has a need to send or broadcast the Sidelink synchronization signal S-SSB, in step S1703-2, the user equipment SL UE3 sends a request for resources for transmitting the S-SSB to the base station gNB. At this time, there are still unallocated and allocatable resources on the unlicensed frequency band for transmitting S-SSB in the COT obtained by the base station gNB in step S1704, for example, the resources of the subchannels indicated by subchannel indices 1 to 3 in time period 3 after time period 1 in the COT. Therefore, the base station gNB can generate downlink control information DCI3 for SL UE3 in step S1705-2 to indicate that time period 3 in the COT is allocated to SL UE3. The base station gNB can send downlink control information DCI3 to SL UE3 in step S1706-2. The SL UE3 that has received the DCI3 may broadcast the synchronization signal S-SSB (on the subchannels indicated by the subchannel indices 1 to 3) in the time period 3 in the COT in step S1707-2 according to the indication by the DCI3.

Note that although for the sake of simplicity of illustration, the example of FIG. 17 shows that step S1703-2 in which the user equipment SL UE3 sends a request for resources for transmitting S-SSB to the base station gNB and subsequent steps S1705-2, S1706-2, etc. are performed after step S1701-1 in which the user equipment SL UE1 broadcasts the synchronization signal S-SSB, the timing of this example is not limited to this. For example, alternatively, the resource request step S1703-2 of SL UE3 may be performed immediately after the resource request step S1703-1 of SL UE1, or may be performed immediately after step S1704, immediately after step S1705-1, or immediately after step S1706-1. Similarly, there is no particular limitation on the timing of steps S1705-2 and S1706-2, as long as they are performed after the resource request step S1703-2 of SL UE 3.

### II.3.2 Example Signaling Flow for FDM Allocation

In the example signaling interaction of FDM allocation in FIG. 18, optionally, first, in step S1801-i for each user equipment SL UEi, the base station gNB sends a system message SIB 12 to the user equipment SL UEi. The SIB 12 message may, for example, include Sidelink communication configuration information generated by the gNB for SL UEi, which optionally includes unlicensed resource pool configuration information and optionally includes unlicensed synchronization channel configuration information for transmitting S-SSB (i=1,3). In this example, the gNB configures multiple unlicensed resource pools for each user equipment SL UE1, SL UE3, and configures different unlicensed frequency band synchronization channels for the user equipment SL UE1, SL UE3 in each unlicensed resource pool, such as the frequency domain resources indicated by the subchannel index 3 and the frequency domain resources indicated by the subchannel index 1 shown in FIG. 15, respectively.

Then, in step S1802-i, RRC reconfiguration is performed between the base station gNB and the user equipment SL UEi, which may include, for example, the user equipment reporting Sidelink capabilities to the gNB (for example, but not limited to, the user equipment reporting the unauthorized resource pool that it can currently use) and the gNB further configuring specific Sidelink resources for the user equipment based on the report. In this example, for example, each user equipment SL UE1 or SL UE3 reports to the gNB the same unlicensed resource pool that can be currently used.

Thereafter, for example, as shown in the figure, when the user equipment SL UE1 has a need to send or broadcast the Sidelink synchronization signal S-SSB, in step S1803-1, the user equipment SL UE1 sends a request for resources for transmitting the S-SSB to the base station gNB.

In response to the request for resources for transmitting S-SSB of the user equipment SL UE1 in step S1803-1, the base station gNB performs channel access processing on the unlicensed frequency band used for transmitting S-SSB (i.e., the unlicensed frequency band synchronization channel (for each user equipment) in the unlicensed resource pool currently available to the user equipment SL UE1, such as the frequency domain resources indicated by subchannel indices 1 to 3 shown in FIG. 15) in step S1804 to obtain COT, and generates downlink control information DCI1 for SL UE1 in step S1805-1 to indicate the allocation of resources on the unlicensed frequency band for transmitting S-SSB in the COT to SL UE1. In this example, it specifically indicates the allocation of time periods 1 to 3 in the COT to SL UE1 (for example, time periods 1 to 3 in the COT shown in FIG. 16). The base station gNB can send downlink control information DCI1 to SL UE1 in step S1806-1. The SL UE1 that has received the DCI1 may, according to the indication by the DCI1, broadcast the synchronization signal S-SSB in time periods 1 to 3 of the COT (on the subchannel indicated by the subchannel index 3) in step S1807-1.

In addition, when the user equipment SL UE3 has a need to send or broadcast the Sidelink synchronization signal S-SSB, in step S1803-2, the user equipment SL UE3 sends a request for resources for transmitting the S-SSB to the base station gNB. At this time, there are still unallocated and allocatable resources on the unlicensed frequency band for transmitting S-SSB in the COT obtained by the base station gNB in step S1804, such as the resources of the subchannel indicated by subchannel index 1 in the entire time period of the COT. Therefore, the base station gNB can generate downlink control information DCI3 for SL UE3 in step S1805-2 to indicate that time periods 1 to 3 in the COT are allocated to SL UE3. The base station gNB can send downlink control information DCI3 to SL UE3 in step S1806-2. The SL UE3 that receives DCI3 may, according to the indication by DCI3, broadcast the synchronization signal S-SSB in time periods 1 to 3 in the COT (on the subchannel indicated by the subchannel index 1) in step S1807-2, which is performed simultaneously with step S1807-1.

Note that although for the sake of simplicity of illustration, the example of FIG. 18 shows that step S1803-2 in which the user equipment SL UE3 sends a request for resources for transmitting S-SSB to the base station gNB and subsequent steps S1805-2, S1806-2, etc. are all performed after step S1806-1 in which the base station gNB sends downlink control information DCI1 to SL UE1, the timing of this example is not limited to this. For example, alternatively, the resource request step S1803-2 of SL UE3 may be performed immediately after the resource request step S1803-1 of SL UE1, or may be performed immediately after step S1804 or immediately after step S1805-1. Similarly, there is no particular limitation on the timing of steps S1805-2 and S1806-2, as long as they are performed after the resource request step S1803-2 of SL UE 3.

### I1.4. Method Embodiment of Second Embodiment

Corresponding to the device embodiment of the second embodiment described above, the present disclosure provides the following method embodiments.

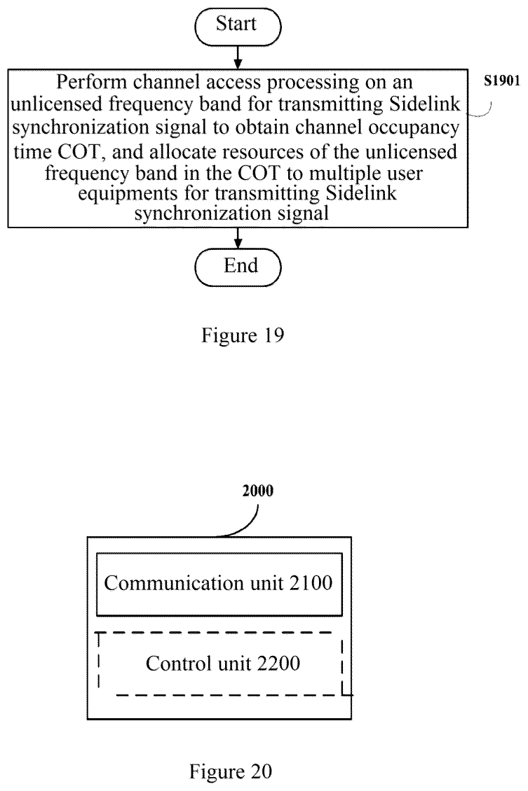

FIG. 19 is a flowchart showing a procedure example of a method for wireless communication on the base station side according to the second embodiment.

As shown in FIG. 19, in step S1901, channel access processing is performed on an unlicensed frequency band used to transmit a direct link (Sidelink) synchronization signal to obtain a channel occupancy time COT, and resources of the unlicensed frequency band in the COT are allocated to multiple user equipments for sending a direct link (Sidelink) synchronization signal.

For example, the channel access processing in step S1901 may be performed at the base station side in response to a request from the user equipment for resources for transmitting a direct link (Sidelink) synchronization signal.

In an example, the process of allocating the resources of the unlicensed frequency band in the COT to multiple user equipments in step S1901 may include: generating downlink control information for each user equipment among the multiple user equipments to indicate allocation of the resources to the user equipment.

In a further example, in step S1901, the processing of allocating resources of the unlicensed frequency band in the COT to multiple user equipments may also include: for example, before performing the channel access processing to obtain the COT, pre-configuring frequency domain resources on the unlicensed frequency band for transmitting a direct link (Sidelink) synchronization signal for each of the multiple user equipments. Optionally, the configured frequency domain resources may include a predetermined number of consecutive resource blocks, and the predetermined number may be an integer multiple of 11, and the integer may be 1, 2, 3, and so on.

For example, optionally, the same frequency domain resources may be pre-configured for the multiple user equipments. In addition, after the COT is obtained, different time periods in the COT allocated to corresponding user equipments may be indicated in the multiple downlink control information respectively generated for the multiple user equipments.

For another example, optionally, different frequency domain resources may be pre-configured for the multiple user equipments. In addition, after the COT is obtained, the same time period in the COT allocated to the corresponding user equipment is indicated in the multiple downlink control information respectively generated for the multiple user equipments.

According to an embodiment of the present disclosure, the subject executing the above method may be an electronic device on the base station side according to the second embodiment of the present disclosure, and therefore all the embodiments of the electronic device on the base station side of the second embodiment in the foregoing text are applicable here and will not be repeated here.

### I1.5. Configuration Example of Electronic Device of Third Embodiment

In a third embodiment of the present disclosure, a single user equipment transmits a Sidelink synchronization signal in an unlicensed frequency band in a manner that the Sidelink synchronization signal and the Sidelink data signal in the unlicensed frequency band share the time-frequency resources.

According to the third embodiment, a device (e.g., user equipment) and method for a Sidelink communication transmitting end, and a device (e.g., user equipment) and method for a Sidelink communication receiving end are provided, which can jointly transmit a Sidelink synchronization signal and a Sidelink data signal on an unlicensed frequency band in a predefined time-frequency resource format, thereby improving the transmission efficiency of the Sidelink synchronization signal.

FIG. 20 is a block diagram showing a configuration example of an electronic device according to the third embodiment, which can be applied to the transmission side/transmitting end of Sidelink communication and can also be applied to the reception side/receiving end of Sidelink communication.

As shown in FIG. 20, the electronic device 2000 may include a communication unit 2100 and an optional control unit 2200. The communication unit 2100 sends information to and/or receives information from devices other than the electronic device 2000 (e.g., under the control of the optional control unit 2200). In addition, although not shown in the drawings, the electronic device 2000 may further include a storage unit.

Here, each unit of the electronic device 2000 may be included in a processing circuit. It should be noted that the electronic device 2000 may include one processing circuit or multiple processing circuits. Further, the processing circuit may include various discrete functional units to perform various different functions and/or operations. It should be noted that these functional units may be physical entities or logical entities, and units with different names may be implemented by the same physical entity.

According to the third embodiment, the communication unit 2100 of the electronic device 2000 on an transmitting end for Sidelink communication (or simply referred to as the transmitting end UE) can (for example, under the control of an optional control unit 2200) jointly send a synchronization signal and a data signal of a direct link (Sidelink) on an unlicensed frequency band in a predefined time-frequency resource format, wherein the time-frequency resource format may include multiple sub-channels on a time slot.

Accordingly, the communication unit 2100 of the electronic device 2000 on a receiving end for Sidelink communication (or simply referred to as the receiving end UE) can (for example, under the control of the optional control unit 2200) receive the synchronization signal and data signal of the direct link (Sidelink) on the unlicensed frequency band jointly sent in a predefined time-frequency resource format, wherein the time-frequency resource format may include multiple sub-channels on a time slot.

As an example, the Sidelink synchronization signal may include a Sidelink primary synchronization signal S-PSS, a Sidelink secondary synchronization signal S-SSS, and a physical Sidelink broadcast channel PSBCH. In addition, the Sidelink data signal may include a physical Sidelink shared channel (PSSCH) as an example of control information and a physical Sidelink shared channel (PSSCH) as an example of data information, wherein the PSSCH as an example of control information may include, for example, Sidelink control information (SCI), which may include, for example, information required by the receiving end to correctly demodulate or detect the PSSCH as an example of data information.

Preferably, in order to facilitate the receiving end to obtain the Sidelink synchronization signal and establish synchronization as early as possible, in the predefined time-frequency resource format, the Sidelink synchronization signal may use, for example, a symbol as early as possible in a time slot. In addition, the Sidelink synchronization signal may preferentially use a subchannel with a relatively low (or small) subchannel index among the multiple subchannels.

In addition, in order for the receiving end to obtain the control information in the Sidelink data signal as early as possible and obtain the data information in the Sidelink data signal according to the control information, preferably, the control information in the Sidelink data signal can use, for example, a symbol as early as possible in a time slot. In addition, the control information may preferentially use a subchannel having a relatively low subchannel index among the multiple subchannels.

The transmitting UE and the receiving UE may obtain the above-mentioned predefined time-frequency resource format in various appropriate ways (for example, using a control unit). For example, the predefined time-frequency resource format may be acquired by the control unit by being written into a storage unit (not shown) of the UE at the factory, being hardwired to the UE, or being pre-stored in a storage unit (not shown) of the UE in other ways. Alternatively, the predefined time-frequency resource format may be received by the communication unit from a base station side device capable of serving the UE, and thus acquired by the control unit.

The transmitting (side) electronic device 2000 (transmitting UE), for example, can use the communication unit 2100 under the control of the control unit 2200 to send Sidelink synchronization signals and Sidelink data signals on the unlicensed frequency band at the corresponding time-frequency positions according to the predefined time-frequency resource format. As an example, the transmitting UE may use a scrambling sequence including the identifier ID of the transmitting UE to scramble the Sidelink synchronization signal it transmits.

Accordingly, the receiving (side) electronic device 2000 (receiving UE), for example, can utilize the communication unit 2100 under the control of the control unit 2200 to receive the Sidelink synchronization signal and Sidelink data signal on the unlicensed frequency band at the corresponding time-frequency positions according to the predefined time-frequency resource format. Optionally, the receiving UE may cache the jointly transmitted Sidelink synchronization signal and Sidelink data signal, for example, by using a storage unit not shown, and process the Sidelink data signal only after successful synchronization, for example.

For example, the receiving UE can achieve synchronization with the transmitting UE by receiving a Sidelink synchronization signal on an unlicensed frequency band at a corresponding time-frequency position, decoding the synchronization signal, and performing a synchronization process based on the decoded synchronization signal. The specific synchronization process after obtaining the Sidelink synchronization signal may adopt any appropriate method (such as various existing synchronization methods), which will not be described in detail here.

Here, the receiving UE may, for example, utilize the communication unit controlled by the control unit to obtain the ID of the transmitting UE according to the scrambling sequence of the received Sidelink synchronization signal. If the receiving UE, for example, uses the control unit to determine that it is the first time to conduct Sidelink communication with the sending UE (or has not yet established synchronization with the sending UE) based on the ID of the sending UE, the receiving UE can, for example, continue to use a storage unit not shown to cache or buffer the Sidelink data signal sent in conjunction with the Sidelink synchronization signal, and then perform subsequent processing (such as decoding processing, etc.) on the Sidelink data signal after waiting for synchronization to be established.

In addition, once the receiving UE determines based on the scrambling sequence of the received Sidelink synchronization signal that it is not the first time but that it is continuously communicating with the transmitting UE (or synchronization has been established with the transmitting UE), the receiving UE does not need to continue decoding the information of the Sidelink synchronization signal or re-synchronize, but can only process the Sidelink data signal (e.g., decoding processing, etc.), which helps to simplify processing and reduce processing load.

Note that the specific time-frequency positions of the Sidelink synchronization signal and the Sidelink data signal transmitted on the above-mentioned unlicensed frequency band can be based on a predefined time-frequency resource format, optionally combined with scheduling from the base station side (when the transmitting UE operates in Sidelink resource allocation mode 1 (mode 1)) or according to the results of resource perception and resource selection (when the transmitting UE operates in Sidelink resource allocation mode 2 (mode 2)), and appropriately determined among the time-frequency resources that can be used for Sidelink transmission between the transmitting UE and the receiving UE. This embodiment does not limit the Sidelink resource allocation mode of the transmitting UE, and in order to avoid blurring the focus of the present disclosure, the details of the specific resource allocation mode and the related signaling interaction between the transmitting UE and the receiving UE are omitted in the above description.

Using the above configuration, the electronic device of this embodiment can transmit the Sidelink synchronization signal in the unlicensed frequency band in a manner of multiplexing or sharing the time-frequency resources of the Sidelink synchronization signal and the Sidelink data signal in the unlicensed frequency band in accordance with the predefined time-frequency resource format, thereby improving the transmission efficiency of the Sidelink synchronization signal. In unlicensed frequency bands, the Sidelink synchronization signal cannot be sent periodically as in licensed frequency bands, which means that the probability of establishing synchronization becomes lower and the delay becomes longer. In this embodiment, the Sidelink synchronization signal and the data signal are jointly transmitted using the above-mentioned predefined time-frequency resource format, and no special requirements are made on the frequency band for transmitting the Sidelink synchronization signal. For example, the Sidelink synchronization signal can also be transmitted on the frequency band that can transmit the Sidelink data signal, thereby increasing the probability and/or frequency of transmitting the Sidelink synchronization channel, thereby increasing the probability of establishing synchronization between the transmitting end and the receiving end and reducing the delay in establishing synchronization.

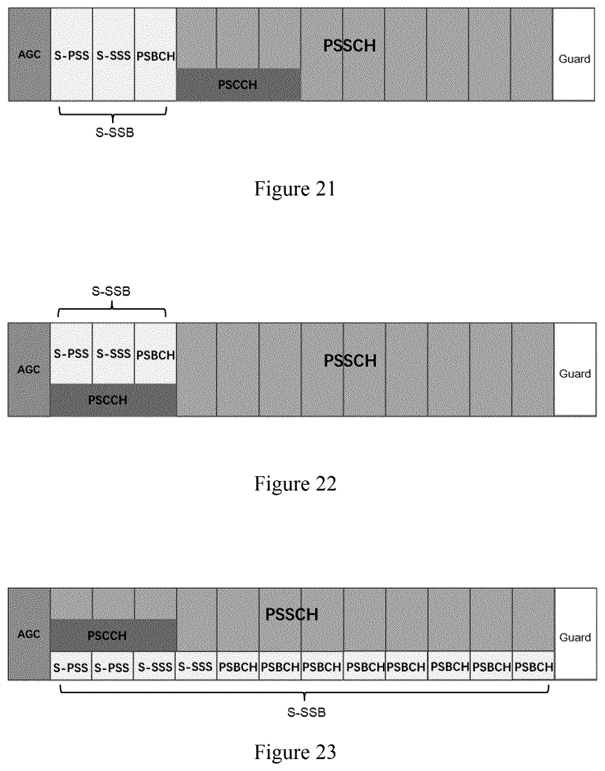

Next, examples of predefined time-frequency resource formats for jointly transmitting a Sidelink synchronization signal and a Sidelink data signal will be described in conjunction with FIGS. 21 to 23. FIGS. 21 to 23 are schematic diagrams for illustrating first to third examples of predefined time-frequency resource formats that can be used for the third embodiment, wherein the predefined time-frequency resource formats of a Sidelink synchronization signal S-SSB including S-PSS, S-SSS and PSBCH and a Sidelink data signal including PSSCH of control information and PSSCH of data information are shown as examples.

In the examples of the time-frequency resource formats of FIGS. 21 to 23, the horizontal direction represents the time domain direction (the direction from left to right represents the time sequence in the time domain) and the vertical direction represents the frequency domain direction (the direction from bottom to top represents the order of the subchannel indexes in the frequency domain from low to high), and each figure shows the resources of multiple subchannels on a time slot (14 OFDM symbols). In FIG. 21 to FIG. 23, the automatic gain control AGC occupies the resources of the first symbol in a time slot, the optional guard symbol GUARD occupies the resources of the fourteenth symbol, and the Sidelink synchronization signal S-SSB and the Sidelink data signal share the resources on the remaining symbols.

FIG. 21 shows a first example of a predefined time-frequency resource format, wherein a time domain resource of a time slot can be shared by a synchronization signal S-SSB, for example including S-PSS, S-SSS and PSBCH, and a data signal, for example including control information PSSCH and data signal PSSCH. Optionally, among multiple symbols in a time slot, the symbol occupied by the synchronization signal S-SSB may be located before the symbol occupied by the data signal. Such an example format is, for example, beneficial for the receiving end to quickly obtain a synchronization signal and perform synchronization processing in advance.

More specifically, as shown in FIG. 21, the synchronization signal S-SSB may occupy the first three (3) consecutive symbols (e.g., after the automatic gain control AGC), and these three (3) symbols may be occupied by S-PSS, S-SSS and PSBCH in sequence, for example. The data signal may occupy, for example, the following 9 consecutive symbols. In the first 3 symbols of these 9 symbols, the control information PSSCH and the data information PSSCH share the frequency domain resources of multiple subchannels, and the control information PSSCH can occupy the subchannel with the lowest index among the multiple subchannels; in the last 6 symbols of these 9 symbols, the data information PSSCH can occupy all subchannels among the multiple subchannels.

FIGS. 22 and 23 respectively show the second and third examples of the predefined time-frequency resource format, wherein, for example, frequency domain resources of multiple sub-channels can be shared or used in a multiplexing manner by a synchronization signal S-SSB including S-PSS, S-SSS and PSBCH and a data signal including control information PSSCH and data information PSSCH.

Further, in the second example shown in FIG. 22, for example, in the first few symbols in one time slot, the synchronization signal S-SSB can share the frequency domain resources of multiple subchannels with the control information PSSCH in the data signal, and the control information PSSCH can occupy the subchannel with the lowest index among the multiple subchannels. Such an example format is, for example, beneficial for the receiving end to quickly obtain the synchronization signal and perform synchronization processing in advance, as well as to quickly obtain the control information in the data signal and process the data signal early.

More specifically, as shown in FIG. 22, in the first three consecutive symbols (for example, the three consecutive symbols after the automatic gain control AGC), the synchronization signal S-SSB can share the frequency domain resources of multiple subchannels together with the control information PSSCH, and the control information PSSCH can occupy the subchannel with the lowest index, and the above three symbols on the remaining subchannels (subchannels with the second lowest index and higher index among multiple subchannels) can be occupied by S-PSS, S-SSS and PSBCH in turn, for example. The data information PSSCH may occupy all time-frequency resources of the following 9 consecutive symbols, for example.

In addition, in the third example shown in FIG. 23, the synchronization signal S-SSB can share the frequency domain resources of multiple subchannels together with the control information PSSCH and the data information PSBCH in the data signal, and the synchronization signal S-SSB can occupy the subchannel with the lowest index among the multiple subchannels. In this example, the synchronization signal S-SSB preferably occupies a predetermined number N of consecutive resource blocks in the subchannel with the lowest index, and the predetermined number N may be an integer multiple of 11, and for example the integer being 1, 2, 3, and so on. Such an example format is, for example, convenient for transmitting a Sidelink synchronization signal occupying 11 consecutive resource blocks and convenient for being compatible with the existing format of the Sidelink synchronization signal.

More specifically, as shown in FIG. 23, in all symbols except symbols that cannot be used by synchronization signals and data signals (for example, multiple consecutive symbols between automatic gain control AGC and protection symbols), the synchronization signal S-SSB can share the frequency domain resources of multiple subchannels with the data signal, and the synchronization signal S-SSB can occupy the subchannel with the lowest index, and for example can include 2 symbols of S-PSS, 2 symbols of S-SSS, and 8 symbols of PSBCH in sequence.

For subchannels other than the subchannel with the lowest index among multiple subchannels (subchannels with the second lowest index and higher index among multiple subchannels), in the first three consecutive symbols (for example, the three consecutive symbols after the automatic gain control AGC), the control information PSSCH and the data information PSBCH can share the frequency domain resources of these subchannels and the control information PSSCH can occupy the subchannel with the lowest index among these subchannels (that is, occupy the subchannel with the second lowest index among all multiple subchannels); in the next nine symbols, the data information PSBCH can use all frequency domain resources in these subchannels (that is, occupy the subchannel with the second lowest index and higher index among all multiple subchannels).

Note that although FIGS. 21 to 23 show as examples the specific usage of resources in the predefined time-frequency resource format by the various parts of the synchronization signal S-PSS, S-SSS and PSBCH and the various parts of the data signal PSSCH and PSSCH, these specific usage methods are only examples and do not constitute a limitation to the present embodiment; the present embodiment may adopt other usage methods of resources by the various parts of the synchronization signal and the various parts of the data signal, which will not be repeated here.

In addition, although an optional guard symbol GUARD is shown in the examples of the predefined time-frequency resource format of FIGS. 21 to 23, alternatively, the guard symbol GUARD may be omitted and the resources of the 14th symbol may be occupied, for example, by data information PSSCH (in a variation of the examples of FIGS. 21 and 22) or by data information PSSCH and a synchronization signal S-SSB (such as the PDBCH therein) in a frequency division multiplexing manner (in a variation of the examples of FIGS. 21 and 22).

### I1.6. Method Embodiment of Third Embodiment

Corresponding to the apparatus embodiment of the third embodiment described above, the present disclosure provides the following method embodiments.

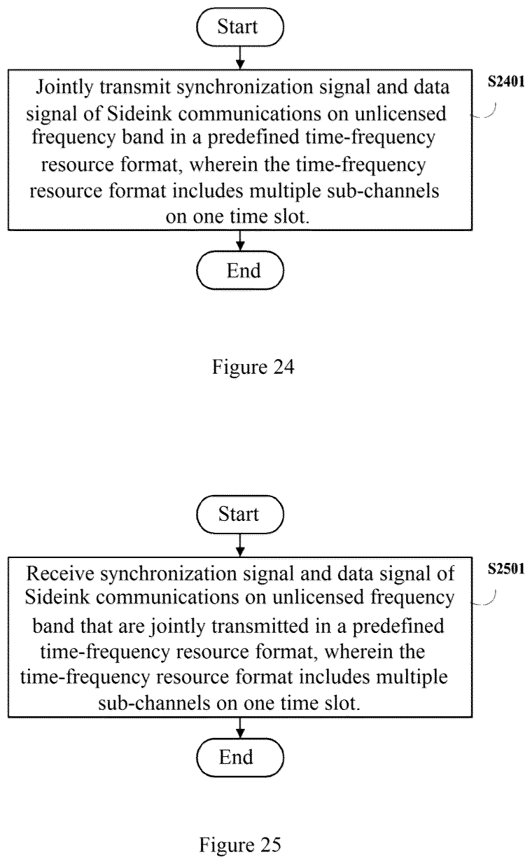

FIGS. 24 and 25 are flowcharts showing process examples of methods for wireless communication at a transmitting end and a receiving end according to the third embodiment, respectively.

As shown in FIG. 24, in the process example of the transmitting end, in step S2401, the synchronization signal and data signal of the direct link on the unlicensed frequency band are jointly sent in a predefined time-frequency resource format, wherein the time-frequency resource format includes multiple sub-channels on a time slot.

Accordingly, as shown in FIG. 25, in the process example at the receiving end, in step S2501, a synchronization signal and a data signal of a direct link (Sidelink) communication on an unlicensed frequency band that are jointly sent in a predefined time-frequency resource format are received, wherein the time-frequency resource format includes multiple subchannels on a time slot.

In the examples of FIG. 24 and FIG. 25, in the first example of the time-frequency resource format, the synchronization signal can share the time domain resources of one time slot with the data signal (in a multiplexing manner). Preferably, among multiple symbols in a time slot, the symbol occupied by the synchronization signal may be located before the symbol occupied by the data signal.

In addition, in the second and third examples of the time-frequency resource format, the synchronization signal can share frequency domain resources of multiple sub-channels with the data signal (in a multiplexing manner).

More specifically, in the second example of the time-frequency resource format, the synchronization signal can share the frequency domain resources of multiple subchannels with the control information and data information in the data signal, and the synchronization signal can occupy the subchannel with the lowest index among the multiple subchannels. At this time, preferably, the synchronization signal may occupy a predetermined number of consecutive resource blocks in the subchannel with the lowest index, and the predetermined number may be an integer multiple of 11.

In the third example of the time-frequency resource format, the synchronization signal may share the frequency domain resources of multiple sub-channels with the control information in the data signal, and the control information may occupy the sub-channel with the lowest index.

According to an embodiment of the present disclosure, the subjects executing the example method of FIG. 24 and the example method of FIG. 25 may be respectively the electronic device at the transmitting end and the electronic device at the receiving end according to the third embodiment of the present disclosure, and therefore all the embodiments of the electronic device of the third embodiment in the foregoing text are applicable here and will not be repeated here.

### III. Application Examples

The technology of the present disclosure can be applied to various products.

For example, the electronic device 200 of the first embodiment and the electronic device 1200 of the second embodiment may be implemented on the base station side. When the electronic device is implemented on the base station side, the electronic device can be implemented as any type of base station device, such as macro eNB and small eNB, and can also be implemented as any type of gNB (base station in the 5G system). A small eNB may be an eNB covering a cell smaller than a macro cell, such as a pico eNB, a micro eNB, and a home (femto) eNB. Alternatively, the base station device may be implemented as any other type of base station, such as a NodeB and a Base Transceiver Station (BTS). The base station may include: a main body (also referred to as a base station device) configured to control wireless communication; and one or more remote radio heads (RRHs) provided at a location different from the main body.

The electronic device on the base station side can also be implemented as any type of TRP. The TRP may have sending and receiving functions, for example, it may receive information from a user equipment and a base station device, and may also send information to a user equipment and a base station device. In a typical example, the TRP can provide services to the user equipment and is controlled by the base station equipment. Furthermore, the TRP may have a structure similar to that of a base station device, or may only have a structure related to sending and receiving information in a base station device.

In addition, the electronic device 500 of the first embodiment and the electronic device 2000 of the third embodiment may be implemented on the terminal side. When an electronic device is implemented on the terminal side, for example, as a terminal device, the electronic device can be various user equipments, which can be implemented as a mobile terminal (such as a smart phone, a tablet personal computer (PC), a notebook PC, a portable game terminal, a portable/dongle type mobile router, and a digital camera device) or a vehicle-mounted terminal (such as a car navigation device). The user equipment may also be implemented as a terminal performing machine-to-machine (M2M) communication (also referred to as a machine type communication (MTC) terminal). Furthermore, the user equipment may be a wireless communication module (such as an integrated circuit module including a single chip) installed on each of the above-mentioned user equipments.

[Application Example about Base Station]

### First application example

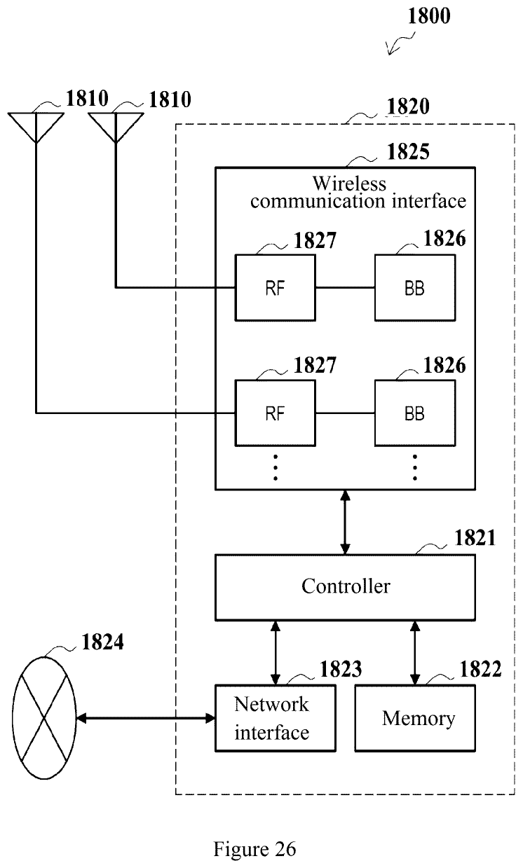

FIG. 26 is a block diagram showing a first example of a schematic configuration of an eNB in which the technique of the disclosure can be applied. The eNB 1800 includes a single or multiple antennas 1810 and a base station equipment 1820. The base station equipment 1820 and each antenna 1810 may be connected with each other via RF cable.

Each of the antennas 1810 includes one or more antenna elements (such as multiple antenna elements included in a multiple-input multiple-output (MIMO) antenna), and are used for transmitting and receiving a wireless signal by the base station equipment 1820. The eNB 1800 may include the multiple antennas 1810, as illustrated in FIG. 26. For example, the multiple antennas 1810 may be compatible with multiple frequency bands used by the eNB 1800. Although FIG. 26 illustrates an example in which the eNB 1800 includes multiple antennas 1810, the eNB 1800 may also include a single antenna 1810.

The base station equipment 1820 includes a controller 1821, a memory 1822, a network interface 1823, and a wireless communication interface 1825.

The controller 1821 may be, for example, a CPU or a DSP and operate various functions of higher layers of the base station equipment 1820. For example, the controller 1821 generates a data packet based on data in a signal processed by the wireless communication interface 1825, and transmits the generated packet via the network interface 1823. The controller 1821 may bundle data from multiple baseband processors to generate a bundled packet and transmit the generated bundled packet. The controller 1821 may have logic functions for performing the following control: wireless resource control, radio carrying control, mobility management, admission control and schedule. The control may be performed in corporation with a nearby eNB or core network node. The memory 1822 includes an RAM and an ROM, and stores a program executed by the controller 1821 and various types of control data (such as a terminal list, transmission power data and scheduling data).

The network interface 1823 is configured to connect the base station equipment 1820 to a communication interface of the core network 1824. The controller 1821 may communicate with a core network node or another eNB via the network interface 1823. In this case, the eNB 1800 and the core network node or another eNB may be connected to each other via a logic interface (such as an S1 interface and an X2 interface). The network interface 1823 may be a wired communication interface or a wireless communication interface for a wireless backhaul line. If the network interface 1823 is a wireless communication interface, the network interface 1823 may use a higher frequency band for radio communication as compared with the frequency band used by the wireless communication interface 1825.

The wireless communication interface 1825 supports any cellular communication scheme (such as Long Term Evolution (LTE) and LTE-Advanced), and provides wireless connection to a terminal located in a cell of the eNB 1800 via the antenna 1810. The wireless communication interface 1825 may generally include a base band (BB) processor 1826 and an RF circuit 1827. The BB processor 1826 may perform, for example, encoding/decoding, modulating/demodulating, and multiplexing/de-multiplexing, and perform various types of signal processing of layers (such as L1, medium access control (MAC), radio link control (RLC), and packet data convergence protocol (PDCP)). Instead of the controller 1821, the BB processor 1826 may have a part or all of the above-mentioned logic functions. The BB processor 1826 may be a memory storing communication control programs, or a module including a processor which is configured to execute the programs and a related circuit. Update of the programs may change the function of the BB processor 1826. The module may be a card or a blade inserted into a slot of the base station equipment 1820. Alternatively, the module may be a chip installed on the card or the blade. Meanwhile, the RF circuit 1827 may include for example a mixer, a filter or an amplifier, and transmits and receives a radio signal via the antenna 1810.

The wireless communication interface 1825 may include multiple BB processors 1826, as illustrated in FIG. 26. For example, the multiple BB processors 1826 may be compatible with multiple frequency bands used by the eNB 1800. As shown in FIG. 26, the wireless communication interface 1825 may include multiple RF circuits 1827. For example, the multiple RF circuits 1827 may be compatible with multiple antenna elements. Although FIG. 26 shows the example in which the wireless communication interface 1825 includes the multiple BB processors 1826 and the multiple RF circuits 1827, the wireless communication interface 1825 may also include a single BB processor 1826 or a single RF circuit 1827.

In the eNB 1800 shown in FIG. 26, the functions of the access unit 210, the generation unit 220 and the configuration unit 230 in the electronic device 200 of the first embodiment previously described with reference to FIG. 2 may be implemented by the controller 1821 (and optionally some modules in the wireless communication interface 1825). In addition, the functions of the access unit 1210 and the allocation unit 1220 in the electronic device 1200 of the second embodiment described with reference to FIG. 12 may also be implemented by the controller 1821 (and optionally some modules in the wireless communication interface 1825). For example, the controller 1821 may implement the functions of the corresponding units or at least part of the functions by executing the instructions stored in the memory 1822. The communication units in the electronic device 200 and the electronic device 1200 may each be implemented, for example, through a wireless communication interface 1825 (e.g., under the control of the controller 1821) or the like. Furthermore, each of the storage units not shown in the electronic devices 200 and 1200 may be implemented by the memory 1822.

### Second Application Example

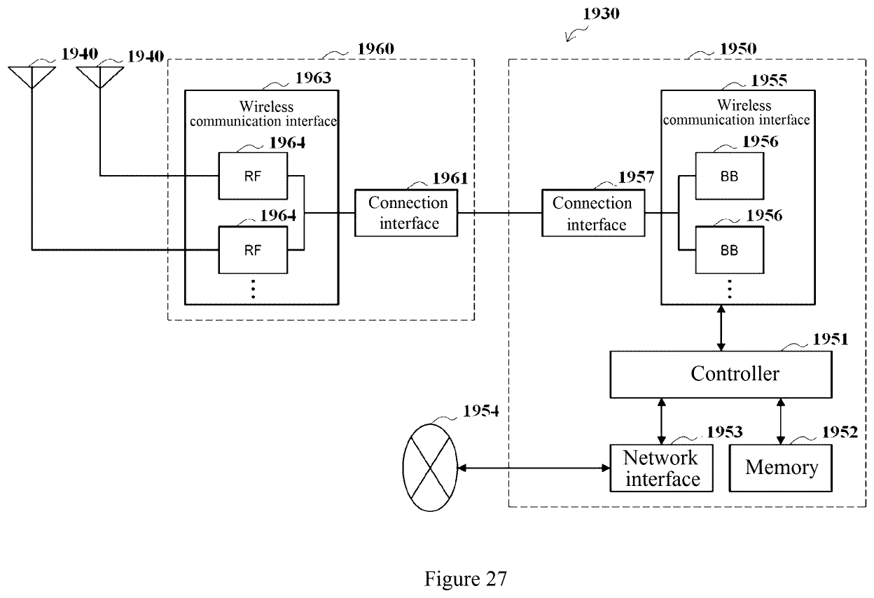

FIG. 27 is a block diagram showing a second example of a schematic configuration of an eNB to which the technology of the present disclosure can be applied. An eNB 1930 includes one or more antennas 1940, a base station equipment 1950 and an RRH 1960. The RRH 1960 and each antenna 1940 may be connected to each other via an RF cable. The base station equipment 1950 and the RRH 1960 may be connected to each other via a high speed line such as an optical fiber cable.

Each of the antennas 1940 includes a single or multiple antenna elements (such as multiple antenna elements included in an MIMO antenna), and is used for the RRH 1960 to transmit and receive radio signals. As shown in FIG. 27, the eNB 1930 may include multiple antennas 1940. For example, the multiple antennas 1940 may be compatible with multiple frequency bands used by the eNB 1930. Although FIG. 27 illustrates an example in which the eNB 1930 includes multiple antennas 1940, the eNB 1930 may also include a single antenna 1940.

The base station equipment 1950 includes a controller 1951, a memory 1952, a network interface 1953, a wireless communication interface 1955, and a connection interface 1957. The controller 1951, the memory 1952, and the network interface 1953 are the same as the controller 1821, the memory 1822, and the network interface 1823 described with reference to FIG. 26.

The wireless communication interface 1955 supports any cellular communication solution (such as LTE and LTE-advanced), and provides wireless communication with a terminal located in a sector corresponding to the RRH 1960 via the RRH 1960 and the antenna 1940. The wireless communication interface 1955 may typically include a BB processor 1956 for example. The BB processor 1956 is the same as the BB processor 1826 described with reference to FIG. 26, except that the BB processor 1956 is connected to the RF circuitry 1964 of the RRH 1960 via the connection interface 1957. As show in FIG. 27, the wireless communication interface 1955 may include multiple BB processors 1956. For example, the multiple BB processors 1956 may be compatible with the multiple frequency bands used by the eNB 1930. Although FIG. 27 shows an example in which the wireless communication interface 1955 includes multiple BB processors 1956, the wireless communication interface 1955 may include a single BB processor 1956.

The connection interface 1957 is an interface for connecting the base station equipment 1950 (wireless communication interface 1955) to the RRH 1960. The connection interface 1957 may also be a communication module for communication in the above-described high-speed line via which the base station equipment 1950 (wireless communication interface 1955) is connected to the RRH 1960.

The RRH 1960 includes a connection interface 1961 and a wireless communication interface 1963.

The connection interface 1961 is an interface for connecting the RRH 1960 (the wireless communication interface 1963) to the base station equipment 1950. The connection interface 1961 may also be a communication module for the communication in the above high-speed line.

The wireless communication interface 1963 transmits and receives a wireless signal via the antenna 1940. The wireless communication interface 1963 may typically include, for example, the RF circuit 1964. The RF circuit 1964 may include for example frequency mixer, a filter and an amplifier, and transmits and receives a wireless signal via the antenna 1940. The wireless communication interface 1963 may include multiple RF circuits 1964, as illustrated in FIG. 27. For example, the multiple RF circuits 1964 may support multiple antenna elements. Although FIG. 27 shows an example in which the wireless communication interface 1963 includes the multiple RF circuits 1964, the wireless communication interface 1963 may also include a single RF circuit 1964.

In the eNB 1930 shown in FIG. 27, the functions of the access unit 210, the generation unit 220 and the configuration unit 230 in the electronic device 200 of the first embodiment previously described with reference to FIG. 2 can be implemented by the controller 1951 (and optionally some modules of the wireless communication interface 1955 and the wireless communication interface 1963). In addition, the functions of the access unit 1210 and the allocation unit 1220 in the electronic device 1200 of the second embodiment described with reference to FIG. 12 may also be implemented by the controller 1951 (and optionally part of the modules of the wireless communication interface 1955 and the wireless communication interface 1963). For example, the controller 1951 may implement the functions of the corresponding units or at least part of the functions by executing instructions stored in the memory 1952. The communication units in the electronic device 200 and the electronic device 1200 may each be implemented, for example, through a wireless communication interface 1955, a wireless communication interface 1963, etc. (e.g., under the control of the controller 1951). Furthermore, each of the storage units not shown in the electronic devices 200 and 1200 may be implemented by the memory 1952.

The communication unit in the electronic device 300 of the second configuration example of the first embodiment described previously with reference to FIG. 3 and the second embodiment may be implemented, for example, by a wireless communication interface 1963 and an optional antenna 1940. The function of the control unit in the electronic device 300 may be implemented by the controller 1951. For example, the controller 1951 may implement the function of a control unit by executing instructions stored in the memory 1952. In addition, the storage unit in the electronic device 300 can be implemented by the memory 1952.

### [Application Example on User Equipment]

### First Application Example

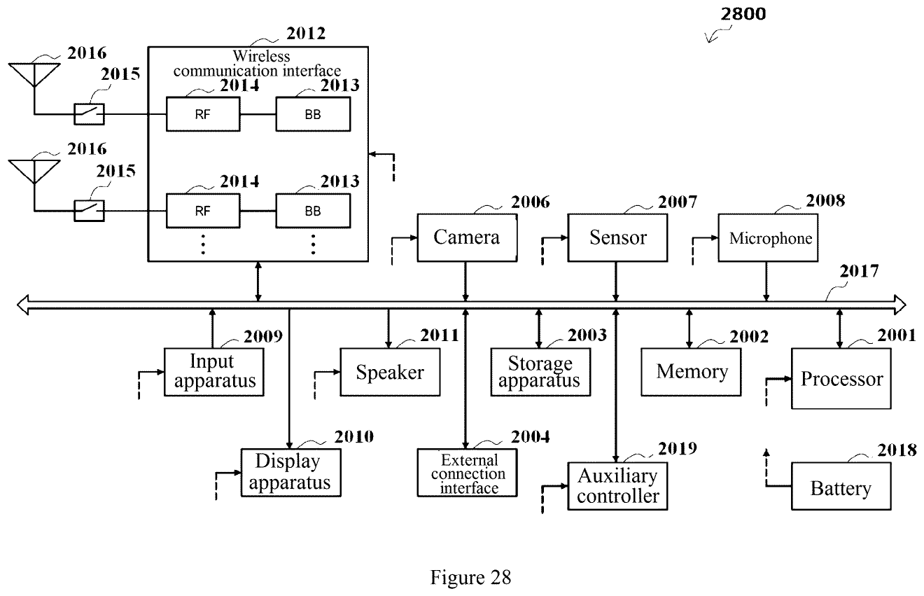

FIG. 28 is a block diagram illustrating an example of exemplary configuration of a smartphone 2000 to which the technology of the present disclosure can be applied. The smartphone 2000 includes a processor 2001, a memory 2002, a storage apparatus 2003, an external connection interface 2004, a camera 2006, a sensor 2007, a microphone 2008, an input apparatus 2009, a display apparatus 2010, a speaker 2011, a wireless communication interface 2012, one or more antenna switches 2015, one or more antennas 2016, a bus 2017, a battery 2018, and an auxiliary controller 2019.

The processor 2001 may be, for example, a CPU or a system on chip (SoC), and control functions of an application layer and additional layer of the smartphone 2000. The memory 2002 includes RAM and ROM, and stores a program that is executed by the processor 2001, and data. The storage apparatus 2003 may include a storage medium such as a semiconductor memory and a hard disk. The external connection interface 2004 is an interface configured to connect an external apparatus (such as a memory card and a universal serial bus (USB) apparatus) to the smart phone 2000.

The camera 2006 includes an image sensor (such as a Charge Coupled Device (CCD) and a Complementary Metal Oxide Semiconductor (CMOS)) and generates a captured image. The sensor 2007 may include a group of sensors such as a measurement sensor, a gyro sensor, a geomagnetic sensor, and an acceleration sensor. The microphone 2008 converts sounds that are inputted to the smart phone 2000 into audio signals. The input apparatus 2009 includes, for example, a touch sensor configured to detect touch onto a screen of the display apparatus 2010, a keypad, a keyboard, a button, or a switch, and receive an operation or information inputted from a user. The display apparatus 2010 includes a screen (such as a liquid crystal display (LCD) and an organic light-emitting diode (OLED) display), and displays an output image of the smartphone 2000. The speaker 2011 converts audio signals that are outputted from the smart phone 2000 to sounds.

The wireless communication interface 2012 supports any cellular communication scheme (such as LTE and LTE-advanced), and performs wireless communication. The wireless communication interface 2012 may generally include for example a BB processor 2013 and an RF circuit 2014. The BB processor 2013 may perform encoding/decoding, modulating/demodulating and multiplexing/de-multiplexing for example, and perform various types of signal processing for wireless communication. Meanwhile, the RF circuit 2014 may include for example a mixer, a filter and an amplifier, and transmit and receive a wireless signal via the antenna 2016. The wireless communication interface 2012 may be a chip module having the BB processor 2013 and the RF circuit 2014 integrated thereon. As shown in FIG. 28, the wireless communication interface 2012 may include multiple BB processors 2013 and multiple RF circuits 2014. Although FIG. 28 illustrates the example in which the wireless communication interface 2012 includes the multiple BB processors 2013 and the multiple RF circuits 2014, the wireless communication interface 2012 may also include a single BB processor 2013 or a single RF circuit 2014.

Furthermore, in addition to a cellular communication scheme, the wireless communication interface 2012 may support another type of wireless communication scheme such as a short-distance wireless communication scheme, a near field communication scheme, and a wireless local area network (LAN) scheme. In this case, the wireless communication interface 2012 may include the BB processor 2013 and the RF circuit 2014 for each wireless communication scheme.

Each of the antenna switches 2015 switches connection destinations of the antennas 916 among multiple circuits (such as circuits for different wireless communication schemes) included in the wireless communication interface 2012.

Each of the antennas 2016 includes a single or multiple antenna elements (such as multiple antenna elements included in an MIMO antenna), and is used for the wireless communication interface 2012 to transmit and receive radio signals. The smartphone 2000 may include the multiple antennas 2016, as illustrated in FIG. 28. Although FIG. 28 illustrates the example in which the smartphone 2000 includes the multiple antennas 2016, the smartphone 2000 may also include a single antenna 2016.

In addition, the smartphone 2000 may include an antenna 2016 for each wireless communication scheme. In this case, the antenna switch 2015 may be omitted from the configuration of the smartphone 2000.

The bus 2017 connects the processor 2001, the memory 2002, the storage apparatus 2003, the external connection interface 2004, the camera 2006, the sensor 2007, the microphone 2008, the input apparatus 2009, the display apparatus 2010, the speaker 2011, the wireless communication interface 2012, and the auxiliary controller 2019 to each other. The battery 2018 supplies power to blocks of the smart phone 2000 shown in FIG. 28 via feeder lines, which are partially shown as dashed lines in the figure. The auxiliary controller 2019 operates a minimum necessary function of the smart phone 2000, for example, in a sleep mode.

In the smartphone 2000 shown in FIG. 28, the functions of the control unit in the electronic device 500 of the first embodiment described previously with reference to FIG. 5 and the electronic device 2000 of the third embodiment described with reference to FIG. 20 may be implemented by the processor 2001 or the auxiliary controller 2019. For example, the processor 2001 (or the auxiliary controller 2019) may implement the functions of the control unit by executing instructions stored in the memory 2002 or the storage apparatus 2003. The communication units in the electronic device 500 and the electronic device 2000 may each be implemented through a wireless communication interface 2012 (e.g., under the control of the processor 2001 or the auxiliary controller 2019) or the like. In addition, the storage unit not shown in the electronic device 500 and the electronic device 2000 may be implemented by the memory 2002 or the storage apparatus 2003.

### Second Application Example

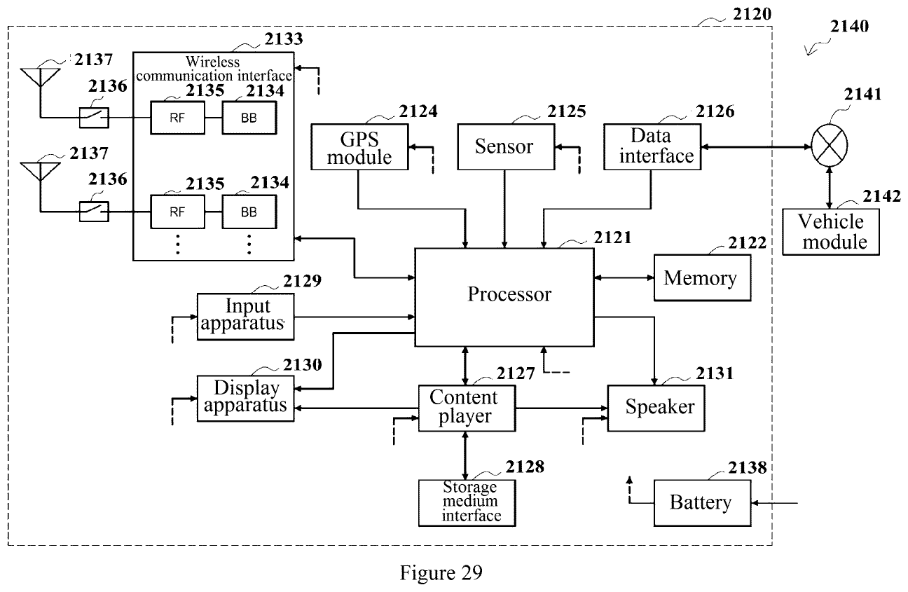

FIG. 29 is a block diagram showing an example of a schematic configuration of a car navigation device 2120 to which the technology according to the present disclosure can be applied. The car navigation device 2120 includes a processor 2121, a memory 2122, a global positioning system (GPS) module 2124, a sensor 2125, a data interface 2126, a content player 2127, a storage medium interface 2128, an input apparatus 2129, a display apparatus 2130, a speaker 2131, a wireless communication interface 2133, one or more antenna switches 2136, one or more antennas 2137, and a battery 2138

The processor 2121 may be, for example, a CPU or a SoC, and control a navigation function and additional function of the vehicle navigation device 2120. The memory 2122 includes RAM and ROM, and stores a program that is executed by the processor 2121, and data.

The GPS module 2124 measures a position (such as latitude, longitude, and altitude) of the car navigation device 2120 by using GPS signals received from a GPS satellite. The sensor 2125 may include a group of sensors such as a gyroscope sensor, a geomagnetic sensor and an air pressure sensor. The data interface 2126 is connected to, for example, an in-vehicle network 2141 via a terminal that is not shown, and acquires data generated by the vehicle (such as vehicle speed data).

The content player 2127 reproduces content stored in a storage medium (such as a CD and a DVD) inserted into the storage medium interface 2128. The input apparatus 2129 includes, for example, a touch sensor configured to detect touch on a screen of the display apparatus 2130, a button, or a switch, and receives an operation or information inputted by a user. The display apparatus 2130 includes a screen such as a LCD or an OLED display, and displays an image of the navigation function or content that is reproduced. The speaker 2131 outputs sounds of the navigation function or the content that is reproduced.

The wireless communication interface 2133 supports any cellular communication scheme (such as LTE and LTE-advanced) and performs wireless communication. The wireless communication interface 2133 may typically include, for example, a BB processor 2134 and an RF circuit 2135. The BB processor 2134 may perform, for example, encoding/decoding, modulating/demodulating, and multiplexing/demultiplexing, and performs various types of signal processing for wireless communication. Meanwhile, the RF circuit 2135 may include for example a mixer, a filter and an amplifier, and transmit and receive a wireless signal via the antenna 2137. The wireless communication interface 2133 may be a chip module having the BB processor 2134 and the RF circuit 2135 integrated thereon. The wireless communication interface 2133 may include multiple BB processors 2134 and multiple RF circuits 2135, as shown in FIG. 29. Although FIG. 29 shows an example in which the wireless communication interface 2133 includes multiple BB processors 2134 and multiple RF circuits 2135, the wireless communication interface 2133 may also include a single BB processor 2134 and a single RF circuit 2135.

Furthermore, in addition to a cellular communication scheme, the wireless communication interface 2133 may support another type of wireless communication scheme such as a short-distance wireless communication scheme, a near field communication scheme, and a wireless LAN scheme. In this case, the wireless communication interface 2133 may include a BB processor 2134 and an RF circuit 2135 for each wireless communication scheme.

Each of the antenna switches 2136 switches connection destinations of the antennas 2137 among multiple circuits (such as circuits for different wireless communication schemes) included in the wireless communication interface 2133.

Each of the antennas 2137 includes one or more antenna elements (such as multiple antenna elements included in a MIMO antenna) and is used by the wireless communication interface 2133 to transmit and receive a wireless signal. As shown in FIG. 29, the car navigation device 2120 may include multiple antennas 2137. Although FIG. 29 illustrates an example in which the vehicle navigation device 2120 includes multiple antennas 2137, the car navigation device 2120 may also include a single antenna 2137.

In addition, the car navigation device 2120 may include an antenna 2137 for each wireless communication scheme. In this case, the antenna switches 2136 may be omitted from the configuration of the car navigation device 2120.

The battery 2138 supplies power to the blocks of the car navigation device 2120 shown in FIG. 29 via a feeder line, which is partially shown with a dash line in the figure. The battery 2138 accumulates power provided by the vehicle.

In the car navigation device 2120 shown in FIG. 29, the functions of the control units in the electronic device 500 of the first embodiment described previously with reference to FIG. 5 and the electronic device 2000 of the third embodiment described with reference to FIG. 20 may each be implemented by a processor 2121. For example, the processor 2121 may implement the functions of the control unit by executing instructions stored in the memory 2122. The communication units in the electronic device 500 and the electronic device 2000 may each be implemented through a wireless communication interface 2133 (e.g., under the control of the processor 2121) or the like. In addition, the storage unit not shown in the electronic device 500 and the electronic device 2000 may be implemented by the memory 2122.

The technology of the present disclosure may also be implemented as an in-vehicle system (or a vehicle) 2140 including one or more of the automobile navigation device 2120, a vehicle network 2141 and a vehicle module 2142. The vehicle module 2142 generates vehicle data (such as vehicle speed, engine speed, and trouble information), and outputs the generated data to the in-vehicle network 2141.

The preferred embodiments of the present disclosure have been described above with reference to the accompanying drawings, whilst the present disclosure is not limited to the above examples, of course. A person skilled in the art may find various alterations and modifications within the scope of the appended claims, and it should be understood that they will naturally come under the technical scope of the present disclosure.

For example, the units shown in dotted boxes in the functional block diagrams shown in the accompanying drawings all indicate that the functional units are optional in the corresponding device, and the various optional functional units can be combined in an appropriate manner to achieve the required functions.

For example, a plurality of functions included in one unit in the above embodiments may be implemented by separate devices. Alternatively, a plurality of functions implemented by a plurality of units in the above embodiments may be implemented by separate devices, respectively. In addition, one of the above functions may be implemented by a plurality of units. Needless to say, such a configuration is included in the technical scope of the present disclosure.

In this specification, the steps described in the flowchart include not only processing executed in time series in the described order but also processing executed in parallel or individually, not necessarily in time series. Furthermore, even in steps processed in time series, it is needless to say that the order can be changed appropriately.

Furthermore, the first embodiment of the present disclosure may provide configurations as follows.

1. An electronic device at a base station side, comprising:
a processing circuit configured to:
perform channel access processing on an unlicensed frequency band used for Sidelink communication to obtain a channel occupation time (COT);
generate downlink control information to indicate allocation of the COT to user equipment for Sidelink communication.

2. The electronic device according to configuration 1, wherein the downlink control information includes: COT indication information indicating a period of the COT allocated to the user equipment.

3. The electronic device according to configuration 2, wherein the downlink control information further includes: access type information indicating a type of the channel access processing.

4. The electronic device according to configuration 3, wherein the type of the channel access processing includes: a priority of listen-before-talk (LBT) for performing the channel access processing.

5. The electronic device according to configuration 3 or 4, wherein the downlink control information further includes: frequency domain resource indication information, indicating frequency domain resources of the unlicensed frequency band allocated to the user equipment.

6. The electronic device according to configuration 5, wherein the downlink control information includes multiple resource allocation fields for multiple COTs, and each resource allocation field includes the COT indication information, the access type information and the frequency domain resource indication information for a corresponding COT.

7. The electronic device according to configuration 2, wherein the downlink control information further includes: feedback timing information indicating sending timing of an uplink signal for feeding back usage of the COT.

8. The electronic device according to configuration 1, wherein the processing circuit is further configured to:
continuously perform the channel access process to obtain the COT and generate the downlink control information; and
send the downlink control information to the user equipment in a static or semi-static manner based on a sending period of the downlink control information configured for the user equipment.

9. The electronic device according to configuration 1, wherein the processing circuit is further configured to: in response to a request from the user equipment for resources for Sidelink communication, perform the channel access processing to obtain the COT, generate the downlink control information, and send the downlink control information to the user equipment.

10. The electronic device according to configuration 9, wherein the processing circuit is further configured to: in response to the request, allocate authorized resources for Sidelink communication to the user equipment, generate another downlink control information indicating the allocation of the authorized resources, and send the another downlink control information to the user equipment.

11. The electronic device according to configuration 1, wherein the processing circuit is further configured to: scramble the downlink control information with a predefined scrambling sequence.

12. The electronic device according to configuration 11, wherein the predefined scrambling sequence includes: a scrambling sequence for indicating scheduling of unlicensed resources for Sidelink communication, or a scrambling sequence for indicating transfer of time slot related information.

13. The electronic device according to configuration 1, wherein the processing circuit is further configured to: configure an unlicensed resource set for the user equipment for Sidelink communication, and the unlicensed resource set includes at least resources of the unlicensed frequency band.

14. The electronic device according to configuration 13, wherein the processing circuit is further configured to: send configuration information of the unlicensed resource set to the user equipment via a system information block (SIB).

15. An electronic device, comprising:
a processing circuit configured to:
receive downlink control information, wherein the downlink control information indicates allocation of a channel occupation time (COT), which is obtained by a base station side device performing channel access processing on an unlicensed frequency band for Sidelink communication, to the electronic device for Sidelink communication.

16. The electronic device according to configuration 15, wherein the downlink control information includes: COT indication information indicating a time period of the COT allocated to the electronic device.

17. The electronic device according to configuration 16, wherein the downlink control information further includes: access type information indicating a type of the channel access processing.

18. The electronic device according to configuration 17, wherein the type of the channel access processing includes: a priority of listen-before-talk (LBT) for performing the channel access processing.

19. The electronic device according to configuration 17 or 18, wherein the downlink control information further includes: frequency domain resource indication information, indicating frequency domain resources of the unlicensed frequency band allocated to the electronic device.

20. The electronic device according to configuration 19, wherein the downlink control information includes multiple resource allocation fields for multiple COTs, and each resource allocation field includes the COT indication information, the access type information and the frequency domain resource indication information for a corresponding COT.

21. The electronic device according to configuration 16, wherein the downlink control information further includes feedback timing information indicating sending timing of an uplink signal for feeding back usage of the COT.

22. The electronic device according to configuration 21, wherein the processing circuit is further configured to: send an uplink signal for feeding back usage of the COT at the sending timing indicated by the feedback timing information.

23. The electronic device according to configuration 15, wherein the processing circuit is further configured to: receive the downlink control information sent in a static or semi-static manner based on a sending period of the downlink control information configured by the base station side device for the electronic device.

24. The electronic device according to configuration 15, wherein the processing circuit is further configured to:
send a request for resources for Sidelink communication to the base station side device; and
receive the downlink control information sent in response to the request.

25. The electronic device of configuration 24, wherein the processing circuit is further configured to: receive another downlink control information sent in response to the request, the another downlink control information indicating allocation of authorized resources for Sidelink communication.

26. The electronic device according to configuration 15, wherein the processing circuit is further configured to: receive the downlink control information scrambled with a predefined scrambling sequence.

27. The electronic device according to configuration 26, wherein the predefined scrambling sequence includes: a scrambling sequence for indicating scheduling of unlicensed resources for Sidelink communication, or a scrambling sequence for indicating transfer of time slot related information.

28. The electronic device according to configuration 15, wherein the processing circuit is further configured to: receive configuration information of an unlicensed resource set for Sidelink communication from the base station side device, and the unlicensed resource set includes at least resources of the unlicensed frequency band.

29. The electronic device according to configuration 28, wherein the processing circuit is further configured to: receive the configuration information sent via a system information block (SIB).

30. A method for wireless communication, comprising:
performing channel access processing on an unlicensed frequency band for Sidelink communication to obtain a channel occupation time (COT);
generating downlink control information to indicate allocation of the COT to a user equipment for Sidelink communication.

31. A method for wireless communication, comprising:
receiving downlink control information, wherein the downlink control information indicates allocation of a channel occupation time (COT), which is obtained by a base station side device performing channel access processing on an unlicensed frequency band for Sidelink communication, to an electronic device for Sidelink communication.

32. A non-transitory computer-readable storage medium storing executable instructions that, when executed by a processor, cause the processor to performs the method for wireless communication according to in configuration 30 or 31.

Furthermore, the second and third embodiments of the present disclosure may provide configurations as follows.

1. An electronic device at a base station side, comprising:
a processing circuit configured to:
perform channel access processing on an unlicensed frequency band for transmitting a Sidelink synchronization signal to obtain a channel occupation time (COT);
allocate resources of the unlicensed frequency band in the COT to multiple user equipments for sending Sidelink synchronization signals.

2. The electronic device according to configuration 1, wherein the processing circuit is further configured to: generate downlink control information for each user equipment among the multiple user equipments to indicate allocation of the resources to the user equipment.

3. The electronic device according to configuration 2, wherein the processing circuit is further configured to: pre-configure a frequency domain resource on the unlicensed frequency band for transmitting a Sidelink synchronization signal for each of the multiple user equipments.

4. The electronic device according to configuration 3, wherein the processing circuit is further configured to:
pre-configure the same frequency domain resource for the multiple user equipments; and
indicate, in the respective pieces of downlink control information generated for the multiple user equipments, different time periods in the COT allocated to the corresponding user equipments.

5. The electronic device according to configuration 3, wherein the processing circuit is further configured to:
pre-configure different frequency domain resources for the multiple user equipments; and
indicate, in the respective pieces of downlink control information generated for the multiple user equipments, the same time period in the COT allocated to the corresponding user equipments.

6. The electronic device according to configuration 4 or 5, wherein the frequency domain resource includes a predetermined number of consecutive resource blocks, and the predetermined number is an integer multiple of 11.

7. The electronic device according to configuration 1, wherein the processing circuit is further configured to: perform the channel access processing in response to a request from the user equipment for resources for transmitting a Sidelink synchronization signal.

8. An electronic device, comprising:
a processing circuit configured to:
jointly send a synchronization signal and a data signal for Sidelink communication on an unlicensed frequency band in a predefined time-frequency resource format,
wherein the time-frequency resource format includes multiple subchannels in one time slot.

9. The electronic device according to configuration 8, wherein, in the time-frequency resource format, the synchronization signal and the data signal share time domain resources of one time slot.

10. The electronic device according to configuration 9, wherein, among a plurality of symbols in one time slot, a symbol occupied by the synchronization signal is located before a symbol occupied by the data signal.

11. The electronic device according to configuration 8, wherein, in the time-frequency resource format, the synchronization signal and the data signal share frequency domain resources of the multiple subchannels.

12. The electronic device according to configuration 11, wherein the synchronization signal and control information and data information in the data signal share the frequency domain resources of the multiple subchannels, and the synchronization signal occupies a subchannel with a lowest index among the multiple subchannels.

13. The electronic device according to configuration 12, wherein the synchronization signal occupies a predetermined number of consecutive resource blocks in the subchannel with the lowest index, the predetermined number being an integer multiple of I1.

14. The electronic device according to configuration 11, wherein the synchronization signal and control information in the data signal share the frequency domain resources of the multiple subchannels, and the control information occupies a subchannel with the lowest index.

15. An electronic device, comprising:
a processing circuit configured to:
receive a synchronization signal and a data signal for Sidelink communication on an unlicensed frequency band that are jointly transmitted in a predefined time-frequency resource format,
wherein the time-frequency resource format includes multiple subchannels in one time slot.

16. The electronic device according to configuration 15, wherein, in the time-frequency resource format, the synchronization signal and the data signal share time domain resources of one time slot.

17. The electronic device according to configuration 16, wherein, among a plurality of symbols in one time slot, a symbol occupied by a synchronization signal is located before a symbol occupied by a data signal.

18. The electronic device according to configuration 15, wherein, in the time-frequency resource format, the synchronization signal and the data signal share frequency domain resources of the multiple subchannels.

19. The electronic device according to configuration 18, wherein the synchronization signal and control information and data information in the data signal share the frequency domain resources of the multiple subchannels, and the synchronization signal occupies a subchannel with a lowest index among the multiple subchannels.

20. The electronic device according to configuration 19, wherein the synchronization signal occupies a predetermined number of consecutive resource blocks in the subchannel with the lowest index, the predetermined number being an integer multiple of 11.

21. The electronic device according to configuration 18, wherein the synchronization signal and control information in the data signal share the frequency domain resources of the multiple subchannels, and the control information occupies a subchannel with the lowest index.

22. A method for wireless communication, comprising:
performing channel access processing on an unlicensed frequency band for transmitting a Sidelink synchronization signal to obtain a channel occupation time (COT);
allocating resources of the unlicensed frequency band in the COT to multiple user equipments for sending Sidelink synchronization signals.

23. A method for wireless communication, comprising:
jointly sending a synchronization signal and a data signal for Sidelink communication on an unlicensed frequency band in a predefined time-frequency resource format,
wherein the time-frequency resource format includes multiple subchannels in one time slot.

24. A method for wireless communication, comprising:
receiving a synchronization signal and a data signal for Sidelink communication on an unlicensed frequency band that are jointly transmitted in a predefined time-frequency resource format,
wherein the time-frequency resource format includes multiple subchannels in one time slot.

25. A non-transitory computer-readable storage medium storing executable instructions that, when executed by a processor, cause the processor to perform the method for wireless communication according to any one of configurations 22 to 24.

Although the embodiments of the present disclosure are described in detail above in conjunction with the accompanying drawings, it should be understood that the above-described implementation modes are only used to illustrate the present disclosure and do not constitute a limitation to the present disclosure. It will be apparent to those skilled in the art that various modifications and variations can be made to the above-described embodiments without departing from the spirit and scope of the present disclosure. Therefore, the scope of the present disclosure is limited only by the appended claims and their equivalents.

1. An electronic device at a base station side, comprising:
a processing circuit configured to:
perform channel access processing on an unlicensed frequency band used for Sidelink communication to obtain a channel occupation time (COT);
generate downlink control information to indicate allocation of the COT to user equipment for Sidelink communication.

2. The electronic device according to claim 1, wherein the downlink control information includes: COT indication information indicating a period of the COT allocated to the user equipment.

3. The electronic device according to claim 2, wherein the downlink control information further includes: access type information indicating a type of the channel access processing.

4. (canceled)

5. The electronic device according to claim 3, wherein the downlink control information further includes: frequency domain resource indication information, indicating frequency domain resources of the unlicensed frequency band allocated to the user equipment.

6. The electronic device according to claim 5, wherein the downlink control information includes multiple resource allocation fields for multiple COTs, and each resource allocation field includes the COT indication information, the access type information and the frequency domain resource indication information for a corresponding COT.

7. The electronic device according to claim 2, wherein the downlink control information further includes: feedback timing information indicating sending timing of an uplink signal for feeding back usage of the COT.

8.-10. (canceled)

11. The electronic device according to claim 1, wherein the processing circuit is further configured to: scramble the downlink control information with a predefined scrambling sequence.

12. The electronic device according to claim 11, wherein the predefined scrambling sequence includes: a scrambling sequence for indicating scheduling of unlicensed resources for Sidelink communication, or a scrambling sequence for indicating transfer of time slot related information.

13. The electronic device according to claim 1, wherein the processing circuit is further configured to: configure an unlicensed resource set for the user equipment for Sidelink communication, and the unlicensed resource set includes at least resources of the unlicensed frequency band.

14. The electronic device according to claim 13, wherein the processing circuit is further configured to: send configuration information of the unlicensed resource set to the user equipment via a system information block (SIB).

15. An electronic device, comprising:
a processing circuit configured to:
receive downlink control information, wherein the downlink control information indicates allocation of a channel occupation time (COT), which is obtained by a base station side device performing channel access processing on an unlicensed frequency band for Sidelink communication, to the electronic device for Sidelink communication.

16. The electronic device according to claim 15, wherein the downlink control information includes: COT indication information indicating a time period of the COT allocated to the electronic device.

17. The electronic device according to claim 16, wherein the downlink control information further includes: access type information indicating a type of the channel access processing.

18. (canceled)

19. The electronic device according to claim 17, wherein the downlink control information further includes: frequency domain resource indication information, indicating frequency domain resources of the unlicensed frequency band allocated to the electronic device.

20. The electronic device according to claim 19, wherein the downlink control information includes multiple resource allocation fields for multiple COTs, and each resource allocation field includes the COT indication information, the access type information and the frequency domain resource indication information for a corresponding COT.

21. The electronic device according to claim 16, wherein the downlink control information further includes feedback timing information indicating sending timing of an uplink signal for feeding back usage of the COT.

22.-25. (canceled)

26. The electronic device according to claim 15, wherein the processing circuit is further configured to: receive the downlink control information scrambled with a predefined scrambling sequence.

27. (canceled)

28. The electronic device according to claim 15, wherein the processing circuit is further configured to: receive configuration information of an unlicensed resource set for Sidelink communication from the base station side device, and the unlicensed resource set includes at least resources of the unlicensed frequency band.

29. The electronic device according to claim 28, wherein the processing circuit is further configured to: receive the configuration information sent via a system information block (SIB).

30. (canceled)

31. A method for wireless communication, comprising:
receiving downlink control information, wherein the downlink control information indicates allocation of a channel occupation time (COT), which is obtained by a base station side device performing channel access processing on an unlicensed frequency band for Sidelink communication, to an electronic device for Sidelink communication.

32. (canceled)
